(19) United States
(12) Patent Application Publication
(10) Pub. No.: US 2023/0135699 A1
(43) Pub. Date: May 4, 2023

(54) SERVICE FUNCTION CHAINING SERVICES IN EDGE DATA NETWORK AND 5G NETWORKS

(71) Applicant: Intel Corporation, Santa Clara, CA (US)

(72) Inventors: Ching-Yu LIAO, Portland, OR (US); Yizhi YAO, Chandler, AZ (US); Puneet JAIN, Portland, OR (US); Joey CHOU, Scottsdale, AZ (US)

(21) Appl. No.: 17/918,842

(22) PCT Filed: Jun. 29, 2021
(86) PCT No.: PCT/US2021/039617

§ 371 Date: Oct. 13, 2022

Related U.S. Application Data
(60) Provisional application No. 63/045,761, filed on Jun. 29, 2020.
(60) Provisional application No. 63/052,187, filed on Jul. 15, 2020.

(51) Int. Cl. H04W 4/50; H04W 28/02

(52) U.S. Cl. CPC H04W 4/50; H04W 28/0268

(57) ABSTRACT

Various embodiments herein provide techniques for service function chaining (SFC) in a wireless cellular network and/or an edge data network. In some embodiments, a service function path (SFP) is configured across both the wireless cellular network and the edge data network. In other embodiments, a SFP is configured in the edge data network. Other embodiments may be described and claimed.

### CROSS REFERENCE TO RELATED APPLICATION

The present application claims priority to U.S. Provisional Patent Application No. 63/045,761, which was filed Jun. 29, 2020 and U.S. Provisional Patent Application No. 63/052,187, which was filed Jul. 15, 2020.

### FIELD

Various embodiments generally may relate to the field of wireless communications.

### BACKGROUND

In Third Generation Partnership Project (3GPP) release 13, there was a study on Flexible Mobile Service Steering (FS_FMSS) in 3GPP Technical Report (TR) 22.808 v14.1.0 (2015 Dec. 17) (referred to herein as “TR 22.808” or [1]). During the study, there were a number of use cases referring to the use of service function chaining beyond (S)Gi interface. However, during the normative phase, the only service requirements in 3GPP Technical Standard (TS) 22.101 v17.1.0 (2019 Dec. 20) (referred to herein as “TS 22.101” or [2]) were related to traffic steering on the (S)Gi interface with the assumption that (S)Gi-local area network (LAN) is outside of 3GPP scope. The same assumption applies to N6-LAN in 5G context.

### BRIEF DESCRIPTION OF THE FIGURES

FIG. 1 illustrates different Service Function Paths (SFPs) in a service function chain (SFC) at SGi_LAN are applied to different users.

FIG. 2 illustrates different SFCs used in SGi-LAN.

FIG. 3 shows the service based representation of the reference architecture of policy and charging control framework for the 5G System.

FIG. 4 shows the reference point representation of the reference architecture of policy and charging control framework for the 5G System.

FIG. 5 illustrates processing of AF requests to influence traffic routing for sessions not identified by a UE address.

FIG. 6 illustrates an application architecture for enabling Edge Applications.

FIG. 7 illustrates a reference architecture that includes SFC network in Edge Data Network according to various embodiments.

FIG. 8 shows an example of the SFC enablers in Edge Data Network and/or 5G network according to various embodiments.

FIG. 9 depicts an example of an SFC network at Edge Data Network with one or more service function paths (SFPs).

FIG. 10 shows the application architecture of the Edge Data Network enabling SFC service via SFC network and the using SFC services provide by 5G network, according to various embodiments.

FIG. 11 shows the corresponding service-based architecture with SFC enabler in 5G network, in accordance with various embodiments.

FIG. 12 illustrates an example of coordination of SFC services in Edge Data Network and 5G network, in accordance with various embodiments.

FIG. 13 shows an example procedure for SFC configuration coordination between SFC service at Edge Data Network and SFC services at 5G network according to various embodiments.

FIG. 14 shows an example procedure for setting up an AF session with required SFC parameters procedure, in accordance with various embodiments.

FIGS. 15A and 15B show examples of a modified/updated Nnef_ParameterProvision_update request/response procedure according to various embodiments.

FIG. 16 shows an example Service specific information provisioning procedure, in accordance with various embodiments.

FIG. 17 shows an example UE Configuration Update procedure for transparent UE Policy delivery procedure according to various embodiments.

FIG. 18 shows an example procedure for processing AF requests to influence traffic routing for Sessions not identified by a UE address according to various embodiments.

FIG. 19 illustrates a procedure in accordance with various embodiments.

FIG. 20 shows a reference architecture that includes SFC network in Edge Data Network according to various embodiments

FIG. 21 further shows the application architecture of the Edge Data Network enabling SFC service via SFC network, according to various embodiments.

FIG. 22 illustrates an example procedure including message flows for SFC configuration and AF request for interfering traffic routing according to various embodiments.

FIG. 23 illustrates another example procedure including message flows for SFC configuration and AF request for interfering traffic routing according to various embodiments.

FIG. 24 illustrates a network in accordance with various embodiments.

FIG. 25 schematically illustrates a wireless network in accordance with various embodiments.

FIG. 26 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 27 and 28 illustrate example procedures for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

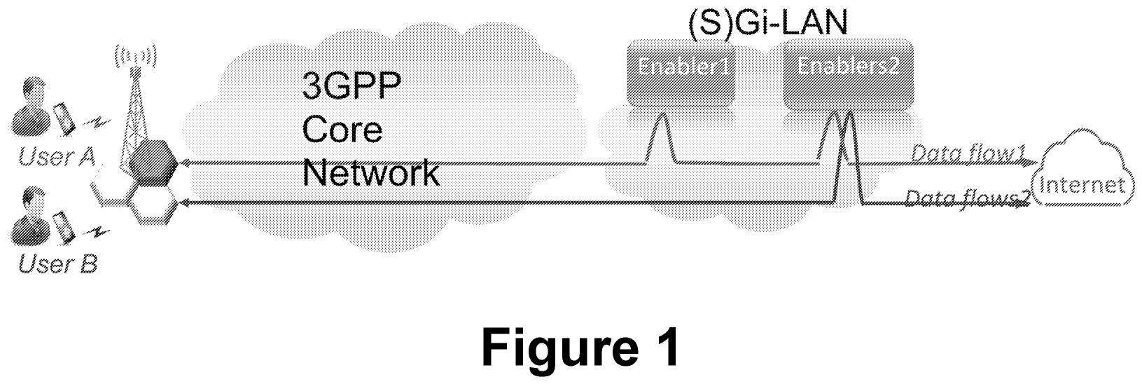

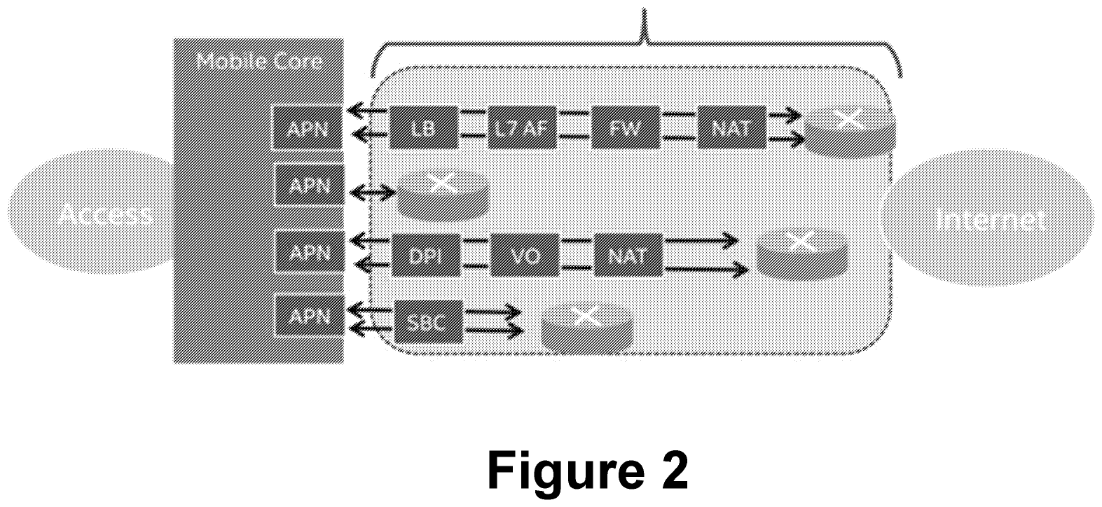

As discussed above, TR 22.808 [1] studied Flexible Mobile Service Steering as part of flexible mobile service steering. During the study, there were a number of use cases referring to the use of service function chaining beyond (S)Gi interface. However, during the normative phase, the only service requirements in TS 22.101 [2] were related to traffic steering on the (S)Gi interface with the assumption that (S)Gi-LAN is outside of 3GPP scope. The same assumption applies to N6-LAN in 5G context. For example, FIG. 1 shows different Service Function Paths (SFPs) in a service function chain (SFC) at SGi_LAN are applied to different users. Additionally, FIG. 2 shows different SFCs are used in SGi-LAN.

By considering N6-LAN outside of the 3GPP scope, it is assumed that the service function chaining inside the N6-LAN is controlled by another system that is distinct from 5GS. However, this separation of individual service functions in N6-LAN from 5G architecture results in challenges in 5G network in many aspects.
First, lacking consolidated network management and orchestration of service function chaining between 5G network and N6-LAN would cause potential interoperability issues even within the mobile network of the same network operator and result in uncoordinated and inefficient service function path settings for routing the E2E service with desired service functions.
Second, losing control over the service functions in N6-LAN provided by operators and third parties, in which SFs are chained and contribute to delay in every hop, results in difficulties to achieve the latency requirement for some services targeting at ultra-reliable low-latency, e.g., interactive AR/VR gaming, remote control of UAV, Audio-Visual Service Production, industrial automation, critical medical applications, self-driving vehicles, etc.
Third, from users' perspective, the service experiences may be compromised when considering service continuity, e.g., in roaming scenarios among HPLMN and VPLMNs, or among PLMN and NPN networks.
Fourth, demands for supporting versatile vertical services are increasing in 5G, which bring challenges in support of service functions in N6-LAN in different networks and services deployment scenarios and in fulfilling required KPIs for the services.
Fifth, there are some advanced features in 5G network, e.g., network slicing, network function virtualization, and edge computing, etc., not considered in the FMSS/eFMSS.

Solutions to tackle the abovementioned challenges include enabling service function chaining service in the 5GS, which provides tighter control of service function chaining. The present disclosure provides solutions to enable SFC network in Edge data network (DN) and/or 5G network.

For example, the present disclosure provides embodiments for scenarios where the SFs in an SFC path are across both of the Edge Data Network and 5G network. The embodiments include:
Embodiment 1: SFC enabler in both Edge Data Network and 5G Network.
Embodiment 2: SFC parameters for SFC network configuration.
Embodiment 3: SFC service coordination between Edge Data Network and 5G network.
Embodiment 4: Operations, Administration, and Maintenance (OAM) entity provides SFCF-U configuration information of the SFCF-U instances.
Embodiment 5: SFC configuration in 3GPP management plane.
Embodiment 6: SFCF-C configures SFPs to be coordinated with SFC network in Edge Data Network.

Additionally, the present disclosure provides embodiments to enable SFC service at the Edge Data Network. These embodiments include:
Embodiment 7: enable SFC network support at Edge Data Network
Embodiment 8: application architecture with support of SFC network in Edge Data Network
Embodiment 9: SFC parameters for SFC network configuration
Embodiment 10: Application Server Provider (ASP) provides SFC service
Embodiment 11: Edge Computing Service Provider (ECSP) provides SFC service at Edge Data Network
Embodiment 12: SFC configuration in 3GPP management plane
Embodiment 13: EAS triggered AF inferencing traffic routing in 5GS (with DPI capability)

Aspects of various embodiments herein may be used in combination or separately. The embodiments herein resolve the challenges/issues presented by the previous and existing solutions. In some implementations, the present embodiments turn these challenges turn into benefits. Also, introducing SFC service at Edge Data Network enables the support of consolidated orchestration and management in 3GPP management plane.

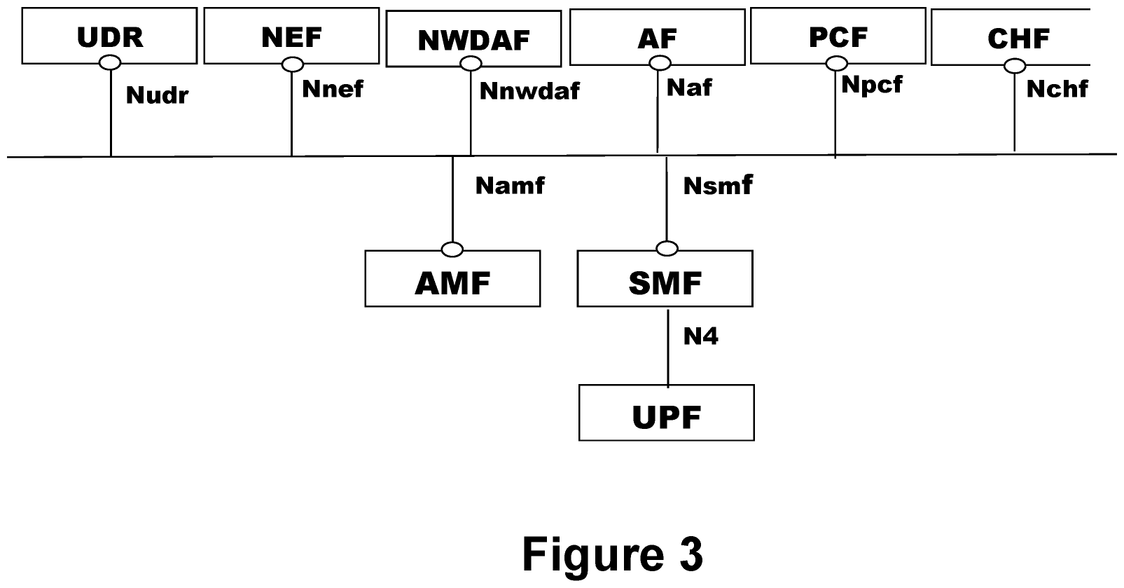

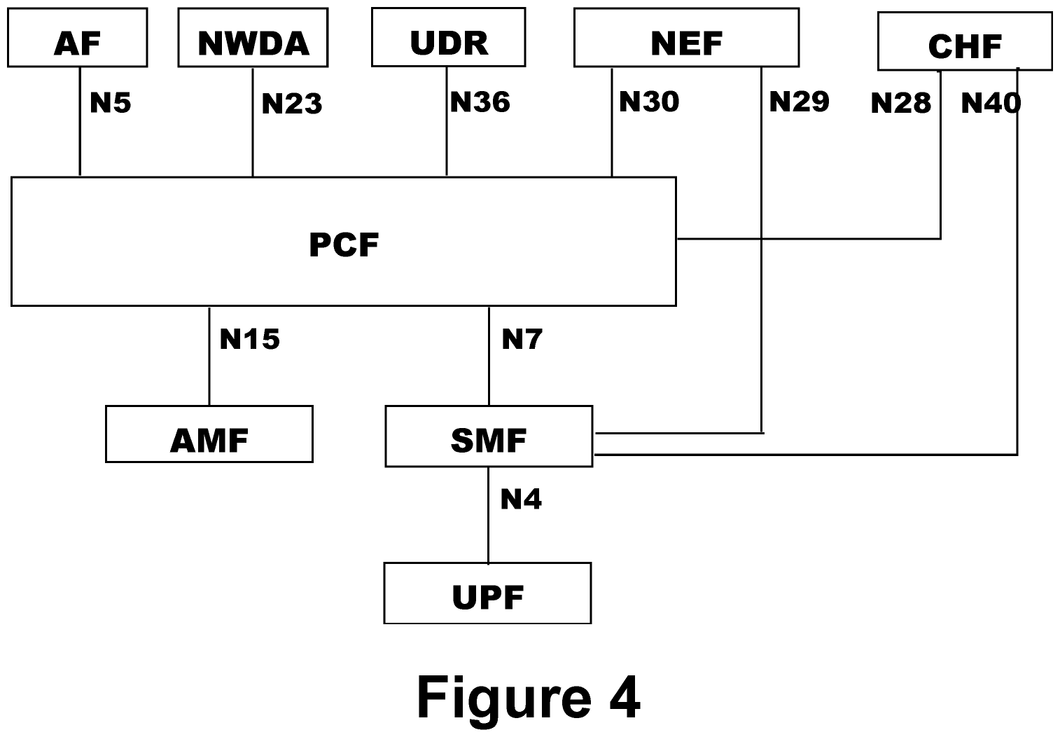

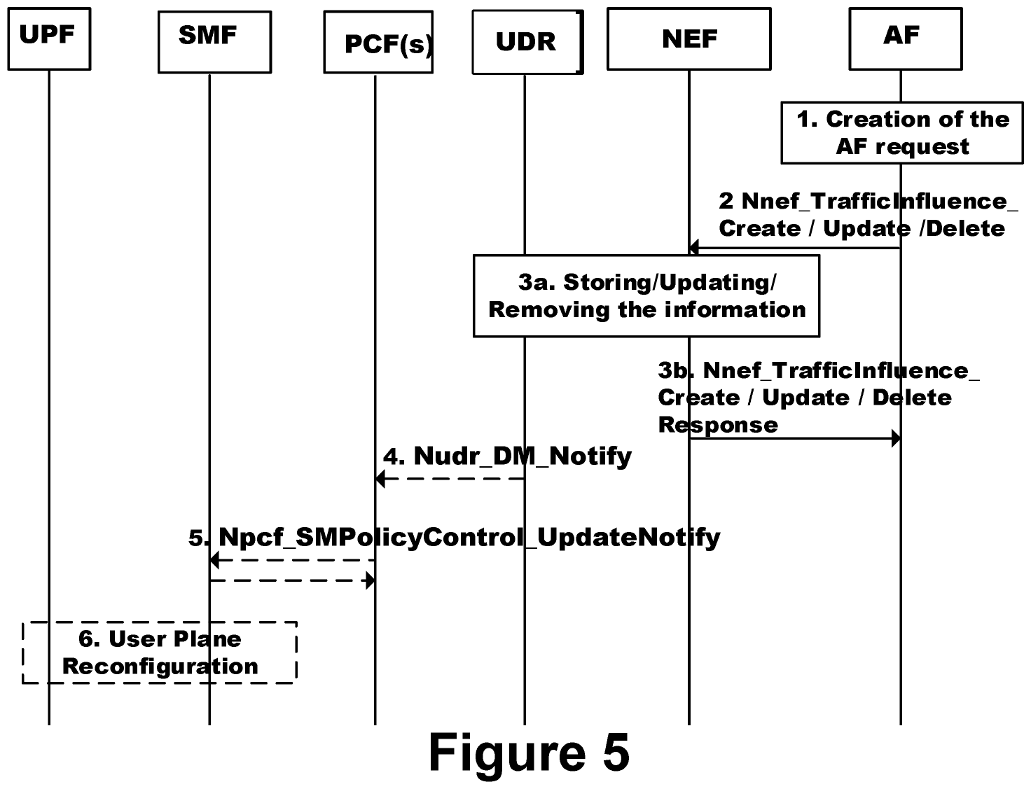

FIGS. 3 and 4 (corresponding to FIGS. 5.2.1-1 and 5.2.1-1a from TS 23.503 show the overall architecture for policy and charging framework in the 5G system in both service-based and reference point representation. The reference architecture of policy and charging control framework for the 5GS includes the policy control function (PCF), session management function (SMF), user plane function (UPF), access and mobility management function (AMF), network exposure function (NEF), Network Data Analytics Function (NWDAF), Charging Function (CHF), Application Function (AF), and Unified Data Repository (UDR). FIG. 3 shows the service based representation and FIG. 4 shows the reference point representation of the reference architecture of policy and charging control framework for the 5G System.

The N4 reference point is not part of the 5G Policy Framework architecture but shown in the figures for completeness (see e.g., 3GPP TS 23.501 v16.4.0 (2020 Mar. 27) (“TS 23.501” or [4]) for N4 reference point definition). How the PCF/NEF stores/retrieves information related with policy subscription data or with application data is defined in TS 23.501. The Nchf service for online and offline charging consumed by the SMF is defined in TS 32.240 v16.1.0 (2019 December) (“TS 32.240” or [8]). The Nchf service for Spending Limit Control consumed by the PCF is defined in TS 23.502 v16.4.0 (2020 Mar. 27) (“TS 23.502” or [5]).

According to TS 23.502 [5] clause 4.3.6, AF influence on traffic routing as described in clause 5.6.7 of TS 23.501 [4]. An AF may send requests to influence SMF routing decisions for User Plane traffic of PDU Sessions. The AF requests may influence UPF (re)selection and allow routing of user traffic to a local access (identified by a DNAI) to a Data Network. The AF may also provide in its request subscriptions to SMF events. FIG. 5 (corresponding the FIG. 4.3.6.2-1 of TS 23.502) illustrates processing of AF requests to influence traffic routing for sessions not identified by a UE address.

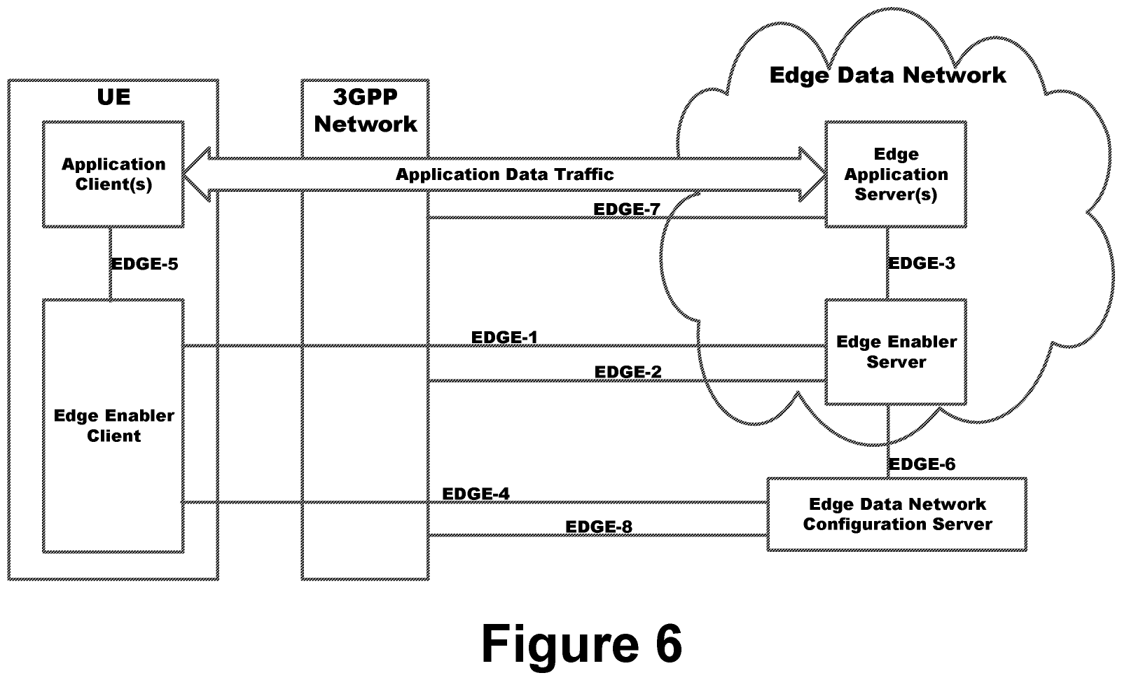

FIG. 6 shows an application architecture for enabling Edge Applications. The Edge Data Network is a local Data Network. Edge Application Server(s) and the Edge Enabler Server are contained within the EDN. The Edge Configuration Server provides configurations related to the EES, including details of the Edge Data Network hosting the EES. The UE contains Application Client(s) and the Edge Enabler Client. The Edge Application Server(s), the Edge Enabler Server, and the Edge Configuration Server may interact with the 3GPP Core Network.

The interactions related to enabling Edge Computing, between the Edge Enabler Server and the Edge Enabler Client are supported by the EDGE-1 reference point. EDGE-1 reference point supports: Registration and de-registration of the Edge Enabler Client to the Edge Enabler Server;

Retrieval and provisioning of configuration information for the UE; and Discovery of Edge Application Servers available in the Edge Data Network.

The interactions related to Edge Enabler Layer, between the Edge Enabler Server and the 3GPP Network are supported by the EDGE-2 reference point. EDGE-2 reference point supports: Access to 3GPP Network functions and APIs for retrieval of network capability information, e.g., via SCEF and NEF APIs as defined in 3GPP TS 23.501 [4], TS 23.502 [5], TS 29.522 [9], TS 29.122 [10], and with the EES acting as a trusted AF in 5GC (see the clause 5.13 of TS 23.501 [4]). EDGE-2 reference point reuses SA2 defined 3GPP reference points, N33, or interfaces of EPS or 5GS considering different deployment models.

The interactions related to Edge Enabler Layer, between the Edge Enabler Server and the Edge Application Servers are supported by the EDGE-3 reference point. EDGE-3 reference point supports: Registration of Edge Application Servers with availability information (e.g., time constraints, location constraints); De-registration of Edge Application Servers from the Edge Enabler Server; and Providing access to network capability information (e.g., location information). The following cardinality rules apply for EDGE-3 (Between EAS and EES): a) One EAS may communicate with only one EES; b) One EES may communicate with one or more EAS(s) concurrently.

The interactions related to Edge Enabler Layer, between the Edge Data Network Configuration Server and the Edge Enabler Client are supported by the EDGE-4 reference point. EDGE-4 reference point supports: Provisioning of Edge Data Network configuration information to the Edge Enabler Client in the UE.

The interactions between Application Client(s) and the Edge Enabler Client in the UE are supported by the EDGE-5 reference point. EDGE-5 reference point supports: Obtaining information about Edge Application Servers that Application Client require to connect; Notifications about events related to the connection between Application Clients and their corresponding Edge Application Servers, such as: when an Application Client needs to reconnect to a different Edge Application Server; Providing Application Client information (such as its profile) to be used for various tasks such as, identifying the appropriate Edge Application Server instance to connect to; and Provide the identity of the desired Edge Application Server to the Edge Enabler Client to enable it to use that identity as a filter when requesting information about Edge Application Servers.

The interactions related to Edge Enabler Layer, between the Edge Data Network Configuration Server and the Edge Enabler Server are supported by the EDGE-6 reference point. EDGE-6 reference point supports: Registration of Edge Enabler Server information to the Edge Enabler Network Configuration Server.

The interactions related to Edge Enabler Layer, between the Edge Enabler Server and the 3GPP Network are supported by the EDGE-2 (or EDGE-7) reference point. EDGE-7 reference point supports: Access to 3GPP Network functions and APIs for retrieval of network capability information, e.g., via SCEF and NEF APIs as defined in 3GPP TS 23.501 [4], TS 23.502 [5], TS 29.522 [9], TS 29.122 [10], and with the EAS acting as a trusted AF in 5GC (see the clause 5.13 of TS 23.501 [4]). EDGE-7 reference point reuses SA2 defined 3GPP reference points, N6, or interfaces of EPS or 5GS considering different deployment models.

The interactions between the Edge Data Network Configuration Server and the 3GPP Network are supported by the EDGE-8 reference point. EDGE-8 reference point supports: Edge Data Network configurations provisioning to the 3GPP network utilizing network exposure services.

EDGE-9 reference point enables interactions between two Edge Enabler Servers. EDGE-9 reference point may be provided between EES within different EDN (FIG. 6.4.10-1 of TS 23.758) and within the same EDN (FIG. 6.4.10-2 of TS 23.758).

The Edge Enabler Server (EES) provides supporting functions needed for Edge Application Servers and Edge Enabler Client. Functionalities of Edge Enabler Server are: a) provisioning of configuration information to Edge Enabler Client, enabling exchange of application data traffic with the Edge Application Server; b) supporting the functionalities of API invoker and API exposing function as specified in [11]; c) interacting with 3GPP Core Network for accessing the capabilities of network functions either directly (e.g., via PCF) or indirectly (e.g., via SCEF/NEF/SCEF+NEF); and d) support the functionalities of application context transfer.

The following cardinality rules apply for Edge Enabler Server: a) One or more EES(s) may be located in an EDN; b) One or more EES(s) may be located in an EDN per ECSP

The Edge Application Server (EAS) is the application server resident in the Edge Data Network, performing the server functions. The Application Client connects to the Edge Application Server in order to avail the services of the application with the benefits of Edge Computing. It is possible that the server functions of an application are available only as Edge Application Server. However, if the server functions of the application are available as both, Edge Application Server and an Application Server resident in cloud, it is possible that the functions of the Edge Application Server and the Application Server are not the same. In addition, if the functions of the Edge Application Server and the Application Server are different, the Application Data Traffic may also be different.

The Edge Application Server may consume the 3GPP Core Network capabilities in different ways, such as: a) it may invoke 3GPP Core Network function APIs directly, if it is an entity trusted by the 3GPP Core Network; b) it may invoke 3GPP Core Network capabilities through the Edge Enabler Server; and c) it may invoke the 3GPP Core Network capability through the capability exposure functions (e.g., SCEF or NEF).

The following cardinality rules apply for Edge Application Servers: a) One or more EAS(s) may be located in an EDN. The EAS(s) belonging to the same EAS ID can be provided by multiple ECSP(s) in an EDN.

The Edge Enabler Server ID (EESID) is the FQDN of that Edge Enabler Server and each Edge Enabler Server ID is unique within PLMN domain.

The Edge Application Server ID (EASID) identifies a particular application for e.g., SA6Video, SA6Game etc. For example, all Edge SA6Video Servers will share the same Edge Application Server ID. The format for the EAS ID is out of scope of this specification. Table 0-8.2.4-1 shows Edge Application Server Profile IEs.

TABLE 0-8.2.4-1
Edge Application Server Profile

| Information element | Status | Description |
|---|---|---|
| EAS ID | M | The identifier of the EAS |
| EAS Endpoint | M | Endpoint information (e.g., URI, FQDN, IP address) used |
| | | to communicate with the EAS. This information maybe |
| | | discovered by EEC and exposed to Application Clients so |
| | | that application clients can establish contact with the EAS. |
| Application Client ID(s) | O | Identifies the Application Client(s) that can be served by the EAS |
| EAS Provider Identifier | O | The identifier of the EAS Provider |
| EAS Type | O | The category or type of EAS (e.g., V2X) |
| EAS description | O | Human-readable description of the EAS |
| EAS Schedule | O | The availability schedule of the EAS (e.g., time windows) |
| EAS Service Area | O | The geographical service area that the EAS serves |
| EAS Service KPIs | O | Service characteristics provided by EAS, detailed in Table 8.2.5-1 |
| Service continuity support | O | Indicates if the EAS supports service continuity or not. |
| EAS Availability Reporting Period | O | The availability reporting period (e.g., heart beat period) |
| | | that indicates to the EES how often it needs to check the |
| | | EAS's availability after a successful registration. |
| EAS Required Service APIs | O | A list of the Service APIs that are required by the EAS |
| EAS Status | O | The status of the EAS (e.g., enabled, disabled, etc.) |

Edge Application Server Service KPIs provide information about service characteristics provided by the Edge Application Server (see e.g., table 0-8.2.5-1).

TABLE 0-8.2.5-1
Edge Application Server Service KPIs

| Information element | Status | Description |
|---|---|---|
| Maximum Request | O | Maximum request rate from the |
| rate | | Application Client supported by the |
| | | server. |
| Maximum Response | O | The maximum response time advertised |
| time | | for the Application Client's service |
| | | requests. |
| Availability | O | Advertised percentage of time the server |
| | | is available for the Application Client's |
| | | use. |
| Available Compute | O | The maximum compute resource available |
| | | for the Application Client. |
| Available Graphical | O | The maximum graphical compute |
| Compute | | resource available for the Application |
| | | Client. |
| Available Memory | O | The maximum memory resource available |
| | | for the Application Client. |
| Available Storage | O | The maximum storage resource available |
| | | for the Application Client. |
| Connection | O | The connection bandwidth in Kbit/s |
| Bandwidth | | advertised for the Application Client's use. |

NOTE:
The maximum response time includes the round-trip time of the request and response packet, the processing time at the server and the time required by the server to consume 3GPP Core Network capabilities, if any.

The Edge Enabler Server profile includes information about the EES and the services it provides (see e.g., table 0-8.2.6-1).

TABLE 0-8.2.6-1
Edge Enabler Server Profile

| Information element | Status | Description |
|---|---|---|
| EES ID | M | The identifier of the EES |
| EES Endpoint | M | Endpoint information (e.g., URI, FQDN, |
| | | IP address) used to communicate with |
| | | the EES. This information isprovided |
| | | to the EEC to connect to the EES. |
| Edge Application | M | List of Edge Application Servers |
| Server Profiles | | registered with the EES. |
| EES Provider | O | The identifier of the EES Provider |
| Identifier | | (such as ECSP) |

The network capability exposure to Edge Application Server(s) depends on the deployment scenarios and the business relationship of the ASP/ECSP with the PLMN operator. The following mechanisms are supported: Direct network capability exposure and/or Network capability exposure via Edge Enabler Server.

In some implementations, the network capability exposure to EAS(s) depends on the deployment scenarios and the business relationship of the ASP/ECSP with the PLMN operator. The following mechanisms are supported: Direct network capability exposure and/or Network capability exposure via Edge Enabler Server. In some implementations, the charging functionalities with different deployment options depending on business relationships among Edge Application Service Provider, Edge Computing Service Provider, and SFC service provider are out of scope of the present disclosure (SA5 study).

In TS 23.203 [12], a solution to handle traffic steering policy with coordination with SFC in (S)Gi-LAN is described, which is out of 3GPP systems.

Among other things, the present disclosure provides embodiments related to SFC in the following scenarios:
SFs in a Service Function Paths (SFPs) for service chaining are across both of Edge Data Network and 5G network, which has never been considered in any previous or existing solution.
SFC Network with SFs and Service Function Paths (SFPs) are provided by the Edge Data Network, e.g., by Edge Application Service provider and/or Edge Computing Service provider.

Service Chaining with Service Function Path Across Edge Data Network and 5G-Network

The present embodiments resolve the challenges discussed above and turn these challenges into benefits. Also, the coordination of SFC services between Edge Data Network and 5G network enable the support of consolidated orchestration and management in 3GPP management plane.

In various embodiments and example implementations discussed herein, the network capability exposure to Edge Application Server(s) may depend on the deployment scenarios and the business relationship of the ASP/ECSP with the PLMN operator. The following mechanisms are supported: Direct network capability exposure and/or Network capability exposure via Edge Enabler Server. The charging functionalities with different deployment options depending on business relationships among Edge Application Service Provider, Edge Computing Service Provider, and SFC service provider are out of scope of the present disclosure.

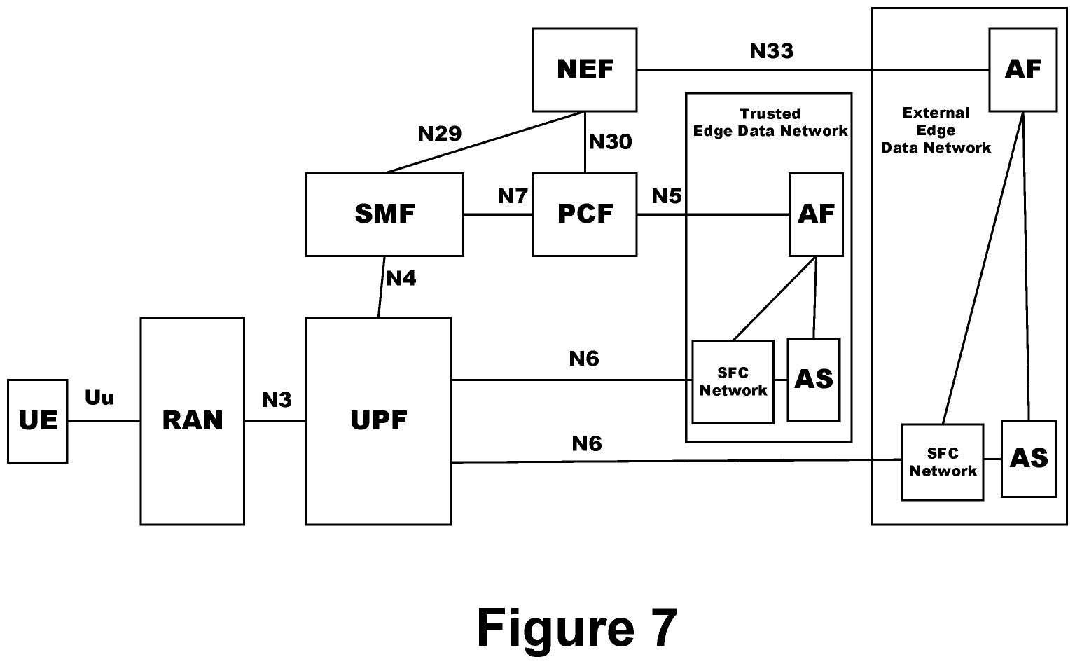

FIG. 7 shows a reference architecture that includes SFC network in Edge Data Network according to various embodiments (partial network functions are included in this reference architecture). The service function chaining service is provided at Edge Data Network by enabling support of service function chaining network (SFC Network), which terminates N6 reference points with trusted data networks or external data networks. The service function chaining policy for steering traffic that needs to pass through a specific Service Function Path (SFP) in SFC network can be configured by AS, AF, or 3GPP OAM. For application server (AS) in the external data network, the AF can inference the traffic routing, e.g., over N6 towards the SFC network at Edge data network, via NEF over N33 interface. For AS in trusted data network, the AF can interfere the traffic routing, e.g., over N6 towards the SFC network at Edge data network, via PCF directly over N5 interface.

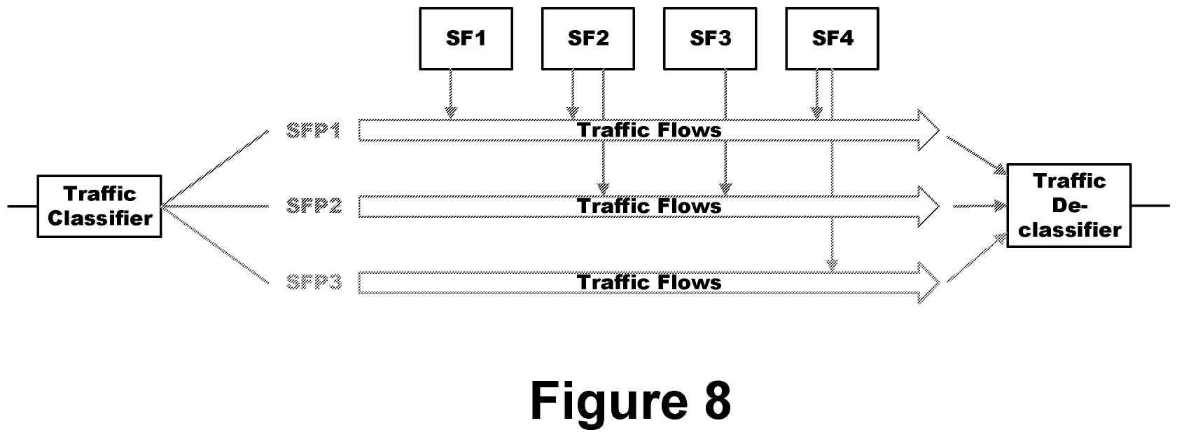

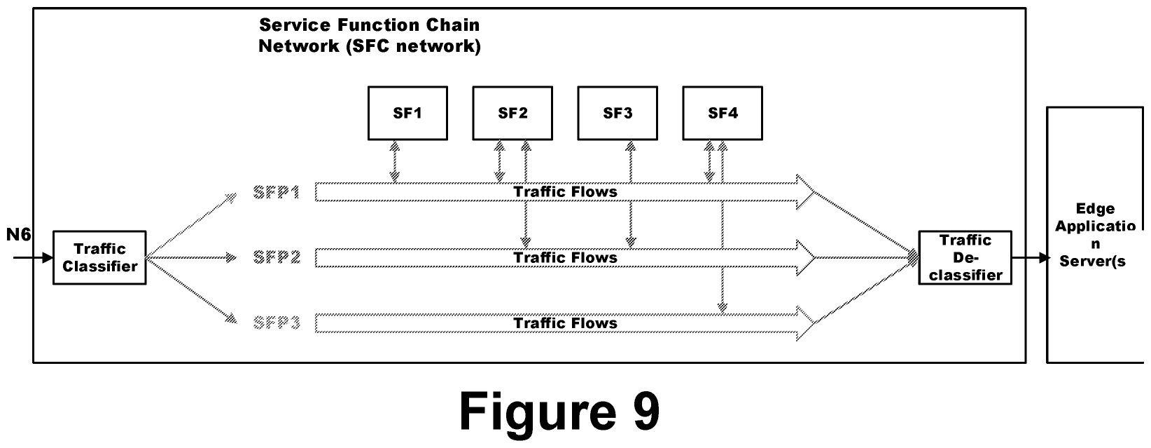

FIG. 8 shows an example of the SFC enablers in Edge Data Network and/or 5G network according to various embodiments. FIG. 9 depicts an example of an SFC network at Edge Data Network with one or more SFPs. In particular, FIG. 9 shows an example of an SFC network with traffic classifier, traffic declassifier, one or more SFs and SFPs, in which traffic flows in each SFP transports through the ordered service functions.

In FIGS. 8 and 9, SFC network contains traffic classifier, traffic declassifier, and SFs, which can handle one or more SFPs. Each SFP contain an ordered SFs that traffic needs to pass through. One or more SFs can be provided by same or different service providers, e.g., edge application service provider(s), the Edge computing service provider(s), SFC service providers, or network operator(s). Depending on the deployment options, the SFC network configuration can be supported over EDGE-X and EDGE-Y, accordingly.

The EDGE-X is the interface between the SF/Traffic classifier/Traffic De-Classifier in SFC network and EAS. The EDGE-Y is the interface between the SF/Traffic classifier/Traffic De-Classifier in SFC network and EES. The traffic classifier and traffic de-classifier are with traffic filtering policies to classify and combine the traffic flows for each SFP before and after SFPs handling, respectively. For the traffic flows that are not assigned an SFP, it skips all the SFs in the SFC network.

As non-limiting examples, the SF in FIGS. 8 and 9 can be one of the following functions:
Network address translation (NAT),
IP tunnel endpoints,
Packet classifiers,
deep packet inspection (DPI),
Lawful inspection (LI),
TCP proxies,
load balancers,
Firewall functions,
Transcoders,
URL filter,
Application detection and control (ADC),
video optimizer.

In embodiments, the SFC with the SFs in one or more SFC paths are across both of SFC Network in Edge Data Network and SFC functions (SFCFs) in 5G network. That is, some SFs are in 5G network and some SFs are in Edge Data Network for constituting one or more service function paths. In embodiments, the SFC enabler in Edge Data Network is at SFC Network, containing SFs for one or more SFPs, which can be provided by Edge Application Service provider, Edge Computing Service provider, or SFC network service providers. In embodiments, the SFC enabler in 5G network provides SFC services to Edge Application Servers, which can be provided by Network Functions with SFC capabilities including SFC configuration, SFC control, and traffic transport for SFPs, etc. In embodiments, the SFC enabler in 5G network or Edge Data Network supports the following SFC functions.

### Embodiment 1: SFC Enabler in Both of Edge Data Network and 5G-Network

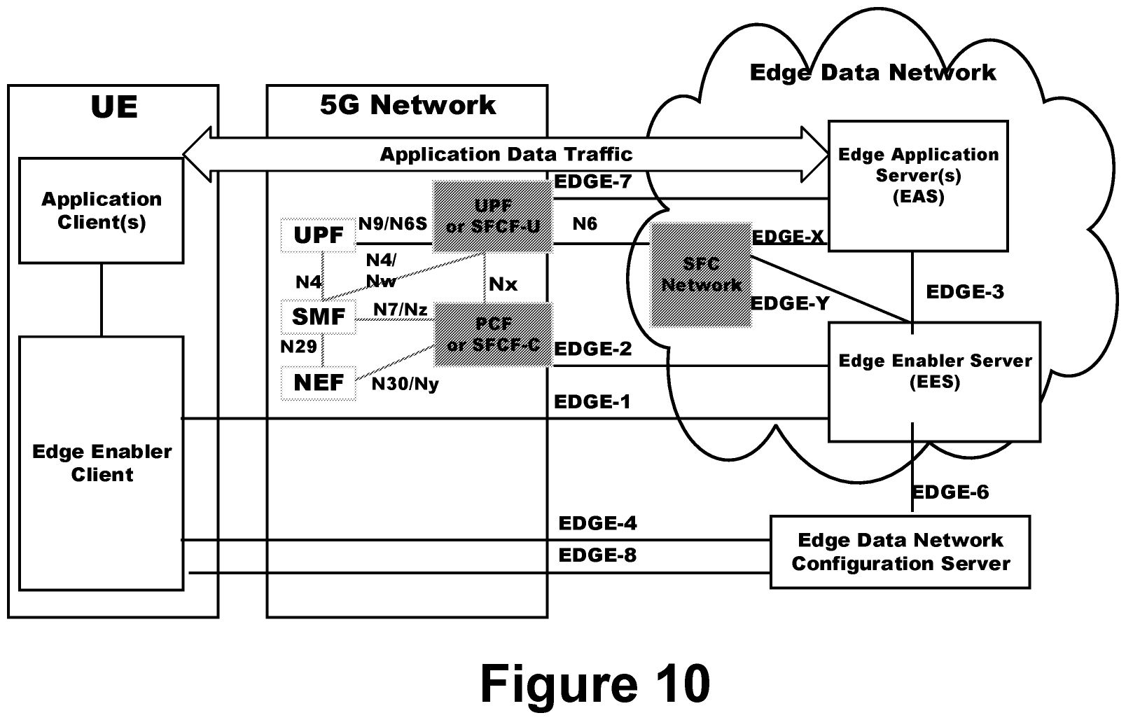

FIG. 10 shows the application architecture of the Edge Data Network enabling SFC service via SFC network and the using SFC services provide by 5G network, according to various embodiments.

In embodiment 1.1, the SFC Network terminates N6 reference points with trusted Edge data networks or external Edge data networks depending on the deployment scenarios and the business relationship of the Edge Application Service Provider or Edge Computing Service Provider with the PLMN operator.

EAS or EES in Edge Data Network can support AF to interact with 5G network via northbound APIs, e.g. 5G network capability exposure APIs (Nnef_trafficInferencing_Create/Update/Delecte message), of the 5G network over Edge-7 or Edge-2 interfaces, respectively. For Edge Data Network in the external data network, the AF can inference the traffic routing with or without SFC (e.g., over N6 towards the SFC network at Edge data network), via NEF over N33 interface (e.g., Edge-7/Edge-2). For Edge Data Network in trusted data network, the AF can interfere the traffic routing with or without SFC, i.e. over N6 towards the SFC network at Edge data network, via PCF directly over N5 interface (e.g., Edge-7/Edge-2).

As shown in FIGS. 8, 9, and 10, the SFC network providing SFC services contains the service functions and one or more service function paths with corresponding ordered SFs that traffic needs to pass through. The EDGE-X is the interface between the SF/Traffic classifier/Traffic De-Classifier in SFC network and EAS. The EDGE-Y is the interface between the SF/Traffic classifier/Traffic De-Classifier in SFC network and EES. The traffic classifier and traffic de-classifier are with traffic filtering policies to classify and combine the traffic flows for each SFP before and after SFPs handling, respectively. For the traffic flows that are not assigned an SFP, it skips all the SFs in the SFC network.

The SFC services of the SFC network can be provided by one or more service providers, including edge service provider(s), the Edge computing service provider(s), SFC network service providers, or network operator(s).

Depending on the deployment options, the SFC network configuration, including service function chaining policies for steering traffic that needs to pass through a specific Service Function Path (SFP) in SFC network, can be configured by 3GPP OAM or by the EAS(s) and EES(s) over EDGE-X and EDGE-Y, accordingly.

### a. Embodiment 1.2: The SFC Enabler in 5G-Network

In embodiment 1.2, the service function chain in 5G network can be supported in NFs with the following SFC capabilities:
SFC user plane function (SFCF-U): mainly for transporting traffic, which can be a stand-alone user plane function for SFC service or supported by an enhanced UPF with SFCF-U functions for SFC services.
   The SFCF-U can be a stand-alone user plane function or an enhanced UPF with SFCF-U functionalities for SFC handling.
SFC control plane function (SFCF-C): manage SFC policies and configure SFCF-U over a new interface Nx, in which SFCF-U interfaces with UPF over a new reference point N6S to steer traffic received from UPF, as shown in FIG. 10.
   The SFCF-C is with functionalities as SMF and PCF, which can be alternative architecture designs to enhance SMF and/or PCF with SFCF-C functions for SFC services.

According to various embodiments, SFCF-C and SFCF-U are used to indicate the support of SFC enablers in control plane and user plane at 5G network, respectively, but the solutions do not limit to the stand-alone NFs, i.e. the solutions are applicable to different deployment options including enhancement of UPF for SFCF-U, and enhancement of SMF and PCF with SFC capabilities for SFCF-C.

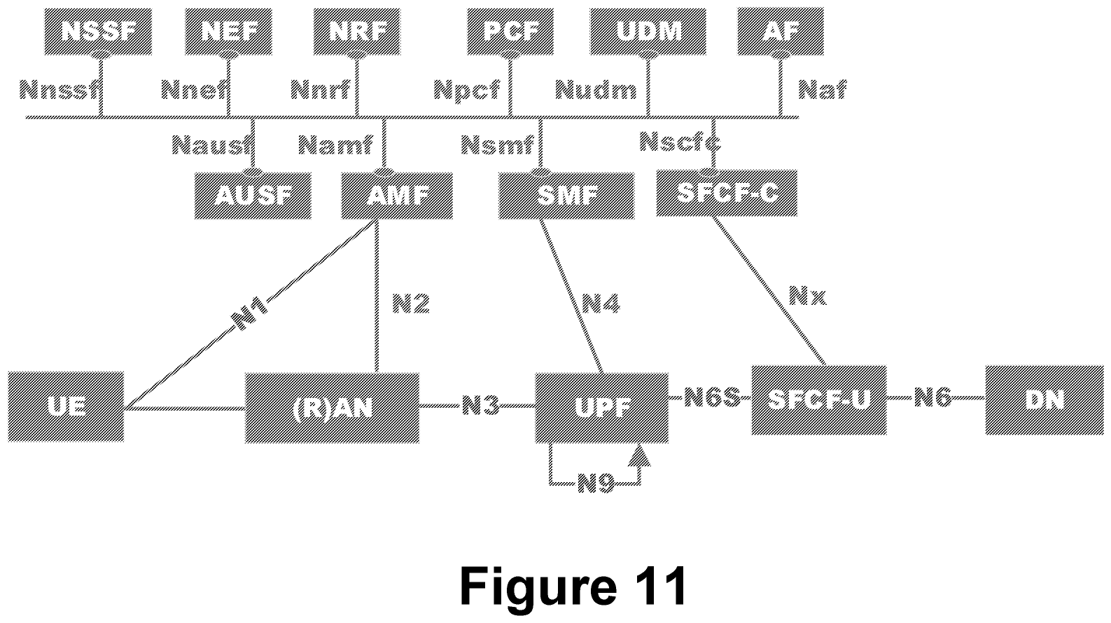

FIG. 11 shows the corresponding service-based architecture with SFC enabler in 5G network.
The SFC policy for steering traffic that needs to pass through a specific Service Function Path (SFP) can be configured at SFCF-U by SFCF-C.
The SMF configures a UPF with routing paths towards one or more SFCF-U(s) for SFC services.
The UPF forwards the traffic to one or more SFCF-U(s) to pass through configured SFPs identified by SFP
The SMF bases on SFC policies provided by SFCF-C via a new interface Nz.
The AF in Edge Data Network can interact with SFCF-C directly or via NEF. In this case, the message between SFCF-C and NEF is over a new interface Ny, to support SFC configuration.
   Alternatively, there are the following alternative options:
If SMF is with SFC functionalities for steering traffic for SFC services in SFCF-U based on SFC configuration, i.e. with part of functionality of the SFCF-C function, the SMF configures SFCF-U over a new interface Nw.
If PCF can support handling of SFC configuration, i.e. with part of functionality of the SFCF-C function, the SFCF-C is at PCF.
If UPF can support SFCF-U capability, the UPF can forward the traffic to UPF with SFCF-U over N9 interface.

### b. Embodiment 1.3: The Coordination of SFC Services in Edge Data Network and 5G-Network

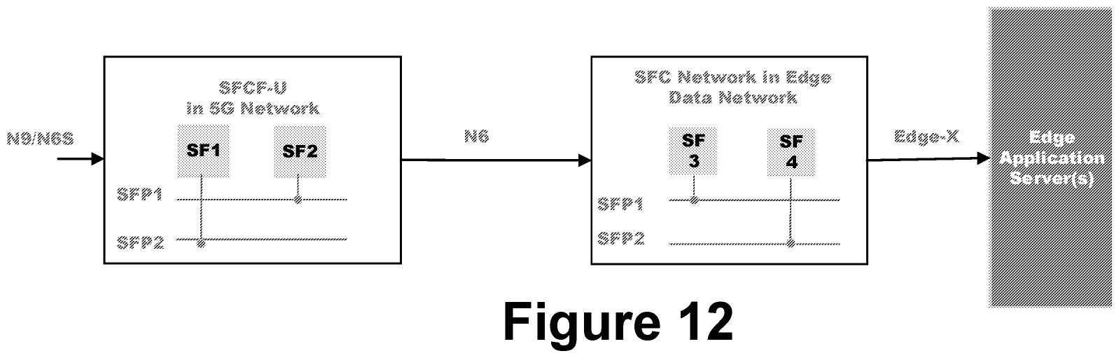

Following embodiments 1.1, 1.2 and/or any other embodiment herein, in embodiment 1.3, the SFC services for an application can be provided by Edge DN and 5G Network. For example, as shown in FIG. 12, the SF1, SF2 can be in 5G Network while the SF3, and SF4 can be in SFC network of the Edge Data Network, in which SFP1 contains SF2 and SF3 and SFP2 contains SF1 and SF4. The EAS directly or via EES configures the SFC network with SF3 and SF4 and part of SFP1 and SFP2 and sends AF requests to 5G network to configure SF1 and SF2 in 5G network with part of SFP1 and SFP2, and to steer the traffic through N6 towards SFC network for the corresponding SFP1 and SFP2.

### Embodiment 2: SFC Parameters for SFC Network Configuration

Following embodiments 1.1, 1.2, 1.3, and/or any other embodiment herein, the SFC parameters of the SFC service in Edge Data Network or 5G Network can include the following information:
SFC service ID: the service ID of this set of SFC parameters for SFC service
SFC configuration: one or more SFs with the corresponding SF parameters
SFP configuration: the SFP index with the corresponding ordered SFs.
SFC routing policy:
   traffic classifier indicates the mapping between a SFP index and traffic filtering rules for forwarding traffic to the first SF in an SFP identified by an SFP index.
   traffic de-classifier indicates with traffic filter rules for combining traffic from the last SF in an SFP identified by an SFP index.
Validity parameters for the SFC service identified by the SFC service ID, for example:
   Duration
   Scheduled Time period, for example, Sam-8 pm every day, etc.
   Application ID(s)
   Associated PDU session parameters, including PDU session type, e.g. IP/Ethernet/Unstructure, DNN, or a slice/Service type (SST) (e.g., eMBB, URLLC, MIoT, V2X, etc) and optional slice differentiator (SD)
      The traffic classifier provides a SFP index with the mapping to SFC classification policy including one or more the following information based on different level or granularities per packet, for example:
UE address
Application ID
Media type
Traffic priorities
   When information is only available in traffic payload, the DPI capability at the traffic classifier is needed.
   The traffic de-classifier provides an “N6 tunnel ID”, which terminates N6 reference point of an DNAI (data network access ID) for an Data Network with the mapping to SFC re-classification policy including one or more the following information to combine traffics from one ore more SFPs before forwarding to the application server of an application, for example:
UE address
Application ID
Media type
Traffic priorities
SFP index
   When information is only available in traffic payload, the DPI capability at the traffic de-classifier is needed.

### Embodiment 3: SFC Service Coordination Between Edge Data Network and 5G-Network

Following embodiment 2 and/or any other embodiment herein, the EAS or EES can initiate AF requests for coordinating the SFC service in 5G network with the SFC service in Edge Data Network. In the case of EES with AF, the EAS can use EES APIs over Edge-3 interface to request the triggering of AF request from EES to 5G network, e.g. over N33 to NEF if the EES/EAS are in external edge data network, over N5 to PCF or over Nxx to SFCF-C if EES/EAS is in trusted Edge Data Network.

### c. Solution 3.1: Edge Application Server Provider (EASP) Provides SFC Service

Following embodiment 2 and/or any other embodiment herein, in embodiment 3.1 the AF requests sent by EAS towards NEF/PCF/SFCF-C directly or via EES using EES APIs to trigger AF at the EES for further creating AF request using 5G network capability exposure APIs to interact with NFs in the 5G network.

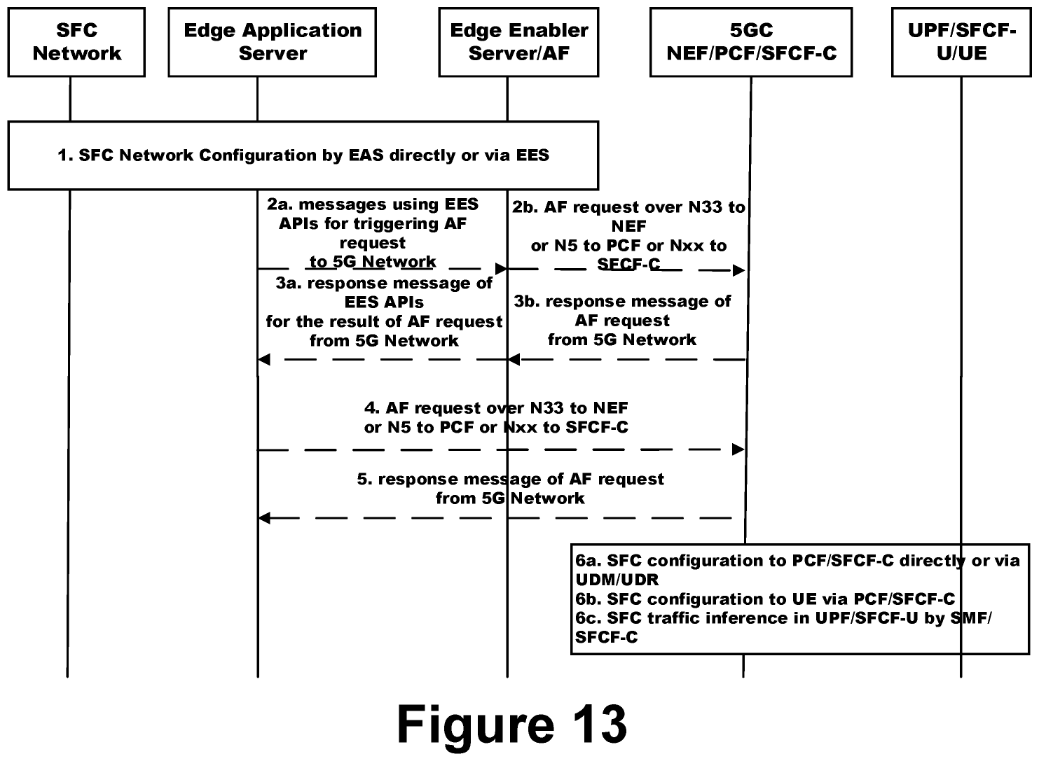

FIG. 13 shows an example procedure for SFC configuration coordination between SFC service at Edge Data Network and SFC services at 5G network according to various embodiments. The procedure of Example 13 may operate as follows.

Step 1: EAS configures SFC network directly via Edge-X or via EES via Edge-3 using EES APIs and Edge-Y interfaces.
Depending on the deployment scenarios as indicated in embodiment 1, where the EASP or ECSP provides SFC services in SFC network, the following two cases can be supported.
Case 1: the EASP provides SFC services to EAS(s) in EDGE Data Network. The EASP can use any of own EAS(s) to provision the SFC parameters of the SFC network for SFC service over EDGE-X interface by sending the SFC configuration request message to control and configure SFs and SFPs at SFC network.
Case 2: the ECSP provides SFC services to EAS(s) via EES in EDGE Data Network. Based on EES APIs to EAS for provisioning the SFC parameters for SFC service over EDGE-3 interface, the EES can trigger the SFC configuration request message to control and configure SFs and SFPs at SFC network over a new interface EDGE-Y.
   Step 2-3: for the case EES supporting AF, the EAS using EES capability exposure API can request EAS to send AF request using 5G network capability exposure for SFC services in 5G network. Step 4-5: for the case EAS supporting AF, the EAS can send AF requests directly to PCF/SFCF-C or via NEF
   Step 6: the AF request can request the following handling:
for SFC configuration at PCF/SFCF-C directly (embodiment 3.1) or via UDM/UDR (embodiment 3.2)
for SFC configuration at UE via PCF/SFCF-C (embodiment 3.3)
for user plane traffic inferencing at UPF/SFCF-U (embodiment 3.4) or UE (embodiment 3.3)

### d. Embodiment 3.1: Northbound APIs for AF Requests for Coordinating SFC Service in 5GS with SFC Network in Edge Data Network

Following embodiment 3 and/or any other embodiment herein, wherein the EAS sends AF request message (EAS ID and AF request) via AF directly or AF at Edge Enabler Server over Edge-3 and N33/N5/Nxx. The AF request is for setting up an AF session with required SFC parameters of SFC service configuration procedure. The AF session can be for existing PDU session or future session of a UE identified by UE address/GPSI, a group of UE identified by a list of UE addresses/External group identifier, or any UE for the application, or any UE for a SFC service identified by SFC service ID, in which the target of SFC service is indicated in the SFC parameters for SFC services.

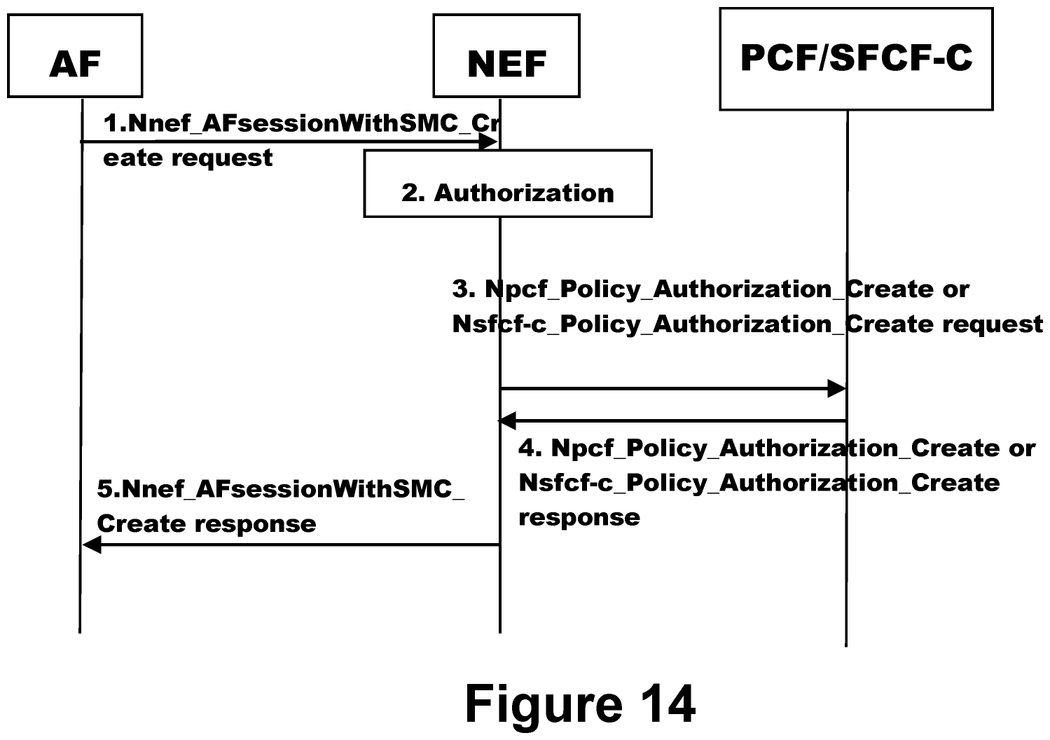

FIG. 14 shows an example procedure for setting up an AF session with required SFC parameters procedure, in accordance with various embodiments.
Step 1: When setting up the connection between AF and 5GS with required SFC parameters of SFC service configuration for an UE, a group of UE, or any UE, the AF sends an Nnef_AFsessionWithSFC_Create request message (UE-ID(s), AF Identifier, Description of the application flows, SFC parameters) to the NEF.
   The Nnef_AFsessionWithSFC_Create request message includes the SFC parameters of SFC service configuration, e.g. SFC service ID, to be created/updated/deleted as indicated in embodiment 2.
   The UE-ID can be:
      For an individual UE, the UE-ID can be GPSI or UE IP/Ethernet address
      For a group of UEs, the UE-ID(s) can be external group identifier or a list of UE IP/Ethernet addresses
      If UE-ID is not provided, the AF request is for any UE with the applications or the SFC service that is also indicated in SFC parameters for SFC services.
Optionally, a period of time or a traffic volume for the requested SFC parameters can be included in the AF request.
The NEF assigns a Transaction Reference ID to the Nnef_AFsessionWithSFC_Create request.
Step 5: The NEF sends a Nnef_AFsessionWithSFC_Create response message (Transaction Reference ID, Result) to the AF. Result indicates whether the request is granted or not.

### e. Embodiment 3.2: Northbound APIs for AF Requests for Service Specific Parameters Provisioning to UE/UE Group/any UE by Coordinating SFC Service Across the UE, 5G-Network, SFC Network in Edge Data Network

Following embodiment 3 and/or any other embodiment herein, the UDR stores the provisioned “SFC parameters of the SFC service configuration”. The AF request, for example, Nnef_ParameterProvisioning_Update request, is to provision SFC parameters for SFC service configuration via NEF and store SFC service configuration at UDM/UDR.

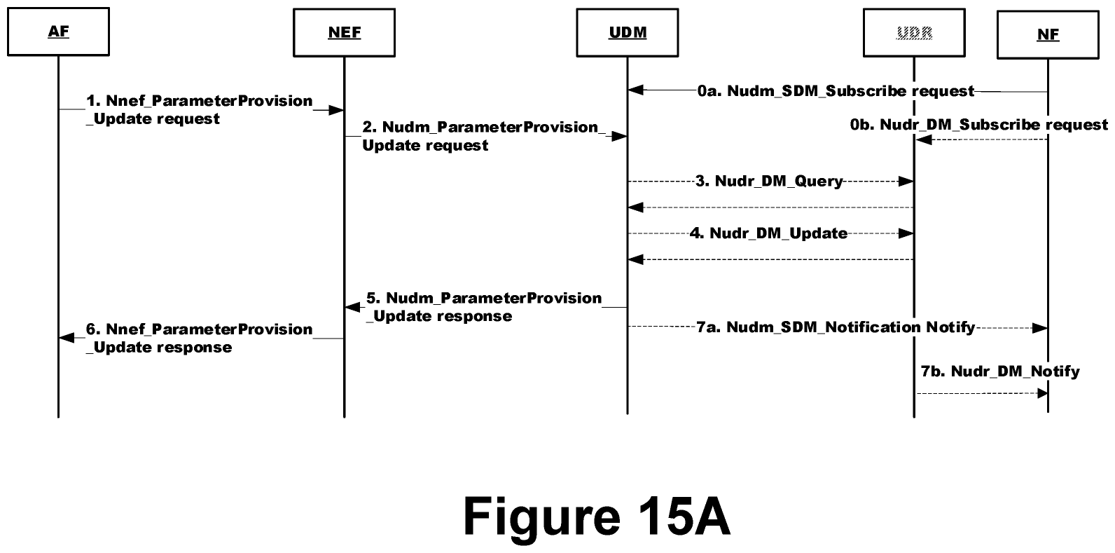

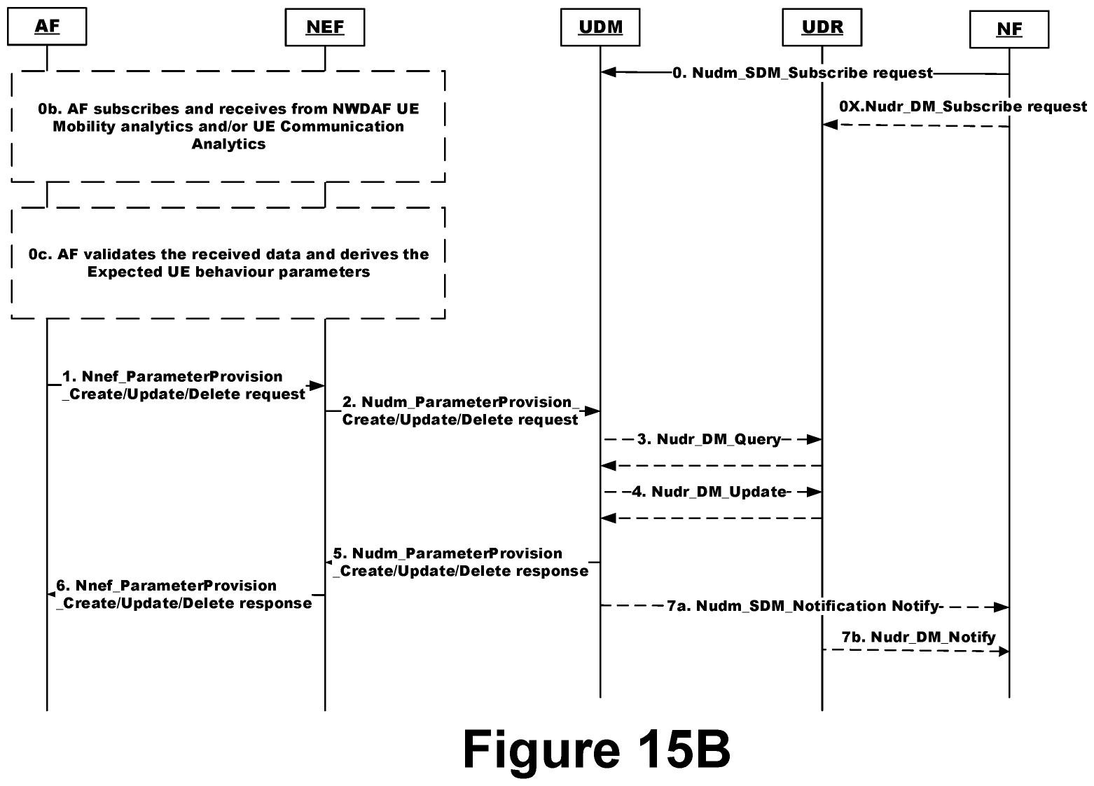

FIGS. 15A and 15B show examples of a modified/updated Nnef_ParameterProvision_update request/response procedure according to various embodiments. This procedure is a modified version of FIG. 4.15.6.2-1 in clause 4.15.6.2 of [5] that adds steps 0b and 7b. As shown by FIGS. 15A and 15B, the NEF service operations information as follows:
0. NF subscribes to UDM notifications of UE and/or Group Subscription data updates.
NOTE 1: The NF can subscribe to Group Subscription data from UDM in this step and be notified of Group Subscription data updates in step 7 using the Shared Data feature defined in TS 29.503 [52].
0b. [Conditional, on using NWDAF-assisted values] The AF may subscribe to NWDAF via NEF in order to learn the UE mobility analytics and/or UE Communication analytics for a UE or group of UEs by applying the procedure specified in [50] clause 6.1.1.2. The Analytics Id is set to any of the values specified in [50] clause 6.7.1.
0c. [Conditional, on using NWDAF-assisted values] AF validates the received data and derives any of the Expected UE behaviour parameters defined in clause 4.15.6.3 of [5] for a UE or group of UEs.
0x. the NF (e.g., PCF/SFCF-C) can subscribe to UDM or UDR notification of information updates of SFC service by indicating subscriber data related to SFC service, e.g. an application that is associated to an SFC service requested by an AF.
1. The AF provides one or more parameter(s) to be created or updated in a Nnef_ParameterProvision_Create or Nnef_ParameterProvision_Update or Nnef_ParameterProvision_Delete Request to the NEF.
   The GPSI identifies the UE and the Transaction Reference ID identifies the transaction request between NEF and AF. For the case of Nnef_ParameterProvision_Create, The NEF assigns a Transaction Reference ID to the Nnef_ParameterProvision_Create request.
   NEF checks whether the requestor is allowed to perform the requested service operation by checking requestor's identifier (i.e. AF ID).
   For a Create request associated with a 5G VN group, the External Group ID identifies the 5G VN Group.
   The payload of the Nnef_ParameterProvision_Update Request includes one or more of the following parameters:
      Expected UE Behaviour parameters (see clause 4.15.6.3), or
      Network Configuration parameters (see clause 4.15.6.3a), or
      External Group Id and 5G VN group data (i.e. 5G-VN configuration parameters) (see clause 4.15.6.3b), or
      5G VN group membership management parameters (see clause 4.15.6.3c of [5]).
      Location Privacy Indication parameters of the “LCS privacy” Data Subset of the Subscription Data (see clause 5.2.3.3.1 and [51] clause 7.1)
   The AF may request to delete 5G VN configuration by sending Nnef_ParameterProvision_Delete to the NEF.
   The AF provides SFC parameters of the SFC service configuration configurations to be updated at UDR in the Nnef_ParameterProvision_Update Request to the NEF, wherein the SFC parameters is following embodiment 2.
2. If the AF is authorised by the NEF to provision the parameters, the NEF requests to create, update and store, or delete the provisioned parameters as part of the subscriber data via Nudm_ParameterProvision_Create, Nudm_ParameterProvision_Update or Nudm_ParameterProvision_Delete Request message, the message includes the provisioned data and NEF reference ID.
   If the AF is not authorised to provision the parameters, then the NEF continues in step 6 indicating the reason to failure in Nnef_ParameterProvision_Create/Update/Delete Response message. Step 7 does not apply in this case.
NOTE 2: For non-roaming case and no authorisation or validation by the UDM required and if the request is not associated with a 5G VN group, the NEF can directly forward the external parameter to the UDR via Nudr_DM_Update Request message. And in this case, the UDR responds to NEF via Nudr_DM_Update Response message.
3. UDM may read from UDR, by means of Nudr_DM_Query, corresponding subscription information in order to validate required data updates and authorize these changes for this subscriber or Group for the corresponding AF.
4. If the AF is authorised by the UDM to provision the parameters for this subscriber, the UDM resolves the GPSI to SUPI, and requests to create, update or delete the provisioned parameters as part of the subscriber data via Nudr_DM_Create/Update/Delete Request message, the message includes the provisioned data.
   If a new 5G VN group is created, the UDM shall assign a unique Internal Group ID for the 5G VN group and include the newly assigned Internal Group ID in the Nudr_DM_Create Request message. If the list of 5G VN group members is changed or if 5G VN group data has changed, the UDM updates the UE and/or Group subscription data according to the AF/NEF request.
   UDR stores the provisioned data as part of the UE and/or Group subscription data and responds with Nudr_DM_Create/Update/Delete Response message.
   When the 5G VN group data (as described in clause 4.15.6.3b) is updated, the UDR notifies to the subscribed PCF by sending Nudr_DM_Notify as defined in clause 4.16.12.2.
   If the AF is not authorised to provision the parameters, then the UDM continues in step 5 indicating the reason to failure in Nudm_ParameterProvision_Update Response message and step 7 is not executed.
   The UDM classifies the received parameters (i.e. Expected UE Behaviour parameters or the Network Configuration parameters or the 5G VN configuration parameters or Location Privacy Indication parameters), into AMF-Associated and SMF-Associated parameters. The UDM may use the AF ID received from the NEF in step 2 to relate the received parameter with a particular subscribed DNN and/or S-NSSAI. The UDM stores the SMF-Associated parameters under corresponding Session Management Subscription data type.
   Each parameter or parameter set may be associated with a validity time. The validity time is stored at the UDM/UDR and in each of the NFs, to which parameters are provisioned (e.g. in AMF or SMF). Upon expiration of the validity time, each node deletes the parameters autonomously without explicit signalling.
5. UDM responds the request with Nudm_ParameterProvision_Create/Update/Delete Response. If the procedure failed, the cause value indicates the reason.
6. NEF responds the request with Nnef_ParameterProvision_Create/Update/Delete Response. If the procedure failed, the cause value indicates the reason.
   The NEF provides the result of the AF request for the update of SFC polices at UDM/UDR.
7. [Conditional this step occurs only after successful step 4] UDM notifies the subscribed Network Function (e.g., AMF) of the updated UE and/or Group subscription data via Nudm_SDM_Notification Notify message.
   a) If the NF is AMF, the UDM performs Nudm_SDM_Notification (SUPI or Internal Group Identifier, AMF-Associated parameters, etc.) service operation. The AMF identifies whether there are overlapping parameter set(s) and merges the parameter set(s) in the Expected UE Behaviour, if necessary. The AMF uses the received AMF-Associated parameters to derive the appropriate UE configuration of the NAS parameters and to derive Core Network assisted RAN parameters. The AMF may determine a Registration area based on parameters Stationary indication or Expected UE Moving Trajectory.
   b) If the NF is SMF, the UDM performs Nudm_SDM_Notification (SUPI or Internal Group Identifier, SMF-Associated parameter set, DNN/S-NSSAI, etc.) service operation.
      The SMF stores the received SMF-Associated parameters and associates them with a PDU Session based on the DNN and S-NSSAI included in the message from UDM. The SMF identifies whether there are overlapping parameter set(s) in the Expected UE behaviour and merges the parameter set(s), if necessary. The SMF may use the SMF-Associated parameters as follows:
         SMF configures the UPF accordingly. The SMF can use the Scheduled Communication Type parameter or Suggested Number of Downlink Packets parameter to configure the UPF with how many downlink packets to buffer. The SMF may use the parameter Communication duration time to determine to deactivate UP connection and to perform CN-initiated selective deactivation of UP connection of an existing PDU Session.
         The SMF may derive SMF derived CN assisted RAN information for the PDU Session. The SMF provides the SMF derived CN assisted RAN information to the AMF as described in PDU Session establishment procedure or PDU Session modification procedure.
NOTE 3: The NEF (in NOTE 1) or the UDM (in step 3) can also update the corresponding UDR data via Nudr_DM_Create/Delete as appropriate.
7b. The UDR sends Nudr_DM_Notify to NF.

### f. Embodiment 3.3: AF Request for UE Service Parameters Updates Via AMF

Following embodiment 3.2 and/or any other embodiment herein, the AF request indicating UE service parameters for SFC service configuration. Service specific parameter provisioning involves procecures for enabling the AF to provide service specific parameters to 5G system via NEF. The AF may issue requests on behalf of applications not owned by the PLMN serving the UE. In the case of architecture without CAPIF support, the AF is locally configured with the API termination points for the service. In the case of architecture with CAPIF support, the AF obtains the service API information from the CAPIF core function via the Availability of service APIs event notification or Service Discover Response as specified in 3GPP TS 23.222 [54].

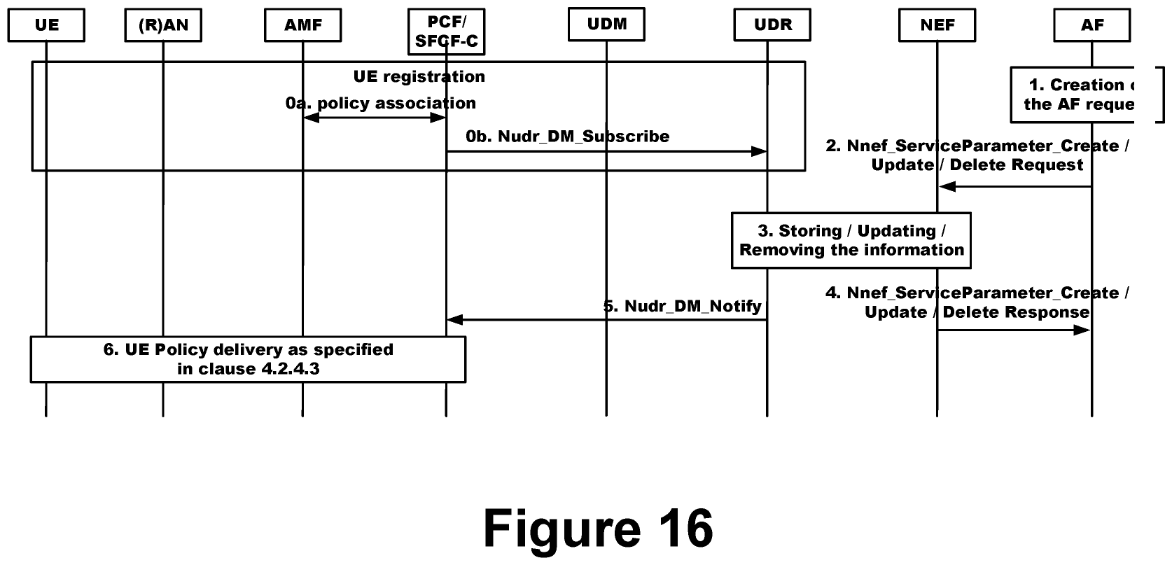

The AF request sent to the NEF contains the following information:
1) Service Description: Service Description is the information to identify a service the Service Parameters are applied to. The Service Description in the AF request can be represented by the combination of DNN and S-NSSAI, an AF-Service-Identifier or an application identifier.
2) Service Parameters: Service Parameters are the service specific information which needs to be provisioned in the Network and delivered to the UE in order to support the service identified by the Service Description.
3) Target UE(s) or a group of Ues: Target UE(s) or a group of UEs indicate the UE(s) who the Service Parameters shall be delivered to. Individual UEs can be identified by GPSI, or an IP address/Prefix or a MAC address. Groups of UEs can be identified by an External Group Identifiers as defined in TS 23.682 [23]. If identifiers of target UE(s) or a group of UEs are not provided, then the Service Parameters shall be delived to any UEs using the service identified by the Service Description.
   The NEF authorizes the AF request received from the AF and stores the information in the UDR as “Application Data”. The Service Parameters are delivered to the targeted UE by the PCF when the UE is reachable.
   FIG. 4.15.6.7-1 in [5] shows a procedure for service specific parameter provisioning. The AF uses Nnef_ServiceParameter service to provide the service specific parameters to the PLMN and the UE. FIG. 16 shows an example Service specific information provisioning procedure based on FIG. 4.15.6.7-1 in [5].

The procedure of FIG. 16 may operate as follows:
0. The SFC policy at PCF/SFCF-C is associated between AMF and PCF/SFCF-C during UE registration.
1. To create anew request, the AF invokes an Nnef_ServiceParameter Create service operation. To update or remove an existing request, the AF invokes an Nnef_ServiceParameter Update or Nnef_ServiceParameter Delete service operation together with the corresponding Transaction Reference ID which was provided to the AF in Nnef_ServiceParameter Create response message.
   The content of this service operation (AF request) includes the information described in clause 5.2.6.11 of [5].
   The AF request is for updating SFC policies in UDR and potentially triggering PCF/SFCF-C for updating SFC policies at the UE on existing PDU session or future PDU sessions.
2. The AF sends its request to the NEF. The NEF authorizes the AF request. The NEF performs the following mappings:
   Map the AF-Service-Identifier into DNN and S-NSSAI combination, determined by local configuration.
   Map the GPSI in Target UE Identifier into SUPI, according to information received from UDM.
   Map the External Group Identifier in Target UE Identifier into Internal Group Identifier, according to information received from UDM.
(in the case of Nnef_ServiceParameter Create): The NEF assigns a Transaction Reference ID to the Nnef_ServiceParameter Create request.
3. (in the case of Nnef_ServiceParameter Create or Update): The NEF stores the AF request information in the UDR as the “Application Data” (Data Subset setting to “Service specific information”) together with the assigned Transaction Reference ID.
   (in the case of Nnef_ServiceParameter delete): The NEF deletes the AF request information from the UDR.
4. The NEF responds to the AF. In the case of Nnef_ServiceParameter Create response message, the response message includes the assigned Transaction Reference ID. The NEF provides the result of update SFC polices at UDR.
   If the UE is registered to the network and the PCF performs the subscription to notification to the data modified in the UDR by invoking Nudr_DM_Subscribe (AF service parameter provisioning information, SUPI, Data Set setting to “Application Data”, Data Subset setting to “Service specific information”) at step 0, the following steps are performed:
5. The PCF(s) receive(s) a Nudr_DM_Notify notification of data change from the UDR. The UDR notifies the PCF/SFCF-C the SFC service configuration changes at the UDR
NOTE 2: PCF does not have to subscribe for each UE the application specific information, e.g. if PCF has already received the application specific information for a group of UE or for a DNN by a subscription of other UE. The same application specific information is delivered to every UE in a group or a DNN.
6. The PCF initiates UE Policy delivery as specified in clause 4.2.4.3. The PCF initiates UE policy delivery procedure for SFC service configuration at the UE as shown in the following figure.

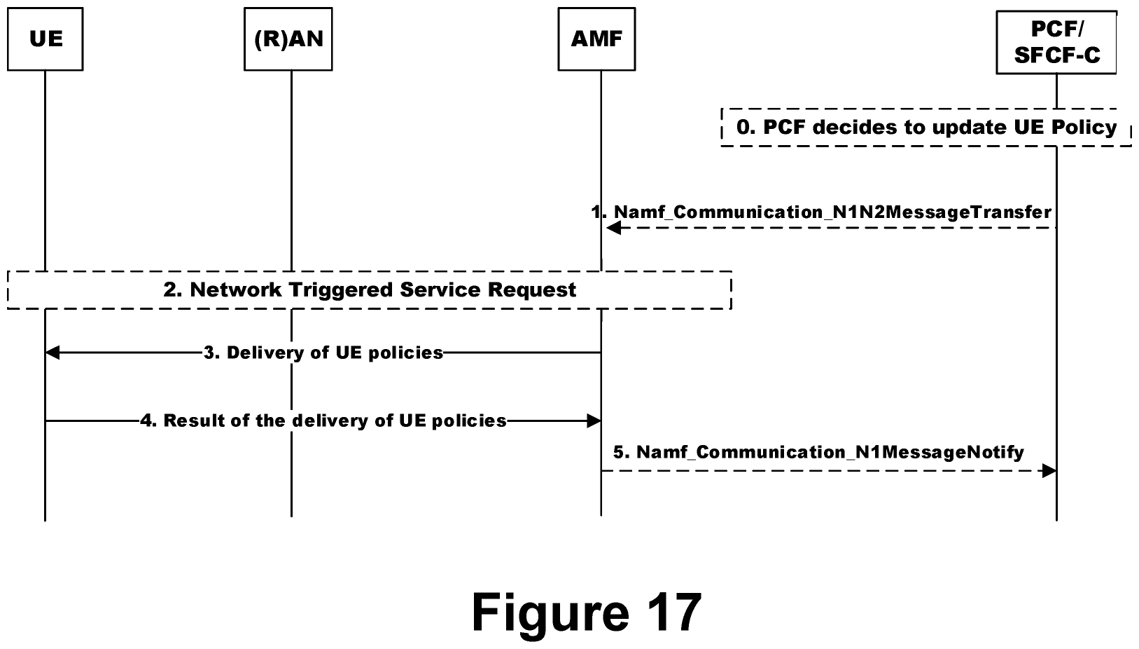

FIG. 17 shows an example UE Configuration Update procedure for transparent UE Policy delivery procedure according to various embodiments. This procedure is initiated when the PCF wants to update UE access selection and PDU Session selection related policy information (i.e. UE policy) in the UE configuration. In the non-roaming case the V-PCF is not involved and the role of the H-PCF is performed by the PCF. For the roaming scenarios, the V-PCF interacts with the AMF and the H-PCF interacts with the V-PCF.
0. PCF decides to update UE policy based on triggering conditions such as an initial registration, registration with 5GS when the UE moves from EPS to 5GS, or need for updating UE policy as follows:
   For the case of initial registration and registration with 5GS when the UE moves from EPS to 5GS, the PCF compares the list of PSIs included in the UE access selection and PDU session selection related policy information in Npcf_UEPolicyControl_Create request and determines, as described in clause 6.1.2.2.2 of 3GPP TS 23.503, whether UE access selection and PDU Session selection related policy information have to be updated and be provided to the UE via the AMF using DL NAS TRANSPORT message; and
   For the network triggered UE policy update case (e.g. the change of UE location, the change of Subscribed S-NSSAIs as described in clause 6.1.2.2.2 of TS 23.503), the PCF checks the latest list of PSIs to decide which UE access selection and/or PDU Session selection related policies have to be sent to the UE.
The PCF checks if the size of the resulting UE access selection and PDU Session selection related policy information exceeds a predefined limit:
   If the size is under the limit, then UE access selection and PDU Session selection related policy information are included in a single Namf_Communication_N1N2MessageTransfer service operation as described below.
   If the size exceeds the predefined limit, the PCF splits the UE access selection and PDU Session selection related policy information in smaller, logically independent UE access selection and PDU Session selection related policy information ensuring the size of each is under the predefined limit. Each UE access selection and PDU Session selection related policy information will be then sent in separated Namf_Communication_N1N2MessageTransfer service operations as described below.
NOTE 1: NAS messages from AMF to UE do not exceed the maximum size limit allowed in NG-RAN (PDCP layer), so the predefined size limit in PCF is related to that limitation.
NOTE 2: The mechanism used to split the UE access selection and PDU Session selection related policy information is described in 3GPP TS 29.507.
1. PCF invokes Namf_Communication_N1N2MessageTransfer service operation provided by the AMF. The message includes SUPI, UE Policy Container.
2. If the UE is registered and reachable by AMF in either 3GPP access or non-3GPP access, AMF shall transfers transparently the UE Policy container to the UE via the registered and reachable access.
   If the UE is registered in both 3GPP and non-3GPP accesses and reachable on both access and served by the same AMF, the AMF transfers transparently the UE Policy container to the UE via one of the accesses based on the AMF local policy.
   If the UE is not reachable by AMF over both 3GPP access and non-3GPP access, the AMF reports to the PCF that the UE Policy container could not be delivered to the UE using Namf_Communication_N1N2TransferFailureNotification as in the step 5 in clause 4.2.3.3 of [5].
   If AMF decides to transfer transparently the UE Policy container to the UE via 3GPP access, e.g. the UE is registered and reachable by AMF in 3GPP access only, or if the UE is registered and reachable by AMF in both 3GPP and non-3GPP accesses served by the same AMF and the AMF decides to transfer transparently the UE Policy container to the UE via 3GPP access based on local policy, and the UE is in CM-IDLE and reachable by AMF in 3GPP access, the AMF starts the paging procedure by sending a Paging message described in the step 4b of Network Triggered Service Request (in clause 4.2.3.3 of [5]). Upon reception of paging request, the UE shall initiate the UE Triggered Service Request procedure (clause 4.2.3.2 of [5]).
3. If the UE is in CM-CONNECTED over 3GPP access or non-3GPP access, the AMF transfers transparently the UE Policy container (UE access selection and PDU Session selection related policy information) received from the PCF to the UE. The UE Policy container includes the list of Policy Sections as described in TS 23.503.
4. The UE updates the UE policy provided by the PCF and sends the result to the AMF.
5. If the AMF received the UE Policy container and the PCF subscribed to be notified of the reception of the UE Policy container then the AMF forwards the response of the UE to the PCF using Namf_Communication_N1MessageNotify.
   The PCF maintains the latest list of PSIs delivered to the UE and updates the latest list of PSIs in the UDR by invoking Nudr_DM_Update (SUPI, Policy Data, Policy Set Entry, updated PSI data) service operation.
   If the PCF is notified about UE Policy delivery failure the PCF may initiate UE Policy Association Modification procedure to provide a new trigger “Connectivity state changes” in Policy Control Request Trigger of UE Policy Association to AMF as defined in clause 4.16.12.2.
NOTE 3: For backward compability the PCF may subscribe the “Connectivity state changes (IDLE or CONNECTED)” event in Rel-15 AMF as defined in clause 5.2.2.3.

### g. Embodiment 3.4: AF Request for Traffic Inferencing Via SMF without an Identified UE Address

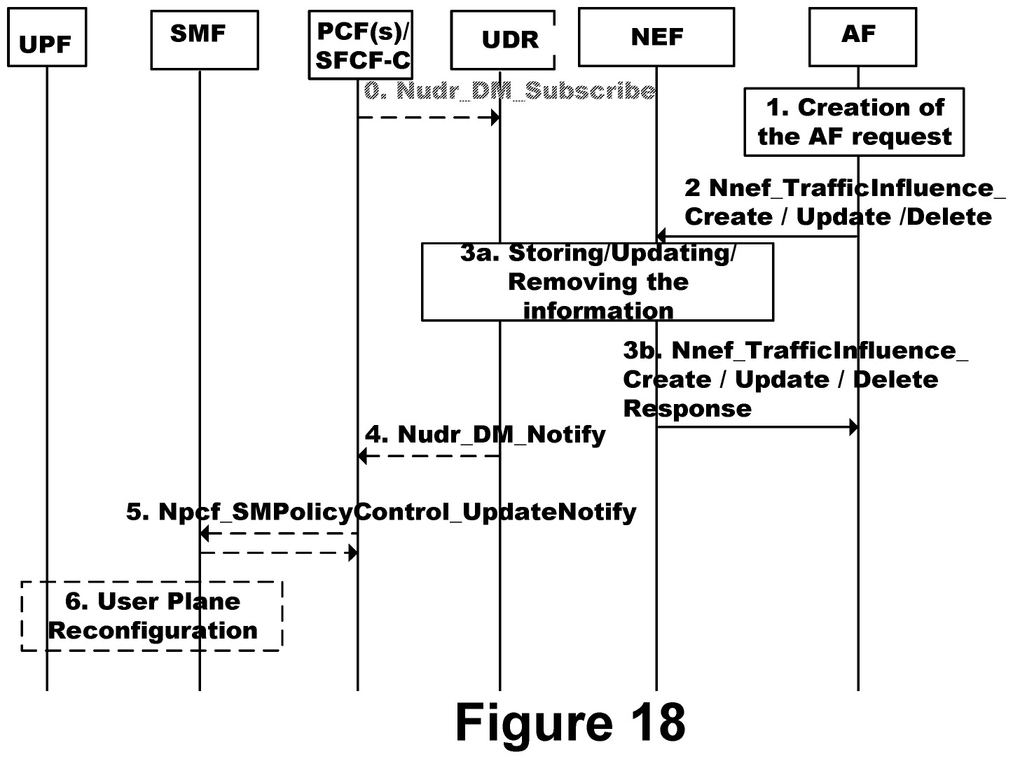

Following embodiment 3 and/or any other embodiment herein, the AF request indicating Traffic inferencing for SFC service controlled by SMF/SFCF-C. FIG. 18 shows an example procedure for processing AF requests to influence traffic routing for Sessions not identified by an an UE address according to various embodiments.
NOTE 1: The 5GC functions used in this scenario are assumed to all belong to the same PLMN (HPLMN in non-roaming case or VPLMN in the case of a PDU Session in LBO mode).
NOTE 2: Nnef_TrafficInfluence_Create or Nnef_TrafficInfluence_Update or Nnef_Trafficlnfluence_Delete service operations invoked from an AF located in the HPLMN for local breakout and home routed roaming scenarios are not supported.
0. The PCF or SFCF-C subscribe to the notification of SFC polices changes at UDR.
1. To create a new request, the AF invokes an Nnef_TrafficInfluence_Create service operation. The content of this service operation (AF request) is defined in clause 5.2.6.7 of [5]. The request contains also an AF Transaction Id. If it subscribes to events related with PDU Sessions the AF indicates also where it desires to receive the corresponding notifications (AF notification reporting information).
   To update or remove an existing request, the AF invokes an Nnef_TrafficInfluence_Update or Nnef_TrafficInfluence_Delete service operation providing the corresponding AF Transaction Id.
   The AF request is for updating SFC policies in UDR targeting at traffic inferencing at UPF/SFCF/U which can potentially trigger SMF/SFCF-C for traffic inferencing on existing PDU session or future PDU sessions in step 6.
2. The AF sends its request to the NEF. If the request is sent directly fom the AF to the PCF, the AF reaches the PCF selected for the existing PDU Session by configuration or by invoking Nbsf_management_Discovery service.
   The NEF ensures the necessary authorization control, including throttling of AF requests and, as described in clause 4.3.6.1 of [5], mapping from the information provided by the AF into information needed by the 5GC.
3. (in the case of Nnef_TrafficInfluence_Create or Update): The NEF stores the AF request information in the UDR (Data Set=Application Data; Data Subset=AF traffic influence request information, Data Key=AF Transaction Internal ID, S-NSSAI and DNN and/or Internal Group Identifier or SUPI).
NOTE 3: Both the AF Transaction Internal ID and, S-NSSAI and DNN and/or Internal Group Identifier or SUPI are regarded as Data Key when the AF request information are stored into the UDR, see Table 5.2.12.2.1-1 of [5].
   (in the case of Nnef_TrafficInfluence_delete): The NEF deletes the AF requirements in the UDR (Data Set=Application Data; Data Subset=AF traffic influence request information, Data Key=AF Transaction Internal ID).
   The NEF responds to the AF.
3b. The NEF provides the result of update SFC polices at UDR.
4. The PCF(s) that have subscribed to modifications of AF requests (Data Set=Application Data; Data Subset=AF traffic influence request information, Data Key=S-NSSAI and DNN and/or Internal Group Identifier or SUPI) receive(s) a Nudr_DM_Notify notification of data change from the UDR.
5. The PCF determines if existing PDU Sessions are potentially impacted by the AF request. For each of these PDU Sessions, the PCF updates the SMF with corresponding new PCC rule(s) by invoking Npcf_SMPolicyControl_UpdateNotify service operation as described in steps 5 and 6 in clause 4.16.5 of [5].
   If the AF request includes a notification reporting request for UP path change, the PCF includes in the PCC rule(s) the information required for reporting the event, including the Notification Target Address pointing to the NEF or AF and the Notification Correlation ID containing the AF Transaction Internal ID.
6. When a PCC rule is received from the PCF, the SMF may take appropriate actions to reconfigure the User plane of the PDU Session such as:
   Adding, replacing or removing a UPF in the data path to e.g. act as an UL CL or a Branching Point e.g. as described in clause 4.3.5 of [5].
   Allocate a new Prefix to the UE (when IPv6 multi-Homing applies)
   Updating the UPF in the target DNAI with new traffic steering rules Subscribe to notifications from the AMF for an Area Of Interest via Namf_EventExposure_Subscribe service operation.

### Embodiment 4: OAM Provides SFCF-U Configuration Information of the SFCF-U Instances

The provisioning of available UPFs in SMF using the NRF is discussed in clause 6.3.3 of [4] and clause 4.17.6 of [5]. This optional node-level step takes place prior to selecting the UPF for PDU Sessions and may be followed by N4 Node Level procedures defined in clause 4.4.3 of [5] where the UPF and the SMF exchange information such as the support of optional functionalities and capabilities.
As an option, UPF(s) may register in the NRF. This registration phase uses the Nnrf_NFManagement_NFRegister operation and hence does not use N4. For the purpose of SMF provisioning of available UPFs, the SMF uses the Nnrf_NFManagement_NFStatusSubscribe, Nnrf_NFManagement_NFStatusNotify and Nnrf_NFDiscovery services to learn about available UPFs. The protocol used by UPF to interact with NRF is described in TS 29.510.
UPFs may be associated with UPF Provisioning Information in the NRF. The UPF Provisioning Information including:
a list of (S-NSSAI, DNN);
UE IPv4 Address Ranges and/or IPv6 Prefix Range(s) per (S-NSSAI, DNN); and
NOTE 2: The above information can be used by the SMF for UPF selection when static IP address/prefix allocation is required for a UE.
a SMF Area Identity the UPF can serve. The SMF Area Identity allows limiting the SMF provisioning of UPF(s) using NRF to those UPF(s) associated with a certain SMF Area Identity. This can e.g. be used if an SMF is only allowed to control UPF(s) configured in NRF as belonging to a certain SMF Area Identity.
the supported ATSSS steering functionality, i.e. whether MPTCP functionality or ATSSS-LL functionality or both are supported.
   The SMF Area Identity and UE IPv4 Address Ranges and/or IPv6 Prefix Range(s) are optional in the UPF Provisioning Information.
   Following embodiment 3 and/or any other embodiment herein, SFCF-C obtains SFC configuration, including one or more SFs and corresponding parameters for SFC service provided by 5G network, from EAS.
   The SFCF-C receiving SFC parameters for SFC service configuration can check the existing available SFCF-U instances with required SFs for the requested SFC service for a UE, a group of UEs, or any UEs, or any UEs of an application, or any UEs of an SFC service. The following two mechanisms provide SFCF-C to obtain available SFCF-U instance:

1—SFCF-C requests an SFCF-U instance from NRF indicating requirement of the supported one or more SFs of the SFCF-C instance.

2—SFCF-C subscribed to NRF service for the notification of status changes of available SFCF-U NFs.

The SFCF-C obtains available SFCF-U instances with supported one or more SFs information from NRF or OAM based on the same procedure of SMF Provisioning of available UPFs using the NRF in clause 4.17.6 of [5] with the SMF replaced with SFCF-C and UPFs replaced with SFCF-U.

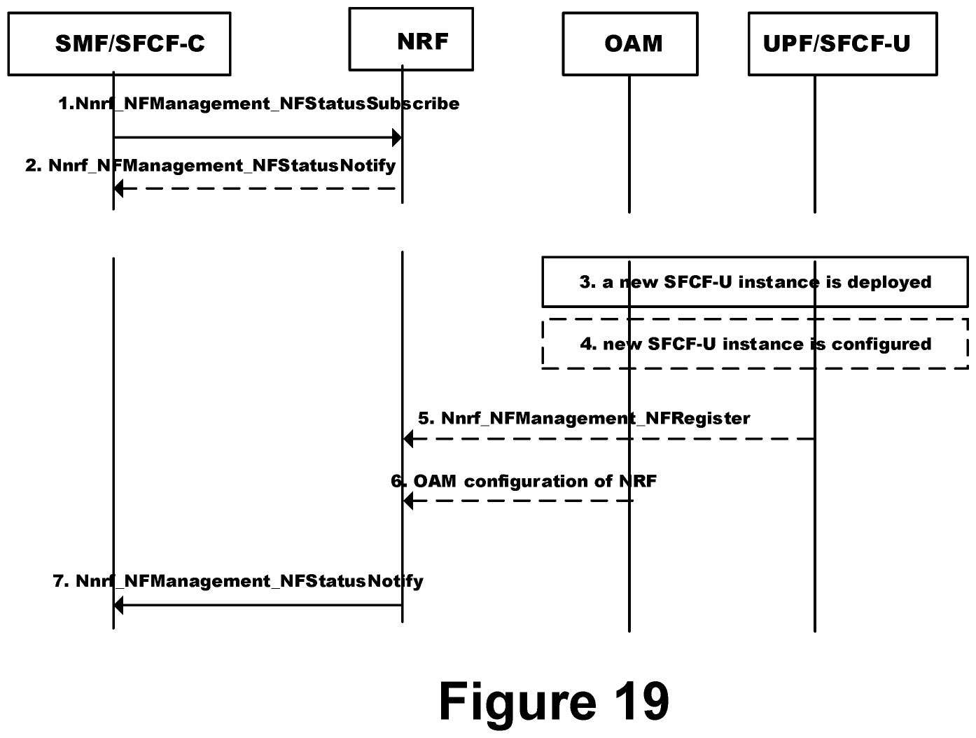

The procedure of FIG. 19 may operate as follows when an SMF expects to be informed of UPFs available in the network:
1 The SMF issues a Nnrf_NFManagement_NFStatusSubscribe Service Operation providing the target UPF Provisioning Information it is interested in. The SFCF-C sends Nnrf_NFManagement_NFStatusSubscribe message to the NRF to subscribe the notification of available SFCF-U, wherein the message may include the information of supported one or more SFs in the SFCF-U instance.
   If the SFCF-C does not provide requirement of the supported SFs of the SFCF-U instance, the NRF notifies all the available SFCF-U instance with supported SFs of the SFCF-U instance in step 7.
   If the SFCF-C indicates the requirement of the supported SFs of the SFCF-U instance, the NRF only notifies the available SFCF-U instance with supported SFs in step 7.
2 The NRF issues Nnrf_NFManagement_NFStatusNotify with the list of all UPFs that currently meet the SMF subscription. This notification indicates the subset of the target UPF Provisioning Information that is supported by each UPF.
   The procedure of FIG. 19 may operate as follows when a new UPF instance is deployed:
3 At any time a new UPF instance is deployed. When SFCF-U is deployed, the SFCF-C instant information is provided by SFCF-U to OAM.
4 The UPF instance is configured with the NRF identity to contact for registration and with its UPF Provisioning Information. An UPF is not required to understand the UPF Provisioning Information beyond usage of this information to register in step 5. The OAM configures the SFCF-U instance.
5 The UPF instance issues an Nnrf_NFManagement_NFRegister Request operation providing its NF type, the FQDN or IP address of its N4 interface, and the UPF Provisioning Information configured in step 4.
6. Alternatively (to steps 4 and 5) OAM registers the UPF on the NRF indicating the same UPF Provisioning Information as provided in step 5. This configuration mechanism is out of scope of this specification.
5 or 6. The SFCF-U or OAM registers SFCF-U instance to NRF, in which Nnrf_NFManagement_NFRegister or OAM configuration of NRF contains the information of supported one or more SFs for the SFCF-U instance.
7. Based on the subscription in step 1, the NRF issues Nnrf_NFManagement_NFStatusNotify to all SMFs with a subscription matching the UPF Provisioning Information of the new UPF. The NRF provides the available SFCF-U information to the SFCF-C. The SFCF-U information contains the supported one or more SFs of the SFCF-U instance.

### h. Embodiment 4.1: OAM Configures SFCF-U Instances with Application Information

Following embodiment 4, step 4, and/or any other embodiment herein: the OAM configures new SFCF-U instance with information of the application indicated by application ID that is supported for this SFCF-U instance.
Step 6: the OAM configuration of NRF associates this SFCF-U instance with the Application ID and SFC service ID as additional information.
Step 7: if Application-ID and SFC service ID are provided in step 6, the NRF provides the application-ID and SFC service ID to the SFCF-U in the notification message, e.g. Nnrf_NFManagement_NFStatusNotify.
   The SFCF-C configures SFPs based on the information of the SFC service ID, SFC application ID, and supported SFs information of the SFCF-U instances.
   This embodiment supports the coordination between SFC service in Edge Data Network and SFC service in 5G network via OAM.

### Embodiment 5: SFC Configuration in 3GPP Management Plane

Following embodiment 2 and/or any other embodiment herein, the EAS or EES or SFC network provider, which provide SFC service at SFC network, can provide SFC parameters of SFC service configuration in SLA with network operators for using 3GPP orchestration and management services for the coordination between SFC service in Edge Data Network and SFC service in 5G network via OAM.

### i. Embodiment 5.1: OAM Configures PCF/SFCF-C

Following embodiment 5 and/or any other embodiment herein, based on SLA for SFC services at 5G network, the OAM configures static SFC configuration at PCF/SFCF-C for managing SFC policies.

### j. Embodiment 5.2: OAM Configures SMF/SFCF-C Directly

Following embodiment 5 and/or any other embodiment herein, based on SLA for SFC services at 5G network, the OAM configures SMF/SFCF-C with SFC service configurations.

### Embodiment 6: SFCF-C Configures SFPs to be Coordinated with SFC Network in Edge Data Network

Following embodiment 5.1, 5.2, 4.1, and/or any other embodiment herein, the SFCF-C can configure an SFP with the ordered SFs at each SFCF-U, identified by an SFP ID, that is composed by one or more SFCF-U instances with different SFs based on the following information:
SFC service ID
SFC application ID
The supported SFs of an SFCF-U instance
Address information of ordered SFCF-U(s), e.g. ingress address and port and egress address and port of each SFCF-U.
   This embodiment supports the coordination between SFC service in Edge Data Network and SFC service in 5G network via OAM.
   Service Function Chaining with Service Functions and Service Function Paths Provided by Edge Data Network

Embodiments are also provided for an SFC network with SFs and SFPs provided by the Edge Data Network, e.g., by Edge Application Service provider or Edge Computing Service provider.

### Embodiment 7: SFC Enabler in Edge Data Network

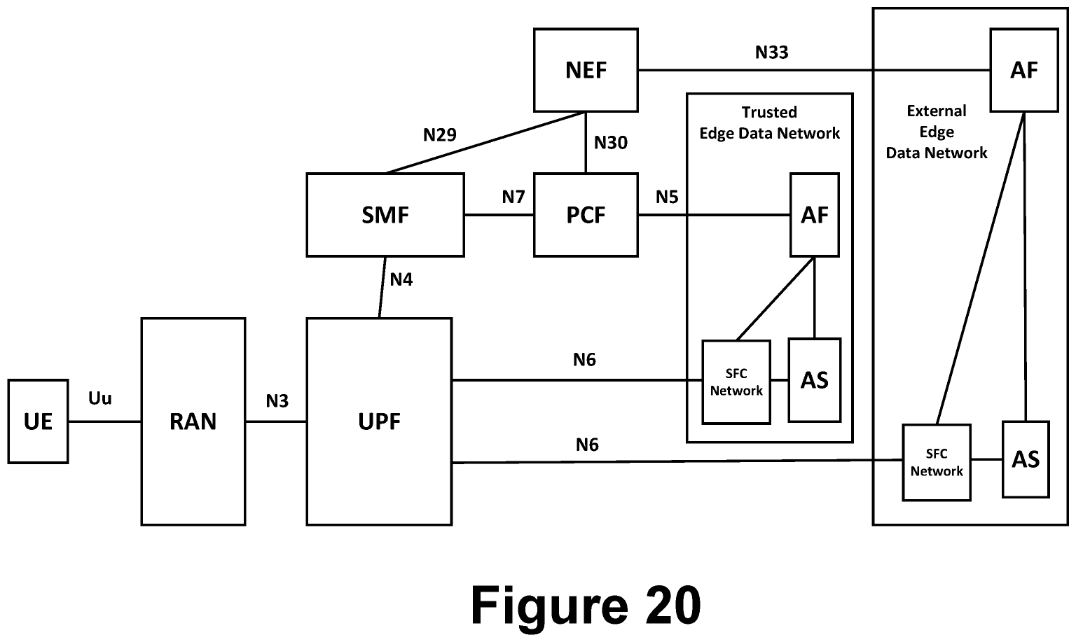

This solution proposes solutions that enables service function chaining service in Edge Data Network, as shown in FIG. 20. With SFC service at Edge Data Network, this solution enables the support of consolidated orchestration and management in 3GPP management plane.

FIG. 20 shows a reference architecture that includes SFC network in Edge Data Network according to various embodiments (partial network functions are included in this reference architecture). The service function chaining service is provided at Edge Data Network by enabling support of service function chaining network (SFC Network), which terminates N6 reference points with trusted data networks or external data networks. The service function chaining policy for steering traffic that needs to pass through a specific Service Function Path (SFP) in SFC network can be configured by AS, AF, or 3GPP OAM. For application server (AS) in the external data network, the AF can inference the traffic routing, e.g., over N6 towards the SFC network at Edge data network, via NEF over N33 interface. For AS in trusted data network, the AF can interfere the traffic routing, e.g., over N6 towards the SFC network at Edge data network, via PCF directly over N5 interface.

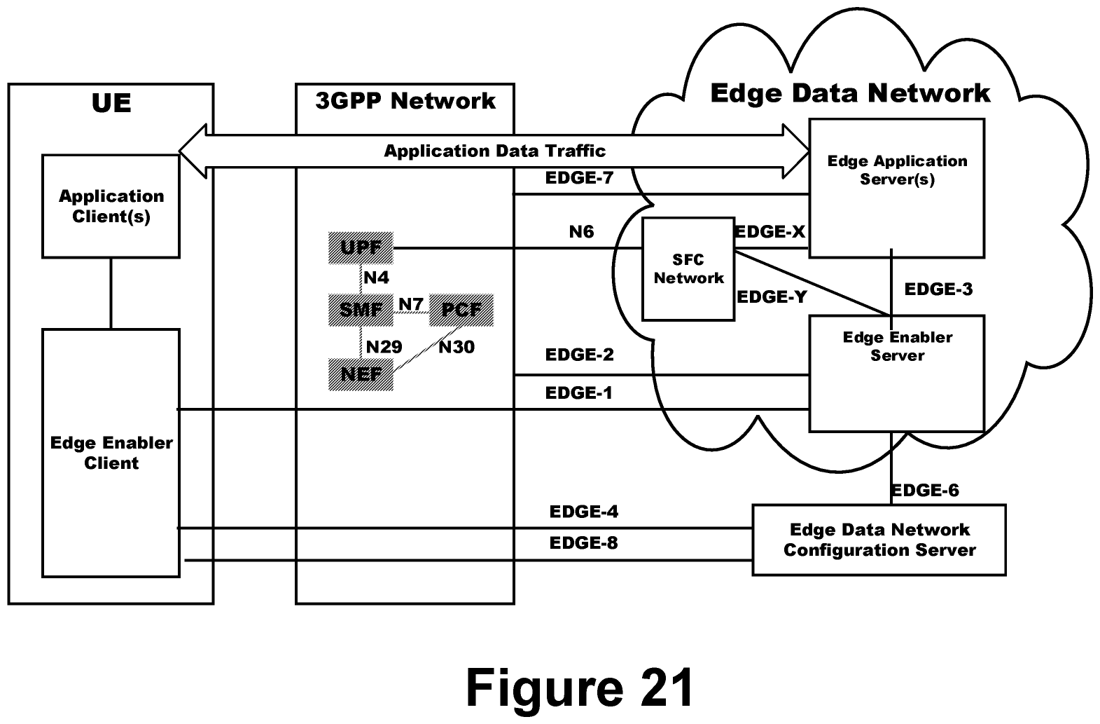

FIG. 21 further shows the application architecture of the Edge Data Network enabling SFC service via SFC network, according to various embodiments.

In FIG. 21, the Edge application servers use SFC service provided by SFC network in Edge Data Network by using AF inferencing traffic routing for steering N6 traffics towards SFC network in Edge Data Network.

The SFC network providing SFC services contains the service functions and one or more service function paths at Edge Data Network, in which a traffic classifier terminates N6 at SFC network for handling traffics from 3GPP network before starting SFC services and a traffic de-classifier for further combining the traffic flows through same or different SFPs before forwarding the traffic towards EAS over EDGE-X interface.

The SFC services can be provided by one or more service providers, including edge service provider(s), the Edge computing service provider(s), SFC network service providers, or network operator(s). Depending on the deployment options, the SFC network configuration can be supported over EDGE-X and EDGE-Y, accordingly, by the EAS(s) and EES(s).

Depending on the deployment scenarios and the business relationship of the Edge Application Service Provider or Edge Computing Service Provider with the PLMN operator, the edge data network can be in the trusted domain or external data network. The Edge-2 and Edge-7 reference points enable the EAS and EES to interact with the PCF directly over N5 or via NEF over N33 interface, respectively. As shown in FIG. 20, there are different deployment options for the support of AF, including:

### Embodiment 7.1

The AF is at Edge Application Server (EAS) which can interact with 3GPP network via Edge 7 reference point. The EAS uses 5G network capability exposure APIs for interacting 5GC directly; and/or

### Embodiment 7.2

The AF is at Edge Enabler Server (EES) which can interact with 5G network via Edge 2 reference point. The EES provides EES capability exposure APIs to EAS for interacting with 5GC by further using 5G network capability exposure APIs, e.g., EAS requests AF in Edge Enabler Server with required information for triggering AF inferencing traffic routing using Edge Enabler Server capability exposure APIs which trigger 5G network capability exposure APIs for interacting 5GC, e.g., e.g., Nnef_trafficInferencing_Create/Update/Delecte message.

### Embodiment 8: Application Architecture with Support of SFC Network in Edge Data Network

Following embodiment 7, SFC network contains traffic classifier, traffic declassifier, and SFs, which can handle one or more SFPs. Each SFP contain an ordered SFs that traffic needs to pass through. One or more SFs can be provided by same or different service providers, e.g., edge application service provider(s), the Edge computing service provider(s), SFC service providers, or network operator(s). Depending on the deployment options, the SFC network configuration can be supported over EDGE-X and EDGE-Y, accordingly.

The EDGE-X is the interface between the SF/Traffic classifier/Traffic De-Classifier in SFC network and EAS. The EDGE-Y is the interface between the SF/Traffic classifier/Traffic De-Classifier in SFC network and EES. The traffic classifier and traffic de-classifier are with traffic filtering policies to classify and combine the traffic flows for each SFP before and after SFPs handling, respectively.

For the traffic flows that are not assigned an SFP, it skips all the SFs in the SFC network.

As discussed above, FIG. 9 depicts an example of an SFC network at Edge Data Network with one or more SFPs. In particular, FIG. 9 shows an example of an SFC network with traffic classifier, traffic declassifier, one or more SFs and SFPs, in which traffic flows in each SFP transports through the ordered service functions.

The SF can be one of the following functions but not limited to:
Network address translation (NAT),
IP tunnel endpoints,
Packet classifiers,
deep packet inspection (DPI),
Lawful inspection (LI),
TCP proxies,
load balancers,
Firewall functions,
Transcoders,
URL filter,
Application detection and control (ADC),
video optimizer.

### Embodiment 9: SFC Parameters for SFC Network Configuration

Following embodiment 8, the SFC parameters of SFC service can include the following information:
SFC network configuration: define the following SFC parameters of SFC services
SFC service ID: the service ID of one set of SFC parameters for a SFC service
SFC configuration: one or more SFs with the corresponding SF parameters and SF address information.
SFP configuration: indicate the SFP index with the corresponding ordered SFs for one or more traffic rules configured at traffic classifier.
SFC routing policy:
traffic classifier indicates the mapping between a SPF index and traffic filtering rules for forwarding traffic to the first SF in an SFP identified by an SFP index.
traffic de-classifier indicates with traffic filter rules for combining traffic from the last SF in an SFP identified by an SFP index.
Validity parameters for the SFC service identified by the SFC service ID, e.g.:
Duration
Scheduled Time period, e.g., Sam-8 pm every day, etc.
Application ID(s)
Associated PDU session parameters, including PDU session type, e.g., IP/Ethernet/Unstructure, DNN, or a slice/Service type (SST) (e.g., eMBB, URLLC, MIoT, V2X, etc) and optional slice differentiator (SD)

The traffic classifier provides a SPF index with the mapping to SFC classification policy including one or more the following information based on different level or granularities per packet, e.g.:
UE address
Application ID
Media type
Traffic priorities

When information is only available in traffic payload, the DPI capability at the traffic classifier is needed.

The traffic de-classifier provides an “Edge application server ID (EAS ID)”, which identifies the target Edge Application Server which terminates Edge-X reference point with the mapping to SFC re-classification policy including one or more the following information to combine traffics from one ore more SFPs before forwarding to the application server of an application, e.g.:
UE address
Application ID
Media type
Traffic priorities
SPF index

When information is only available in traffic payload, the DPI capability at the traffic de-classifier is needed.

### Embodiment 10: Edge Application Server Provider (EASP) Provides SFC Service

Following embodiment 9, the EASP provides SFC services to Edge Application Server in EDGE Data Network.
The EASP can use any of own EAS(s) to provision the SFC parameters of the SFC network for SFC service over EDGE-X interface.
Further, based on EES APIs to the EAS and 5GC network capability exposure APIs to the EES, the EAS can request Edge enabler server to trigger AF inferencing traffic routing towards SFC network.

In addition, the SFC service may be provided by SFC network service provider to EASP at Edge Data Network under a SLA between the SFC network service provider and EASP.

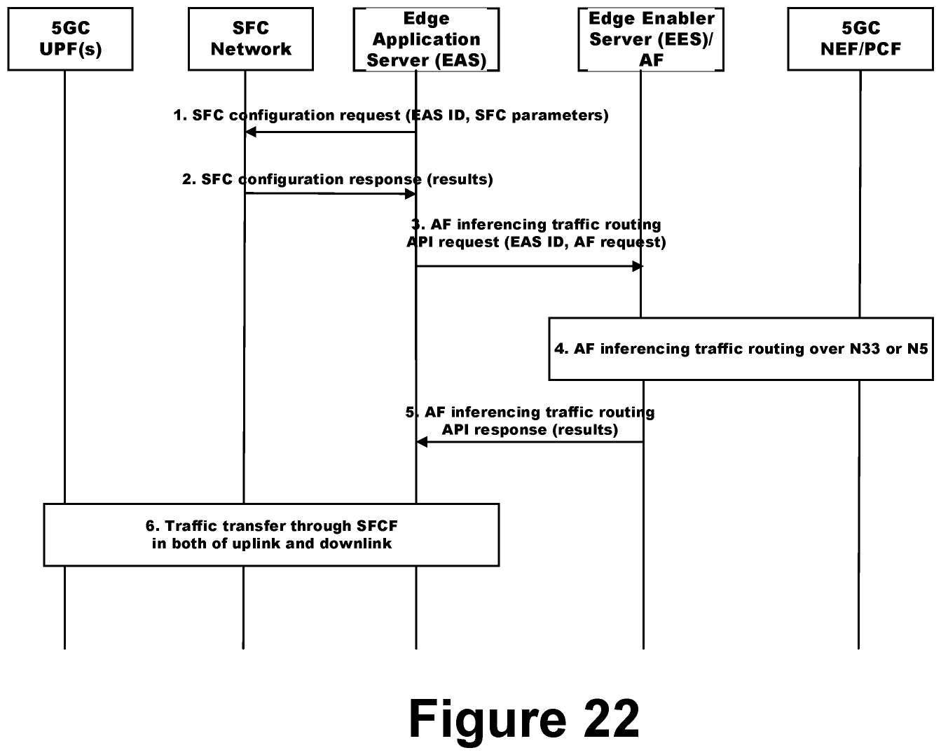

FIG. 22 shows an example procedure according to various embodiments. FIG. 22 involves message flows for SFC configuration and AF request for interfering traffic routing.

The procedure of FIG. 22 may operate as follows:

Step 1: The Edge application server sends SFC configuration request including SFC parameters with its EAS ID to control and configure SFs and SFPs at the SFC network and transaction ID for identifying this request message. In addition, the request message may indicate the create, update, or deletion of SFC parameters configuration.

Step 2: The SFC network returns the SFC configuration response message (results) to Edge Application server for the results of the SFC and SFPs.

Step 3: The Edge application sever using EES capability exposure API to EAS requests AF in EES for 5G network capability exposure to inference traffic routing over N6 tunnel between UPF and the SFC network. In addition, the request message may indicate the create, update, or deletion of AF request for inferencing traffic routing.

Step 4: The Edge enabler server using AF to trigger AF inferencing traffic routing procedure as indicated in embodiment 7.

Step 5: The Edge enabler server responds the results of the AF inferencing traffic routing request.

Step 6: The traffic can start to traverse between UPFs and the Edge application server via SFC network.

### Embodiment 11: Edge Computing Service Provider (ECSP) Provides SFC Service at Edge Data Network

Following embodiment 10, the ECSP provides SFC services to Edge Application Server via Edge Enabler Server in EDGE Data Network.
Based on EES APIs to EAS for provisioning the SFC parameters for SFC service over EDGE-3 interface, the Edge enabler server can trigger the SFC configuration request message to control and configure SFC at SFC network over a new interface EDGE-Y.
Further, based on EES APIs to the EAS and 5GC network capability exposure APIs to the EES, the Edge enabler server can trigger the AF request for triggering AF inferencing traffic routing towards SFC network.

In addition, the SFC service may be provided by SFC network service provider to ECSP at Edge Data Network under a SLA between the SFC network service provider and ECSP.

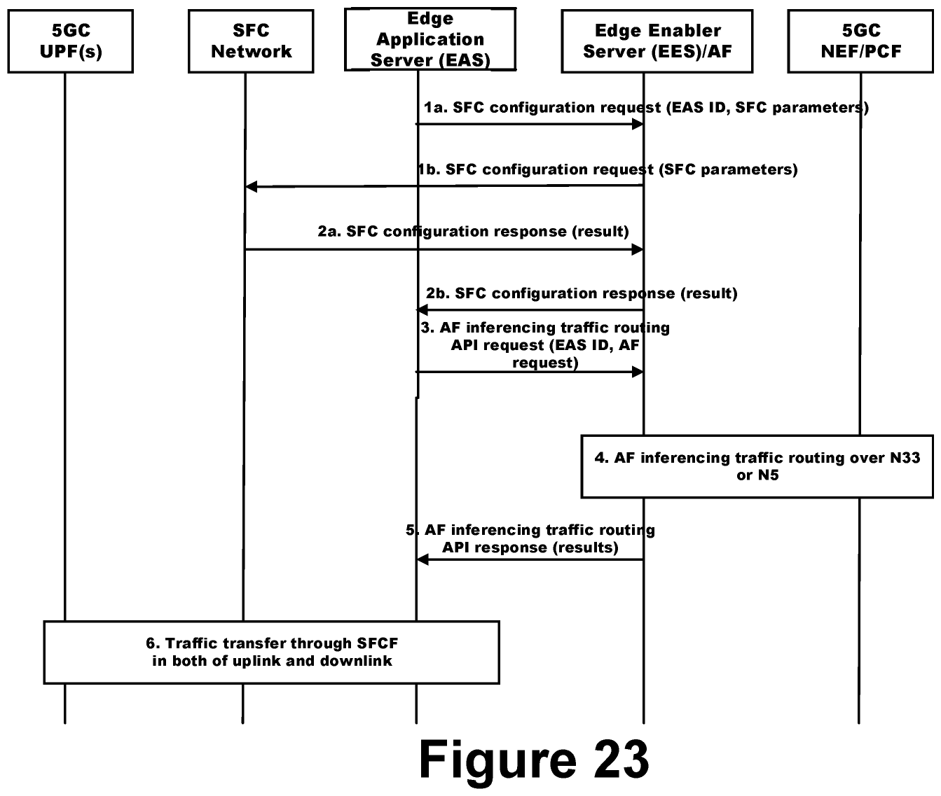

FIG. 23 shows an example procedure according to various embodiments. FIG. 23 involves message flows for SFC configuration and AF request for interfering traffic routing. The procedure of FIG. 23 may operate as follows:

Step 1: The Edge application server sends SFC configuration request including SFC parameters to control and configure SFs and SFPs at the SFC network via EES capability exposure API to EAS at Step 1a. In Step 1b, the Edge enabler Server generates the transaction ID and forwards the SFC configuration request message indicating the SFC parameters and the transaction ID to SFC network. In addition, the request message may indicate the create, update, or deletion of SFC parameters configuration.

Step 2: The SFC network returns the SFC configuration response message indicating the transaction ID and the results of SFC parameters configuration of SFC and SFPs to Edge Application server at Step 2a. In Step 2b, the Edge enabler server forwards the SFC configuration response message with the results of SFC configuration to the requested Edge Application server.

Step 3: The Edge application sever uses EES capability exposure API to EAS, provided by Edge Enabler Server, to request AF in EES for 5G network capability exposure to inference traffic routing over N6 tunnel between UPF and the SFC network. In addition, the request message may indicate the create, update, or deletion of AF request for inferencing traffic routing.

Step 4: The Edge enabler server using AF to trigger AF inferencing traffic routing procedure as indicated in embodiment 13.

Step 5: The Edge enabler server response the results of the AF inferencing traffic routing request.

Step 6: The traffic can start to traverse between UPFs and the Edge application server via SFC network.

### Embodiment 12: SFC Configuration in 3GPP Management Plane

Following embodiment 10 or 11, the EAS or EES or SFC network provider, which provide SFC service at SFC network, can provide SFC parameters of the SFC network in SLA with network operator for SFC configuration using 3GPP orchestration and management services.

### Embodiment 13: EAS Triggered AF Inferencing Traffic Routing in 5GS (with DPI Capability)

Following embodiment 10, 11, and/or 12, wherein the EAS sends AF inferencing traffic routing request message (EAS ID and AF request) via AF directly or AF at Edge Enabler Server over Edge-3 and N33.

For the traffic filtering information in AF request, if requiring DPI (deep packet inspection) capability at the UPF/PSA, the DPI indicator is provided with DPI rules and policies for traffic classification based on information, e.g., included in packet header or packet payload, wherein the DPI policy is configured to classify network traffic flows towards indicated N6 tunnel based on N6 traffic routing information.

For example, the DPI policy can be configured to classify different prioritized traffics based on packet payload information and enable high-priority traffic to pass through a N6 tunnel with higher throughput.

For example, the DPI policy can be configured to classify different media types based on packet payload information and enable traffic with different media types to pass through different N6 tunnels with different throughput.

### Embodiment 13.1

Following embodiment 13 and referring to clause 5.6.7 of TS 23.501 and clause 4.3.6 of TS 23.502, wherein the AF request for N6 traffic routing towards SFC network can include the following information:
AF transaction identifier: is provided to refer to the AF request.
DNN, and one or more DNAI(s): are provided to identify an Edge data network, wherein the DN Access Identifier (DNAI) is the identifier of a user plane access to one or more DN(s) where applications are deployed. The PLMN supporting edge computing services provides connection to Edge Application Servers located in EDNs that respectively corresponds to one or more DNAI(s).
one or more N6 traffic routing information of each DNAI for N6 tunnel: is provided for steering traffic towards SFC Network and Edge application server at Edge Data network, wherein the addresses information includes IP address and port number for IP packets and/or Ethernet MAC address for Ethernet traffic.
The traffic description for each N6 traffic routing information: is provided for identify the target traffic to be influenced, which can be represented by the combination of DNN and optionally S-NSSAI, and application identifier (APP-ID) or traffic filtering information based on IP/Ethernet packet header information.
Target UE Identifier(s): is provided to indicates the UE(s) to be targeting for the AF request, which can be represented by GPSI for an individual UE or external group identifier for a group of UE, or any UEs accessing the combination of DNN, S-NSSAI and DNAI(s).

### Embodiment 13.2: Additional Information in AF Request

Following embodiment 13.1, the following additional information can be provided:
Spatial Validity Condition: is provided to indicate that the request applies only to the traffic of UE(s) located in the specified location, represented by areas of validity or a list of geographic zone identifier(s).

Temporal Validity Condition: is provided to indicate time interval(s) or duration(s) for enforcing the inferencing request from AF.

### 1. Systems and Implementations

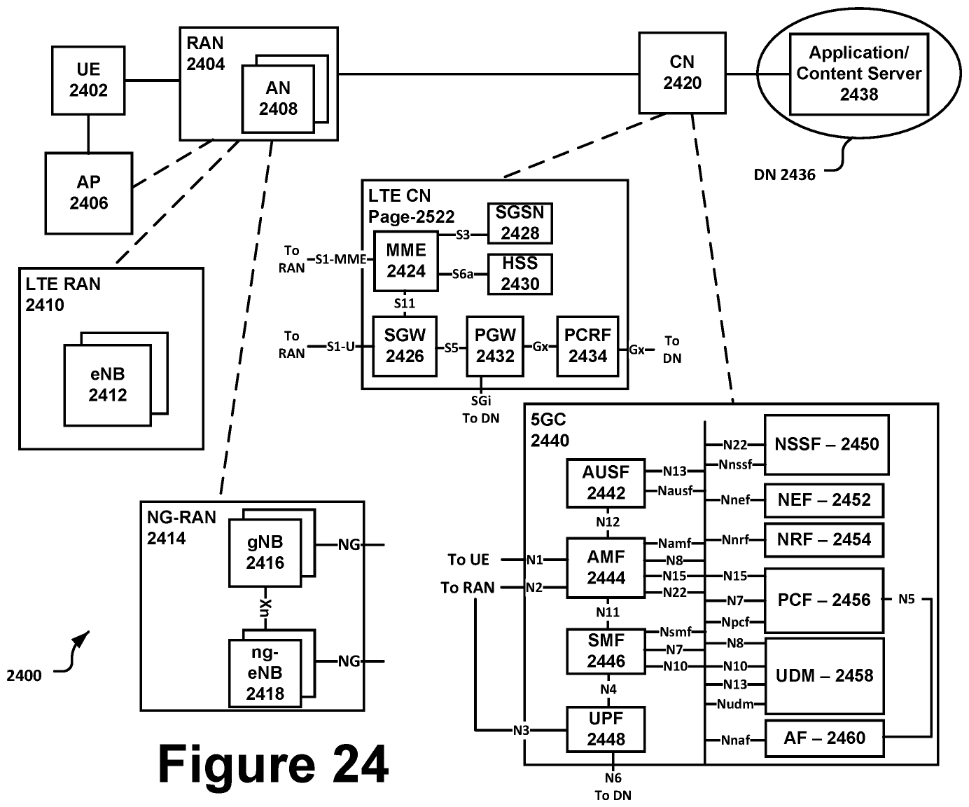

FIGS. 24-26 illustrate various systems, devices, and components that may implement aspects of disclosed embodiments.

FIG. 24 illustrates a network 2400 in accordance with various embodiments. The network 2400 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 2400 may include a UE 2402, which may include any mobile or non-mobile computing device designed to communicate with a RAN 2404 via an over-the-air connection. The UE 2402 may be communicatively coupled with the RAN 2404 by a Uu interface. The UE 2402 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 2400 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 2402 may additionally communicate with an AP 2406 via an over-the-air connection. The AP 2406 may manage a WLAN connection, which may serve to offload some/all network traffic from the RAN 2404. The connection between the UE 2402 and the AP 2406 may be consistent with any IEEE 802.11 protocol, wherein the AP 2406 could be a wireless fidelity (Wi-Fi®) router. In some embodiments, the UE 2402, RAN 2404, and AP 2406 may utilize cellular-WLAN aggregation (for example, LWA/LWIP). Cellular-WLAN aggregation may involve the UE 2402 being configured by the RAN 2404 to utilize both cellular radio resources and WLAN resources.

The RAN 2404 may include one or more access nodes, for example, AN 2408. AN 2408 may terminate air-interface protocols for the UE 2402 by providing access stratum protocols including RRC, PDCP, RLC, MAC, and L1 protocols. In this manner, the AN 2408 may enable data/voice connectivity between CN 2420 and the UE 2402. In some embodiments, the AN 2408 may be implemented in a discrete device or as one or more software entities running on server computers as part of, for example, a virtual network, which may be referred to as a CRAN or virtual baseband unit pool. The AN 2408 be referred to as a BS, gNB, RAN node, eNB, ng-eNB, NodeB, RSU, TRxP, TRP, etc. The AN 2408 may be a macrocell base station or a low power base station for providing femtocells, picocells or other like cells having smaller coverage areas, smaller user capacity, or higher bandwidth compared to macrocells.

In embodiments in which the RAN 2404 includes a plurality of ANs, they may be coupled with one another via an X2 interface (if the RAN 2404 is an LTE RAN) or an Xn interface (if the RAN 2404 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 2404 may each manage one or more cells, cell groups, component carriers, etc. to provide the UE 2402 with an air interface for network access. The UE 2402 may be simultaneously connected with a plurality of cells provided by the same or different ANs of the RAN 2404. For example, the UE 2402 and RAN 2404 may use carrier aggregation to allow the UE 2402 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 2404 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 2402 or AN 2408 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 2404 may be an LTE RAN 2410 with eNBs, for example, eNB 2412. The LTE RAN 2410 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 2404 may be an NG-RAN 2414 with gNBs, for example, gNB 2416, or ng-eNBs, for example, ng-eNB 2418. The gNB 2416 may connect with 5G-enabled UEs using a 5G NR interface. The gNB 2416 may connect with a 5G core through an NG interface, which may include an N2 interface or an N3 interface. The ng-eNB 2418 may also connect with the 5G core through an NG interface, but may connect with a UE via an LTE air interface. The gNB 2416 and the ng-eNB 2418 may connect with each other over an Xn interface.

In some embodiments, the NG interface may be split into two parts, an NG user plane (NG-U) interface, which carries traffic data between the nodes of the NG-RAN 2414 and a UPF 2448 (e.g., N3 interface), and an NG control plane (NG-C) interface, which is a signaling interface between the nodes of the NG-RAN 2414 and an AMF 2444 (e.g., N2 interface).

The NG-RAN 2414 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 2402 can be configured with multiple BWPs where each BWP configuration has a different SCS. When a BWP change is indicated to the UE 2402, the SCS of the transmission is changed as well. Another use case example of BWP is related to power saving. In particular, multiple BWPs can be configured for the UE 2402 with different amount of frequency resources (for example, PRBs) to support data transmission under different traffic loading scenarios. A BWP containing a smaller number of PRBs can be used for data transmission with small traffic load while allowing power saving at the UE 2402 and in some cases at the gNB 2416. A BWP containing a larger number of PRBs can be used for scenarios with higher traffic load.

The RAN 2404 is communicatively coupled to CN 2420 that includes network elements to provide various functions to support data and telecommunications services to customers/subscribers (for example, users of UE 2402). The components of the CN 2420 may be implemented in one physical node or separate physical nodes. In some embodiments, NFV may be utilized to virtualize any or all of the functions provided by the network elements of the CN 2420 onto physical compute/storage resources in servers, switches, etc. A logical instantiation of the CN 2420 may be referred to as a network slice, and a logical instantiation of a portion of the CN 2420 may be referred to as a network sub-slice.

In some embodiments, the CN 2420 may be an LTE CN 2422, which may also be referred to as an EPC. The LTE CN 2422 may include MME 2424, SGW 2426, SGSN 2428, HSS 2430, PGW 2432, and PCRF 2434 coupled with one another over interfaces (or “reference points”) as shown. Functions of the elements of the LTE CN 2422 may be briefly introduced as follows.

The MME 2424 may implement mobility management functions to track a current location of the UE 2402 to facilitate paging, bearer activation/deactivation, handovers, gateway selection, authentication, etc.

The SGW 2426 may terminate an S1 interface toward the RAN and route data packets between the RAN and the LTE CN 2422. The SGW 2426 may be a local mobility anchor point for inter-RAN node handovers and also may provide an anchor for inter-3GPP mobility. Other responsibilities may include lawful intercept, charging, and some policy enforcement.

The SGSN 2428 may track a location of the UE 2402 and perform security functions and access control. In addition, the SGSN 2428 may perform inter-EPC node signaling for mobility between different RAT networks; PDN and S-GW selection as specified by MME 2424; MME selection for handovers; etc. The S3 reference point between the MME 2424 and the SGSN 2428 may enable user and bearer information exchange for inter-3GPP access network mobility in idle/active states.

The HSS 2430 may include a database for network users, including subscription-related information to support the network entities' handling of communication sessions. The HSS 2430 can provide support for routing/roaming, authentication, authorization, naming/addressing resolution, location dependencies, etc. An S6a reference point between the HSS 2430 and the MME 2424 may enable transfer of subscription and authentication data for authenticating/authorizing user access to the LTE CN 2420.

The PGW 2432 may terminate an SGi interface toward a data network (DN) 2436 that may include an application/content server 2438. The PGW 2432 may route data packets between the LTE CN 2422 and the data network 2436. The PGW 2432 may be coupled with the SGW 2426 by an S5 reference point to facilitate user plane tunneling and tunnel management. The PGW 2432 may further include a node for policy enforcement and charging data collection (for example, PCEF). Additionally, the SGi reference point between the PGW 2432 and the data network 2436 may be an operator external public, a private PDN, or an intra-operator packet data network, for example, for provision of IMS services. The PGW 2432 may be coupled with a PCRF 2434 via a Gx reference point.

The PCRF 2434 is the policy and charging control element of the LTE CN 2422. The PCRF 2434 may be communicatively coupled to the app/content server 2438 to determine appropriate QoS and charging parameters for service flows. The PCRF 2432 may provision associated rules into a PCEF (via Gx reference point) with appropriate TFT and QCI.

In some embodiments, the CN 2420 may be a 5GC 2440. The 5GC 2440 may include an AUSF 2442, AMF 2444, SMF 2446, UPF 2448, NSSF 2450, NEF 2452, NRF 2454, PCF 2456, UDM 2458, and AF 2460 coupled with one another over interfaces (or “reference points”) as shown. Functions of the elements of the 5GC 2440 may be briefly introduced as follows.

The AUSF 2442 may store data for authentication of UE 2402 and handle authentication-related functionality. The AUSF 2442 may facilitate a common authentication framework for various access types. In addition to communicating with other elements of the 5GC 2440 over reference points as shown, the AUSF 2442 may exhibit an Nausf service-based interface.

The AMF 2444 may allow other functions of the 5GC 2440 to communicate with the UE 2402 and the RAN 2404 and to subscribe to notifications about mobility events with respect to the UE 2402. The AMF 2444 may be responsible for registration management (for example, for registering UE 2402), connection management, reachability management, mobility management, lawful interception of AMF-related events, and access authentication and authorization. The AMF 2444 may provide transport for SM messages between the UE 2402 and the SMF 2446, and act as a transparent proxy for routing SM messages. AMF 2444 may also provide transport for SMS messages between UE 2402 and an SMSF. AMF 2444 may interact with the AUSF 2442 and the UE 2402 to perform various security anchor and context management functions. Furthermore, AMF 2444 may be a termination point of a RAN CP interface, which may include or be an N2 reference point between the RAN 2404 and the AMF 2444; and the AMF 2444 may be a termination point of NAS (N1) signaling, and perform NAS ciphering and integrity protection. AMF 2444 may also support NAS signaling with the UE 2402 over an N3 IWF interface.

The SMF 2446 may be responsible for SM (for example, session establishment, tunnel management between UPF 2448 and AN 2408); UE IP address allocation and management (including optional authorization); selection and control of UP function; configuring traffic steering at UPF 2448 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 2444 over N2 to AN 2408; and determining SSC mode of a session. SM may refer to management of a PDU session, and a PDU session or “session” may refer to a PDU connectivity service that provides or enables the exchange of PDUs between the UE 2402 and the data network 2436.

The UPF 2448 may act as an anchor point for intra-RAT and inter-RAT mobility, an external PDU session point of interconnect to data network 2436, and a branching point to support multi-homed PDU session. The UPF 2448 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 2448 may include an uplink classifier to support routing traffic flows to a data network.

The NSSF 2450 may select a set of network slice instances serving the UE 2402. The NSSF 2450 may also determine allowed NSSAI and the mapping to the subscribed S-NSSAIs, if needed. The NSSF 2450 may also determine the AMF set to be used to serve the UE 2402, or a list of candidate AMFs based on a suitable configuration and possibly by querying the NRF 2454. The selection of a set of network slice instances for the UE 2402 may be triggered by the AMF 2444 with which the UE 2402 is registered by interacting with the NSSF 2450, which may lead to a change of AMF. The NSSF 2450 may interact with the AMF 2444 via an N22 reference point; and may communicate with another NSSF in a visited network via an N31 reference point (not shown). Additionally, the NSSF 2450 may exhibit an Nnssf service-based interface.

The NEF 2452 may securely expose services and capabilities provided by 3GPP network functions for third party, internal exposure/re-exposure, AFs (e.g., AF 2460), edge computing or fog computing systems, etc. In such embodiments, the NEF 2452 may authenticate, authorize, or throttle the AFs. NEF 2452 may also translate information exchanged with the AF 2460 and information exchanged with internal network functions. For example, the NEF 2452 may translate between an AF-Service-Identifier and an internal 5GC information. NEF 2452 may also receive information from other NFs based on exposed capabilities of other NFs. This information may be stored at the NEF 2452 as structured data, or at a data storage NF using standardized interfaces. The stored information can then be re-exposed by the NEF 2452 to other NFs and AFs, or used for other purposes such as analytics. Additionally, the NEF 2452 may exhibit an Nnef service-based interface.

The NRF 2454 may support service discovery functions, receive NF discovery requests from NF instances, and provide the information of the discovered NF instances to the NF instances. NRF 2454 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 2454 may exhibit the Nnrf service-based interface.

The PCF 2456 may provide policy rules to control plane functions to enforce them, and may also support unified policy framework to govern network behavior. The PCF 2456 may also implement a front end to access subscription information relevant for policy decisions in a UDR of the UDM 2458. In addition to communicating with functions over reference points as shown, the PCF 2456 exhibit an Npcf service-based interface.

The UDM 2458 may handle subscription-related information to support the network entities' handling of communication sessions, and may store subscription data of UE 2402. For example, subscription data may be communicated via an N8 reference point between the UDM 2458 and the AMF 2444. The UDM 2458 may include two parts, an application front end and a UDR. The UDR may store subscription data and policy data for the UDM 2458 and the PCF 2456, and/or structured data for exposure and application data (including PFDs for application detection, application request information for multiple UEs 2402) for the NEF 2452. The Nudr service-based interface may be exhibited by the UDR 221 to allow the UDM 2458, PCF 2456, and NEF 2452 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 2458 may exhibit the Nudm service-based interface.

The AF 2460 may provide application influence on traffic routing, provide access to NEF, and interact with the policy framework for policy control.

In some embodiments, the 5GC 2440 may enable edge computing by selecting operator/3rd party services to be geographically close to a point that the UE 2402 is attached to the network. This may reduce latency and load on the network. To provide edge-computing implementations, the 5GC 2440 may select a UPF 2448 close to the UE 2402 and execute traffic steering from the UPF 2448 to data network 2436 via the N6 interface. This may be based on the UE subscription data, UE location, and information provided by the AF 2460. In this way, the AF 2460 may influence UPF (re)selection and traffic routing. Based on operator deployment, when AF 2460 is considered to be a trusted entity, the network operator may permit AF 2460 to interact directly with relevant NFs. Additionally, the AF 2460 may exhibit an Naf service-based interface.

The data network 2436 may represent various network operator services, Internet access, or third party services that may be provided by one or more servers including, for example, application/content server 2438.

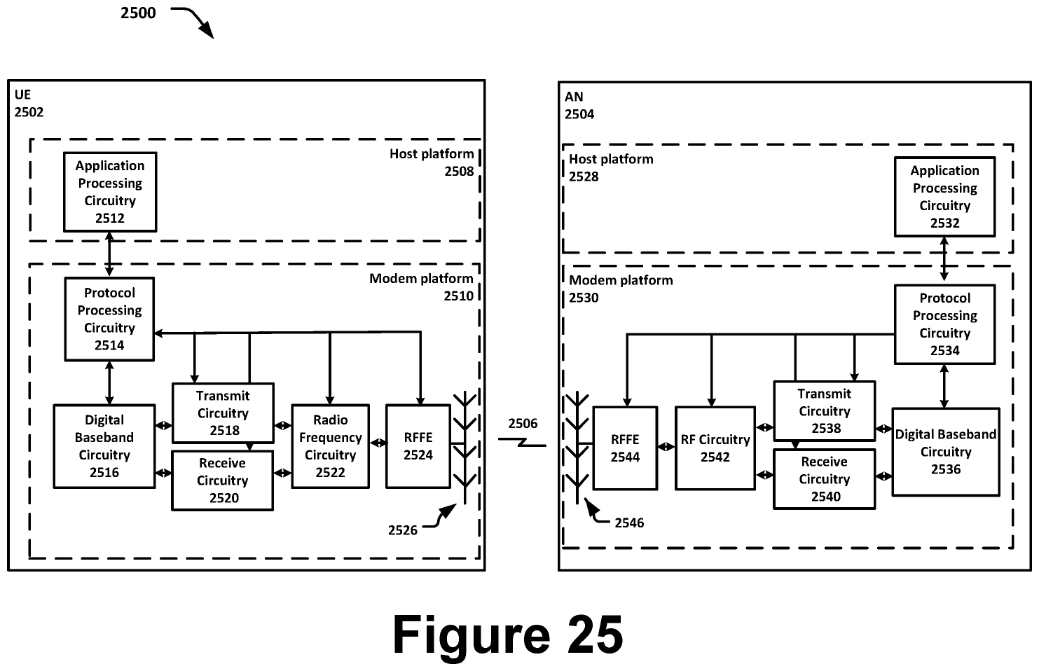

FIG. 25 schematically illustrates a wireless network 2500 in accordance with various embodiments. The wireless network 2500 may include a UE 2502 in wireless communication with an AN 2504. The UE 2502 and AN 2504 may be similar to, and substantially interchangeable with, like-named components described elsewhere herein.

The UE 2502 may be communicatively coupled with the AN 2504 via connection 2506. The connection 2506 is illustrated as an air interface to enable communicative coupling, and can be consistent with cellular communications protocols such as an LTE protocol or a 5G NR protocol operating at mmWave or sub-6 GHz frequencies.

The UE 2502 may include a host platform 2508 coupled with a modem platform 2510. The host platform 2508 may include application processing circuitry 2512, which may be coupled with protocol processing circuitry 2514 of the modem platform 2510. The application processing circuitry 2512 may run various applications for the UE 2502 that source/sink application data. The application processing circuitry 2512 may further implement one or more layer operations to transmit/receive application data to/from a data network. These layer operations may include transport (for example UDP) and Internet (for example, IP) operations

The protocol processing circuitry 2514 may implement one or more of layer operations to facilitate transmission or reception of data over the connection 2506. The layer operations implemented by the protocol processing circuitry 2514 may include, for example, MAC, RLC, PDCP, RRC and NAS operations.

The modem platform 2510 may further include digital baseband circuitry 2516 that may implement one or more layer operations that are “below” layer operations performed by the protocol processing circuitry 2514 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 2510 may further include transmit circuitry 2518, receive circuitry 2520, RF circuitry 2522, and RF front end (RFFE) 2524, which may include or connect to one or more antenna panels 2526. Briefly, the transmit circuitry 2518 may include a digital-to-analog converter, mixer, intermediate frequency (IF) components, etc.; the receive circuitry 2520 may include an analog-to-digital converter, mixer, IF components, etc.; the RF circuitry 2522 may include a low-noise amplifier, a power amplifier, power tracking components, etc.; RFFE 2524 may include filters (for example, surface/bulk acoustic wave filters), switches, antenna tuners, beamforming components (for example, phase-array antenna components), etc. The selection and arrangement of the components of the transmit circuitry 2518, receive circuitry 2520, RF circuitry 2522, RFFE 2524, and antenna panels 2526 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 2514 may include one or more instances of control circuitry (not shown) to provide control functions for the transmit/receive components.

A UE reception may be established by and via the antenna panels 2526, RFFE 2524, RF circuitry 2522, receive circuitry 2520, digital baseband circuitry 2516, and protocol processing circuitry 2514. In some embodiments, the antenna panels 2526 may receive a transmission from the AN 2504 by receive-beamforming signals received by a plurality of antennas/antenna elements of the one or more antenna panels 2526.

A UE transmission may be established by and via the protocol processing circuitry 2514, digital baseband circuitry 2516, transmit circuitry 2518, RF circuitry 2522, RFFE 2524, and antenna panels 2526. In some embodiments, the transmit components of the UE 2504 may apply a spatial filter to the data to be transmitted to form a transmit beam emitted by the antenna elements of the antenna panels 2526.

Similar to the UE 2502, the AN 2504 may include a host platform 2528 coupled with a modem platform 2530. The host platform 2528 may include application processing circuitry 2532 coupled with protocol processing circuitry 2534 of the modem platform 2530. The modem platform may further include digital baseband circuitry 2536, transmit circuitry 2538, receive circuitry 2540, RF circuitry 2542, RFFE circuitry 2544, and antenna panels 2546. The components of the AN 2504 may be similar to and substantially interchangeable with like-named components of the UE 2502. In addition to performing data transmission/reception as described above, the components of the AN 2508 may perform various logical functions that include, for example, RNC functions such as radio bearer management, uplink and downlink dynamic radio resource management, and data packet scheduling.

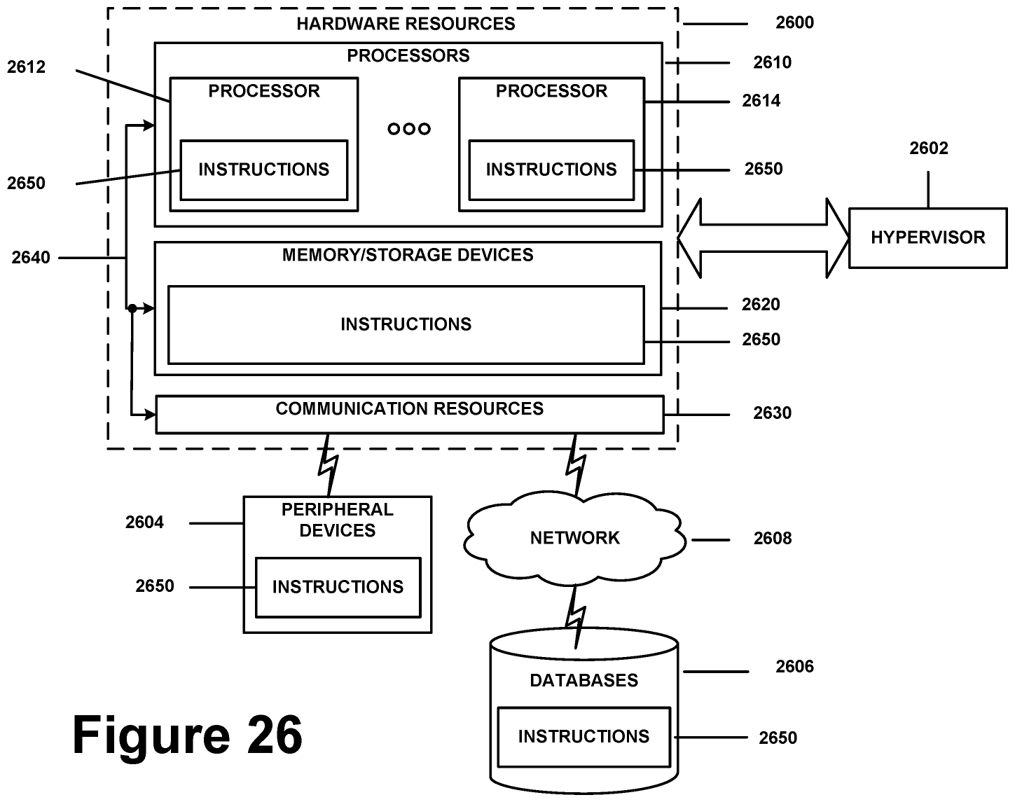

FIG. 26 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 26 shows a diagrammatic representation of hardware resources 2600 including one or more processors (or processor cores) 2610, one or more memory/storage devices 2620, and one or more communication resources 2630, each of which may be communicatively coupled via a bus 2640 or other interface circuitry. For embodiments where node virtualization (e.g., NFV) is utilized, a hypervisor 2602 may be executed to provide an execution environment for one or more network slices/sub-slices to utilize the hardware resources 2600.

The processors 2610 may include, for example, a processor 2612 and a processor 2614. The processors 2610 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 2620 may include main memory, disk storage, or any suitable combination thereof. The memory/storage devices 2620 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 2630 may include interconnection or network interface controllers, components, or other suitable devices to communicate with one or more peripheral devices 2604 or one or more databases 2606 or other network elements via a network 2608. For example, the communication resources 2630 may include wired communication components (e.g., for coupling via USB, Ethernet, etc.), cellular communication components, NFC components, Bluetooth® (or Bluetooth® Low Energy) components, Wi-Fi® components, and other communication components.

Instructions 2650 may comprise software, a program, an application, an applet, an app, or other executable code for causing at least any of the processors 2610 to perform any one or more of the methodologies discussed herein. The instructions 2650 may reside, completely or partially, within at least one of the processors 2610 (e.g., within the processor's cache memory), the memory/storage devices 2620, or any suitable combination thereof. Furthermore, any portion of the instructions 2650 may be transferred to the hardware resources 2600 from any combination of the peripheral devices 2604 or the databases 2606. Accordingly, the memory of processors 2610, the memory/storage devices 2620, the peripheral devices 2604, and the databases 2606 are examples of computer-readable and machine-readable media.

### Example Procedures

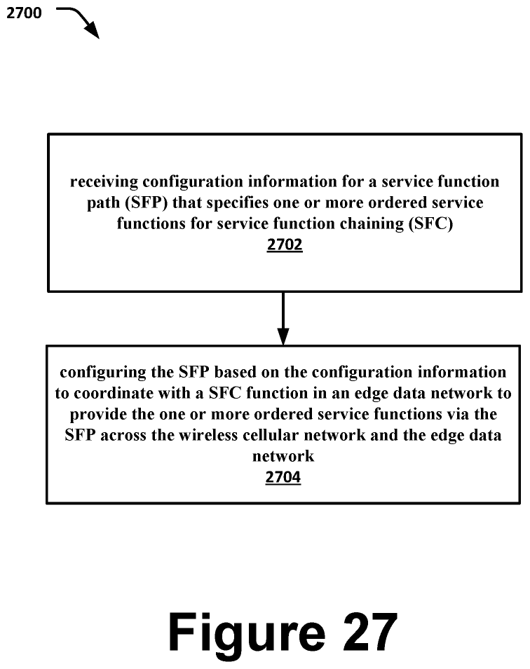

In some embodiments, the electronic device(s), network(s), system(s), chip(s) or component(s), or portions or implementations thereof, of FIGS. 24-26, or some other figure herein, may be configured to perform one or more processes, techniques, or methods as described herein, or portions thereof. For example, FIG. 27 illustrates a process 2700 in accordance with various embodiments. At 2702, the process 2700 may include receiving configuration information for a service function path (SFP) that specifies one or more ordered service functions for service function chaining (SFC). At 2704, the process 2700 may further include configuring the SFP based on the configuration information to coordinate with a SFC function in an edge data network to provide the one or more ordered service functions via the SFP across the wireless cellular network and the edge data network. In some embodiments, the process 2700 may be performed by a SFC control plane function (SFCF-C) or a portion thereof.

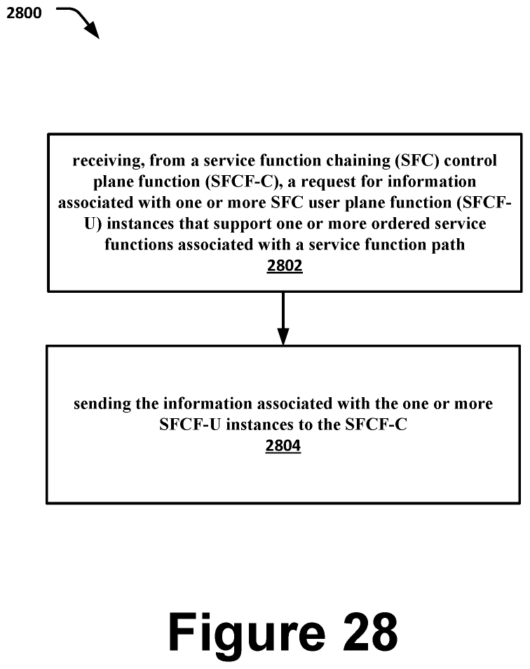

FIG. 28 illustrates another process 2800 in accordance with various embodiments. At 2802, the process 2800 may include receiving, from a service function chaining (SFC) control plane function (SFCF-C), a request for information associated with one or more SFC user plane function (SFCF-U) instances that support one or more ordered service functions associated with a service function path. At 2804, the process 2800 may further include sending the information associated with the one or more SFCF-U instances to the SFCF-C. In some embodiments, the process 2800 may be performed by an operations, administration, and management (OAM) entity or a portion thereof.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Additional examples of the presently described embodiments include the following, non-limiting implementations. Each of the following non-limiting examples may stand on its own or may be combined in any permutation or combination with any one or more of the other examples provided below or throughout the present disclosure.

Example A01 includes a method for enabling the coordination of service function chaining services in 5G system and in Edge Data Network.

Example A02 includes the method of example A01 and/or some other example(s) herein, wherein the SFC service in Edge Data Network can be provided by Edge service provider or Edge computing service provider or SFC network provider, which can include SFC parameters of SFC service configuration in SLA (service level agreement) with network operators for using 3GPP orchestration and management services.

Example A03 includes the method of example A02 and/or some other example(s) herein, wherein, based on SLA for SFC services at 5G network, the OAM configures static SFC configuration at PCF/SFCF-C for managing SFC policies.

Example A04 includes the method of example A02 and/or some other example(s) herein, wherein, based on SLA for SFC services at 5G network, the OAM configures SMF/SFCF-C with SFC service configurations.

Example A05 includes the method of examples A03-A04 and/or some other example(s) herein, wherein SFCF-C configures SFPs to be coordinated with SFC network in Edge Data Network.

Example A06 includes the method of example A05 and/or some other example(s) herein, wherein SFP is identified by an SFP ID which is composed by one or more SFCF-U instances with different SFs based on the following information: SFC service ID; SFC application ID; the supported SFs of an SFCF-U instance; address information of ordered SFCF-U(s), e.g. ingress address and port and egress address and port of each SFCF-U.

Example A07 includes the method of example A01 and/or some other example(s) herein, wherein SFCF-C obtains SFC configuration, including one or more SFs and corresponding parameters for SFC service provided by 5G network, from EAS.

Example A08 includes the method of example A07 and/or some other example(s) herein, wherein the SFCF-C receiving SFC parameters for SFC service configuration can check the existing available SFCF-U instances with required SFs for the requested SFC service for a UE, a group of UEs, or any UEs, or any UEs of an application, or any UEs of an SFC service.

Example A09 includes the method of example A08 and/or some other example(s) herein, wherein SFCF-C obtain available SFCF-U instance by requesting an SFCF-U instance from NRF indicating requirement of the supported one or more SFs of the SFCF-C instance.

Example A10 includes the method of example A08 and/or some other example(s) herein, wherein SFCF-C subscribed to NRF service for the notification of status changes of available SFCF-U NFs.

Example A11 includes the method of examples A09-A10 and/or some other example(s) herein, wherein the SFCF-C obtains available SFCF-U instances with supported one or more SFs information from NRF or OAM.

Example A12 includes the method of example A11 and/or some other example(s) herein, wherein the OAM configures the SFCF-U instance.

Example A13 includes the method of example A12 and/or some other example(s) herein, wherein the OAM configuration of NRF contains the information of supported one or more SFs for the SFCF-U instance.

Example A13 includes the method of example A13 and/or some other example(s) herein, wherein the SFCF-U or OAM registers SFCF-U instance to NRF, in which Nnrf_NFManagement_NFRegister or OAM configuration of NRF contains the information of supported one or more SFs for the SFCF-U instance.

Example A15 includes the method of example A14 and/or some other example(s) herein, wherein the NRF provides the available SFCF-U information to the SFCF-C, in which the SFCF-U information contains the supported one or more SFs of the SFCF-U instance.

Example A16 includes the method of example A12 and/or some other example(s) herein, wherein the OAM configures new SFCF-U instance with information of the application indicated by application ID that is supported for this SFCF-U instance.

Example A17 includes the method of example A16 and/or some other example(s) herein, wherein the OAM configuration of NRF associates this SFCF-U instance with the Application ID and SFC service ID as additional information

Example A18 includes the method of example A17 and/or some other example(s) herein, wherein if Application-ID and SFC service ID are provided in step 6, the NRF provides the application-ID and SFC service ID to the SFCF-U in the notification message, e.g., Nnrf_NFManagement_NFStatusNotify.

Example A19 includes the method of examples A15, A18 and/or some other example(s) herein, wherein the SFCF-C configures SFPs based on the information of the SFC service ID, SFC application ID, and supported SFs information of the SFCF-U instances.

Example B01 includes a method for coordinating service function chaining (SFC) services in a 5G system (5GS) and a Edge Data Network (EDN), the method comprising: indicating, by a SFC user plane function (SFCF-U) and SFC control plane function (SFCF-C), support of SFC enablers in control plane and user plane at 5G network, respectively.

Example B02 includes the method of example B01 and/or some other example(s) herein, wherein the SFC service in the EDN is provided by an Edge service provider, an Edge computing service provider, or SFC network provider, which can include SFC parameters of SFC service configuration in service level agreement (SLA) with network operators for using 3GPP orchestration and management services.

Example B03 includes the method of example B02 and/or some other example(s) herein, wherein, based on SLA for SFC services at 5G network, the OAM configures static SFC configuration at PCF/SFCF-C for managing SFC policies.

Example B04 includes the method of examples B02-B03 and/or some other example(s) herein, wherein the OAM configures SFCF-C with SFC service configurations based on SLA for SFC services at 5GS.

Example B05 includes the method of examples B03-B04 and/or some other example(s) herein, wherein SFCF-C configures SFPs to be coordinated with SFC network in the EDN.

Example B06 includes the method of example B05 and/or some other example(s) herein, wherein SFP is identified by an SFP ID which is composed by one or more SFCF-U instances with different SFs based on the following information: SFC service ID; SFC application ID; the supported SFs of an SFCF-U instance; address information of ordered SFCF-U(s), (e.g., ingress address and port and egress address and port of each SFCF-U).

Example B07 includes the method of examples B01-B06 and/or some other example(s) herein, wherein SFCF-C obtains SFC configuration, including one or more SFs and corresponding parameters for SFC service provided by 5G network, from EAS.

Example B08 includes the method of example B07 and/or some other example(s) herein, wherein the SFCF-C receiving SFC parameters for SFC service configuration can check the existing available SFCF-U instances with required SFs for the requested SFC service for a UE, a group of UEs, or any UEs, or any UEs of an application, or any UEs of an SFC service.

Example B09 includes the method of example B08 and/or some other example(s) herein, wherein SFCF-C obtain available SFCF-U instance by requesting an SFCF-U instance from NRF indicating requirement of the supported one or more SFs of the SFCF-C instance.

Example B10 includes the method of examples B08-B09 and/or some other example(s) herein, wherein SFCF-C subscribed to NRF service for the notification of status changes of available SFCF-U NFs.

Example B11 includes the method of examples B09-B10 and/or some other example(s) herein, wherein the SFCF-C obtains available SFCF-U instances with supported one or more SFs information from NRF or OAM.

Example B12 includes the method of example B11 and/or some other example(s) herein, wherein the OAM configures the SFCF-U instance.

Example B13 includes the method of example B12 and/or some other example(s) herein, wherein the OAM configuration of NRF contains the information of supported one or more SFs for the SFCF-U instance.

Example B14 includes the method of example B13 and/or some other example(s) herein, wherein the SFCF-U or OAM registers SFCF-U instance to NRF, in which Nnrf_NFManagement_NFRegister or OAM configuration of NRF contains the information of supported one or more SFs for the SFCF-U instance.

Example B15 includes the method of example B14 and/or some other example(s) herein, wherein the NRF provides the available SFCF-U information to the SFCF-C, in which the SFCF-U information contains the supported one or more SFs of the SFCF-U instance.

Example B16 includes the method of examples B12-B15 and/or some other example(s) herein, wherein the OAM configures new SFCF-U instance with information of the application indicated by application ID that is supported for this SFCF-U instance.

Example B17 includes the method of example B16 and/or some other example(s) herein, wherein the OAM configuration of NRF associates this SFCF-U instance with the Application ID and SFC service ID as additional information

Example B18 includes the method of example B17 and/or some other example(s) herein, wherein if Application-ID and SFC service ID are provided in step 6, the NRF provides the application-ID and SFC service ID to the SFCF-U in the notification message (e.g., Nnrf_NFManagement_NFStatusNotify).

Example B19 includes the method of examples B15-B18 and/or some other example(s) herein, wherein the SFCF-C configures SFPs based on the information of the SFC service ID, SFC application ID, and supported SFs information of the SFCF-U instances.

Example B20 includes the method of examples A01-A19, B01-B19, and/or some other example(s) herein, wherein the SFCF-U is a UPF in the 5GS, the SFCF-C is a PCF, NEF, or SMF in the 5GS, and the Edge Enabler is an AF in the 5GS.

Example C1 includes a method for enabling service function chaining services at Edge Computing Data Network with Edge Application servers and Edge enabler servers.

Example C2 includes the method of example C1 and/or some other example(s) herein, wherein the service function chaining service enables the support of service function chaining network (SFC Network), which terminates N6 reference points between 5G network and trusted Edge Computing data networks or external Edge Computing data networks depending on the deployment scenarios and the business relationship of the Edge Application Service Provider or Edge Computing Service Provider with the PLMN operator.

Example C3 includes the method of example C2 and/or some other example(s) herein, wherein the Edge application server (EAS) and Edge enabler Server (EES) are in the external Edge Computing data network, the Application Function (AF) in EAS or EES can inference the traffic routing over N6 towards the SFC network at Edge data network via NEF over N33 interface.

Example C4 includes the method of example C2 and/or some other example(s) herein, wherein the Edge application server (EAS) and Edge enabler server (EES) are in the trusted Edge computing Data network, the Application Function in EAS or EES can interfere the traffic routing over N6 towards the SFC network at Edge data network via PCF directly over N5 interface.

Example C5 includes the method of examples C3 or C4 and/or some other example(s) herein, wherein the Edge application servers use SFC service provided by SFC network in Edge Data Network by using AF inferencing traffic routing for steering N6 traffics towards SFC network in Edge Data Network.

Example C6 includes the method of example C2 and/or some other example(s) herein, wherein the SFC network providing SFC services contains the service functions and one or more service function paths at Edge Computing Data Network, in which a traffic classifier terminates N6 at SFC network for handling traffics from 3GPP network before starting SFC services and a traffic de-classifier for further combining the traffic flows through same or different SFPs before forwarding the traffic towards EAS over EDGE-X interface.

Example C7 includes the method of example C2 and/or some other example(s) herein, wherein the service function chaining policy for steering traffic that needs to pass through a specific Service Function Path (SFP) in SFC network can be configured by Edge Application Server, Edge Computing Enabler Server, or 3GPP OAM.

Example C8 includes the method of example C7 and/or some other example(s) herein, wherein the SFC services can be provided by one or more service providers, including edge service provider(s), the Edge computing service provider(s), SFC network service providers, or network operator(s) Example C9 includes the method of example C8 and/or some other example(s) herein, wherein the SFC network configuration can be supported over EDGE-X and EDGE-Y by the EAS(s) for the SFs provided by edge application service providers, and EES(s) for the SFs provided by Edge computing service providers, respectively.

Example C10 includes the method of example C5 and/or some other example(s) herein, wherein AF inferencing traffic routing is sent by EAS using 5G network capability exposure APIs for interacting 5GC directly.

Example C11 includes the method of example C8 and/or some other example(s) herein, wherein AF inferencing traffic routing is sent by Edge Enabler Server (EES) when receiving EAS request using EES capability exposure APIs for interacting with 5G network.

Example C12 includes the method of example C6 and/or some other example(s) herein, wherein the service function chain service is provided by a service function containing function in user plane containing one or more service functions with the following service function but not limited to: Network address translation (NAT), IP tunnel endpoints, Packet classifiers, deep packet inspection (DPI), Lawful inspection (LI), TCP proxies, load balancers, Firewall functions, Transcoders, video optimizer, URL filter, Application detection and control (ADC).

Example C13 includes the method of example C12 and/or some other example(s) herein, wherein the SFC parameters of SFC service can include at least one of the following information: SFC service ID as the service ID of this set of SFC parameters for SFC service; SFC configuration as one or more SFs with the corresponding SF parameters; SFP configuration as the SFP index with the corresponding ordered SFs;

Example C14 includes the method of example C13 and/or some other example(s) herein, wherein the SFC parameters of SFC service also include the information of SFC routing policy which contains traffic classifier indicating the mapping between a SPF index and traffic filtering rules for forwarding traffic to the first SF in an SFP identified by an SFP index and traffic de-classifier indicating with traffic filter rules for combining traffic from the last SF in an SFP identified by an SFP index.

Example C15 includes the method of examples C13 or C14 and/or some other example(s) herein, wherein the SFC parameters of SFC service also include the information of Validity parameters for the SFC service identified by the SFC service ID, which can include one or more of the following information: Duration, Scheduled Time period, Application ID(s), Associated PDU session parameters, including PDU session type, e.g., IP/Ethernet/Unstructure, DNN, or a slice/Service type (SST) (e.g., eMBB, URLLC, MIoT, V2X, etc) and optional slice differentiator (SD).

Example C16 includes the method of example C14 and/or some other example(s) herein, wherein the traffic classifier provides a SPF index with the mapping to SFC classification policy based on different level or granularities per packet, which can include one or more the following information but not limit to UE address, Application ID, Media type, Traffic priorities.

Example C17 includes the method of example C14 and/or some other example(s) herein, wherein the traffic de-classifier provides an Edge application server ID (EAS ID), which, which terminates Edge-Z reference point for the target Edge application server, with the mapping to SFC re-classification policy including one or more the following information to combine traffics from one or more SFPs before forwarding to the application server of an application.

Example C18 includes the method of example C16 or example C17 and/or some other example(s) herein, wherein the policy can be based on but not limit to the information of UE address, Application ID, Media type, Traffic priorities, SPF index.

Example C19 includes the method of example C18 and/or some other example(s) herein, wherein when the information for the policy is only available in traffic payload, the DPI capability at the traffic classifier or traffic declassifier is needed.

Example C20 includes a method for enabling service function chaining (SFC) services comprising one or more service function paths (SFPs).

Example C21 includes the method of example C20 and/or some other example(s) herein, wherein the SFC service enables the support of an SFC network, which terminates N6 reference points between 5G network and at least one Edge Computing Data Network (ECDN).

Example C22 includes the method of examples C20-21 and/or some other example(s) herein, wherein the ECDN comprises one or more Edge Application Servers and/or one or more Edge Enabler Servers.

Example C23 includes the method of examples C21-22 and/or some other example(s) herein, wherein the ECDN is one or more trusted Edge Computing Data Networks (ECDNs) and/or one or more external ECDNs.

Example C24 includes the method of example C23 and/or some other example(s) herein, wherein the Edge application server (EAS) and Edge enabler Server (EES) are in the external Edge Computing data network, the Application Function (AF) in EAS or EES can inference the traffic routing over N6 towards the SFC network at Edge data network via NEF over N33 interface.

Example C25 includes the method of example C23 and/or some other example(s) herein, wherein the Edge application server (EAS) and Edge enabler server (EES) are in the trusted Edge computing Data network, the Application Function in EAS or EES can interfere the traffic routing over N6 towards the SFC network at Edge data network via PCF directly over N5 interface. Example C26 includes the method of examples C24-C25 and/or some other example(s) herein, wherein the Edge application servers use SFC service provided by SFC network in Edge Data Network by using AF inferencing traffic routing for steering N6 traffics towards SFC network in Edge Data Network.

Example C27 includes the method of examples C1-C26 and/or some other example(s) herein, wherein the SFC network providing SFC services contains the service functions and one or more service function paths at Edge Computing Data Network, in which a traffic classifier terminates N6 at SFC network for handling traffics from 3GPP network before starting SFC services and a traffic de-classifier for further combining the traffic flows through same or different SFPs before forwarding the traffic towards EAS over EDGE-X interface.

Example C28 includes the method of examples C1-C27 and/or some other example(s) herein, wherein the service function chaining policy for steering traffic that needs to pass through a specific Service Function Path (SFP) in SFC network can be configured by Edge Application Server, Edge Computing Enabler Server, or 3GPP OAM.

Example C29 includes the method of example C28 and/or some other example(s) herein, wherein the SFC services can be provided by one or more service providers, including edge service provider(s), the Edge computing service provider(s), SFC network service providers, or network operator(s)

Example C30 includes the method of example C29 and/or some other example(s) herein, wherein the SFC network configuration can be supported over EDGE-X and EDGE-Y by the EAS(s) for the SFs provided by edge application service providers, and EES(s) for the SFs provided by Edge computing service providers, respectively.

Example C31 includes the method of examples C26-C30 and/or some other example(s) herein, wherein AF inferencing traffic routing is sent by EAS using 5G network capability exposure APIs for interacting 5GC directly.

Example C32 includes the method of examples C29-C31 and/or some other example(s) herein, wherein AF inferencing traffic routing is sent by Edge Enabler Server (EES) when receiving EAS request using EES capability exposure APIs for interacting with 5G network.

Example C33 includes the method of examples C29-C32 and/or some other example(s) herein, wherein the service function chain service is provided by a service function containing function in user plane containing one or more service functions with the following service function but not limited to: Network address translation (NAT), IP tunnel endpoints, Packet classifiers, deep packet inspection (DPI), Lawful inspection (LI), TCP proxies, load balancers, Firewall functions, Transcoders, video optimizer, URL filter, Application detection and control (ADC).

Example C34 includes the method of example C33 and/or some other example(s) herein, wherein the SFC parameters of SFC service can include at least one of the following information: SFC service ID as the service ID of this set of SFC parameters for SFC service; SFC configuration as one or more SFs with the corresponding SF parameters; SFP configuration as the SFP index with the corresponding ordered SFs;

Example C35 includes the method of example C34 and/or some other example(s) herein, wherein the SFC parameters of SFC service also include the information of SFC routing policy which contains traffic classifier indicating the mapping between a SPF index and traffic filtering rules for forwarding traffic to the first SF in an SFP identified by an SFP index and traffic de-classifier indicating with traffic filter rules for combining traffic from the last SF in an SFP identified by an SFP index.

Example C36 includes the method of examples C33-C35 and/or some other example(s) herein, wherein the SFC parameters of SFC service also include the information of Validity parameters for the SFC service identified by the SFC service ID, which can include one or more of the following information: Duration, Scheduled Time period, Application ID(s), Associated PDU session parameters, including PDU session type, e.g., IP/Ethernet/Unstructure, DNN, or a slice/Service type (SST) (e.g., eMBB, URLLC, MIoT, V2X, etc) and optional slice differentiator (SD).

Example C37 includes the method of examples C35-C36 and/or some other example(s) herein, wherein the traffic classifier provides a SPF index with the mapping to SFC classification policy based on different level or granularities per packet, which can include one or more the following information but not limit to UE address, Application ID, Media type, Traffic priorities.

Example C38 includes the method of examples C35-C37 and/or some other example(s) herein, wherein the traffic de-classifier provides an Edge application server ID (EAS ID), which, which terminates Edge-Z reference point for the target Edge application server, with the mapping to SFC re-classification policy including one or more the following information to combine traffics from one or more SFPs before forwarding to the application server of an application.

Example C39 includes the method of examples C37-C38 and/or some other example(s) herein, wherein the policy can be based on but not limit to the information of UE address, Application ID, Media type, Traffic priorities, SPF index.

Example C40 includes the method of example C38-C39 and/or some other example(s) herein, wherein when the information for the policy is only available in traffic payload, the DPI capability at the traffic classifier or traffic declassifier is needed.

Example D1 includes one or more non-transitory computer-readable media (NTCRM) having instructions, stored thereon, that when executed by one or more processors cause an apparatus of a wireless cellular network to: receive configuration information for a service function path (SFP) that specifies one or more ordered service functions for service function chaining (SFC); and configure the SFP based on the configuration information to coordinate with a SFC function in an edge data network to provide the one or more ordered service functions via the SFP across the wireless cellular network and the edge data network.

Example D2 includes the one or more NTCRM of example D1, wherein the configuration information is received from an operations, administration, and management (OAM) entity or a network function repository function (NRF) of the wireless cellular network.

Example D3 includes the one or more NTCRM of any of examples D1-D2, wherein the configuration information includes one or more SFC parameters based on a service level agreement (SLA) for SFC services at the wireless cellular network.

Example D4 includes the one or more NTCRM of any of examples D1-D3, wherein the configuration information is received from an edge application server (EAS) and indicates the one or more ordered service functions to be provided by the wireless cellular network and associated parameters.

Example D5 includes the one or more NTCRM of any of examples D1-D4, wherein to configure the SFP includes to configure one or more SFC user plane functions (SFCF-Us) to provide the one or more ordered service functions.

Example D6 includes the one or more NTCRM of example D5, wherein the configuration information includes an indication of one or more SFCF-U instances that support one or more of the one or more ordered service functions.

Example D7 includes the one or more NTCRM of example D6, wherein the instructions, when executed, are further to cause the apparatus to send a request for the configuration information associated with the one or more SFCF-U instances, wherein the request identifies the one or more ordered service functions.

Example D8 includes the one or more NTCRM of example D6 or example D7, wherein the configuration information further includes at least one of a SFC application ID or a SFC service ID associated with the respective one or more SFCF-U instances.

Example D9 includes the one or more NTCRM of any of examples D1-D8, wherein the apparatus implements a SFC control plane function (SFCF-C).

Example D10 includes one or more non-transitory computer-readable media (NTCRM) having instructions, stored thereon, that when executed by one or more processors cause an operations, administration, and management (OAM) entity to: receive, from a service function chaining (SFC) control plane function (SFCF-C), a request for information associated with one or more SFC user plane function (SFCF-U) instances that support one or more service ordered functions associated with a service function path; and send the information associated with the one or more SFCF-U instances to the SFCF-C.

Example D11 includes the one or more NTCRM of example D10, wherein the instructions, when executed, are further to cause the OAM entity to: determine that no SFCF-U instance that supports a first service function of the one or more ordered service functions is available; and configure, based on the determination, a new SFCF-U instance to support the first service function.

Example D12 includes the one or more NTCRM of example D10-D11, wherein the instructions, when executed, are further to cause the OAM entity to register the new SFCF-U instance with a network function repository function (NRF).

Example D13 includes the one or more NTCRM of example D12, wherein to register the new SFCF-U instance with the NRF includes to provide information on at least one of an application ID and a SFC service ID associated with the SFCF-U instance.

Example D14 includes the one or more NTCRM of any of examples D10-D13, wherein the service function path includes the one or more ordered service functions to be provided by a wireless cellular network and one or more other ordered service functions to be provided by an edge data network.

Example D15 includes an apparatus of an edge data network, the apparatus comprising: a traffic classifier to receive service function chaining (SFC) traffic from a wireless cellular network and route the SFC traffic to one or more ordered service functions via a service function path (SFP); and a traffic declassifier to receive the SFP traffic from the SFP and provide the SFP traffic to an edge application server or an edge enabler server.

Example D16 includes the apparatus of example D15, wherein the traffic classifier is further to receive SFC policy information, and wherein the SFC traffic is to identify the SFP via with to route the SFC traffic based on the SFC policy information.

Example D17 includes the apparatus of example D16, wherein the SFC policy information is received from the edge application server, the edge enabler server, or an operations, administration, and management (OAM) entity of the wireless cellular network.

Example D18 includes the apparatus of any of examples D15-D17, wherein the SFC traffic is received via an N6 interface and the SFP traffic is provided via an EDGE-X or EDGE-Y interface.

Example D19 includes the apparatus of any of examples D15-D18, wherein the traffic declassifier is to combine SFP traffic from multiple SFPs and provide the combined SFP traffic to the edge application server or the edge enabler server.

Example D20 includes the apparatus of any of examples D15-D19, wherein the one or more service functions include one or more of: network address translation (NAT), an Internet Protocol (IP) tunnel endpoint, a packet classifier, deep packet inspection (DPI), lawful inspection (LI), a transmission control protocol (TCP) proxy, a load balancer, a firewall function, a transcoder, a video optimizer, a uniform resource locator (URL) filter, or application detection and control (ADC).

Example D21 includes the apparatus of any of examples D15-D19, wherein the traffic classifier is to receive SFC parameters for an SFC service associated with the SFC traffic, wherein the SFC parameters include one or more of: a SFC service ID, a SFC configuration that includes one or more service functions and associated service function parameters, or a SFP configuration that includes an SFP index and associated ordered service functions; and wherein the traffic classifier is route the SFC traffic based further on the SFC parameters.

Example D22 includes the apparatus of example D21, wherein the SFC parameters further include one or more validity parameters for the SFC service, wherein the one or more validity parameters include one or more of: a duration, a scheduled time period, one or more application IDs, a packet data unit session type or other associated PDU session parameters, or a slice differentiator.

Example D23 includes the apparatus of any of examples D15-D22, wherein the SFC traffic includes one or more of a user equipment (UE) address, an application ID, a media type, or a traffic priority.

Example Z01 includes an apparatus comprising means to perform one or more elements of a method described in or related to any of examples A01-A19, B01-B20, C1-C40, D1-D23, or any other method or process described herein.

Example Z02 includes one or more non-transitory computer-readable media comprising instructions to cause an electronic device, upon execution of the instructions by one or more processors of the electronic device, to perform one or more elements of a method described in or related to any of examples A01-A19, B01-B20, C1-C40, D1-D23, or any other method or process described herein.

Example Z03 includes an apparatus comprising logic, modules, or circuitry to perform one or more elements of a method described in or related to any of examples A01-A19, B01-B20, C1-C40, D1-D23, or any other method or process described herein.

Example Z04 includes a method, technique, or process as described in or related to any of examples A01-A19, B01-B20, C1-C40, D1-D23, or portions or parts thereof.

Example Z05 includes an apparatus comprising: one or more processors and one or more computer-readable media comprising instructions that, when executed by the one or more processors, cause the one or more processors to perform the method, techniques, or process as described in or related to any of examples A01-A19, B01-B20, C1-C40, D1-D23, or portions thereof.

Example Z06 includes a signal as described in or related to any of examples A01-A19, B01-B20, C1-C40, D1-D23, or portions or parts thereof.

Example Z07 includes a datagram, packet, frame, segment, protocol data unit (PDU), or message as described in or related to any of examples A01-A19, B01-B20, C1-C40, D1-D23, or portions or parts thereof, or otherwise described in the present disclosure.

Example Z08 includes a signal encoded with data as described in or related to any of examples A01-A19, B01-B20, C1-C40, D1-D23, or portions or parts thereof, or otherwise described in the present disclosure.

Example Z09 includes a signal encoded with a datagram, packet, frame, segment, protocol data unit (PDU), or message as described in or related to any of examples A01-A19, B01-B20, C1-C40, D1-D23, or portions or parts thereof, or otherwise described in the present disclosure.

Example Z10 includes an electromagnetic signal carrying computer-readable instructions, wherein execution of the computer-readable instructions by one or more processors is to cause the one or more processors to perform the method, techniques, or process as described in or related to any of examples A01-A19, B01-B20, C1-C40, D1-D23, or portions thereof.

Example Z11 includes a computer program comprising instructions, wherein execution of the program by a processing element is to cause the processing element to carry out the method, techniques, or process as described in or related to any of examples A01-A19, B01-B20, C1-C40, D1-D23, or portions thereof.

Example Z12 includes a signal in a wireless network as shown and described herein.

Example Z13 includes a method of communicating in a wireless network as shown and described herein.

Example Z14 includes a system for providing wireless communication as shown and described herein.

Example Z15 includes a device for providing wireless communication as shown and described herein.

An example implementation is an edge computing system, including respective edge processing devices and nodes to invoke or perform the operations of examples A01-A19, B01-B20, C1-C40, D1-D23, or other subject matter described herein.

Another example implementation is a client endpoint node, operable to invoke or perform the operations of examples A01-A19, B01-B20, C1-C40, D1-D23, or other subject matter described herein. Another example implementation is an aggregation node, network hub node, gateway node, or core data processing node, within or coupled to an edge computing system, operable to invoke or perform the operations of examples A01-A19, B01-B20, C1-C40, D1-D23, or other subject matter described herein. Another example implementation is an access point, base station, roadside unit, street-side unit, or on-premise unit, within or coupled to an edge computing system, operable to invoke or perform the operations of examples A01-A19, B01-B20, C1-C40, D1-D23, or other subject matter described herein. Another example implementation is an edge provisioning node, service orchestration node, application orchestration node, or multi-tenant management node, within or coupled to an edge computing system, operable to invoke or perform the operations of examples A01-A19, B01-B20, C1-C40, D1-D23, or other subject matter described herein. Another example implementation is an edge node operating an edge provisioning service, application or service orchestration service, virtual machine deployment, container deployment, function deployment, and compute management, within or coupled to an edge computing system, operable to invoke or perform the operations of examples A01-A19, B01-B20, C1-C40, D1-D23, or other subject matter described herein. Another example implementation is an edge computing system operable as an edge mesh, as an edge mesh with side car loading, or with mesh-to-mesh communications, operable to invoke or perform the operations of examples A01-A19, B01-B20, C1-C40, D1-D23, or other subject matter described herein. Another example implementation is an edge computing system including aspects of network functions, acceleration functions, acceleration hardware, storage hardware, or computation hardware resources, operable to invoke or perform the use cases discussed herein, with use of examples A01-A19, B01-B20, C1-C40, D1-D23, or other subject matter described herein. Another example implementation is an edge computing system adapted for supporting client mobility, vehicle-to-vehicle (V2V), vehicle-to-everything (V2X), or vehicle-to-infrastructure (V21) scenarios, and optionally operating according to ETSI MEC specifications, operable to invoke or perform the use cases discussed herein, with use of examples A01-A19, B01-B20, C1-C40, D1-D23, or other subject matter described herein. Another example implementation is an edge computing system adapted for mobile wireless communications, including configurations according to an 3GPP 4G/LTE or 5G network capabilities, operable to invoke or perform the use cases discussed herein, with use of examples A01-A19, B01-B20, C1-C40, D1-D23, or other subject matter described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019 June). For the purposes of the present document, the following abbreviations may apply to the examples and embodiments discussed herein.

| | |
|---|---|
| 3GPP | Third Generation Partnership Project |
| 4G | Fourth Generation |
| 5G | Fifth Generation |
| 5GC | 5G Core network |
| ACK | Acknowledgement |
| AF | Application Function |
| AM | Acknowledged Mode |
| AMBR | Aggregate Maximum Bit Rate |
| AMF | Access and Mobility Management Function |
| AN | Access Network |
| ANR | Automatic Neighbour Relation |
| AP | Application Protocol, Antenna Port, Access Point |
| API | Application Programming Interface |
| APN | Access Point Name |
| ARP | Allocation and Retention Priority |
| ARQ | Automatic Repeat Request |
| AS | Access Stratum |
| ASN.1 | Abstract Syntax Notation One |
| ASP | Application Service Provider |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, Certification Authority |
| CAPEX | CAPital EXpenditure |
| CBRA | Contention Based Random Access |
| CC | Component Carrier, Country Code, Cryptographic Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CFRA | Contention Free Random Access |
| CG | Cell Group |
| CI | Cell Identity |
| CID | Cell-ID (e g., positioning method) |
| CIM | Common Information Model |
| CIR | Carrier to Interference Ratio |
| CK | Cipher Key |
| CM | Connection Management, Conditional Mandatory |
| CMAS | Commercial Mobile Alert Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, Cyclic Prefix, Connection Point |
| CPD | Connection Point Descriptor |
| CPE | Customer Premise Equipment |
| CPICH | Common Pilot Channel |
| CQI | Channel Quality Indicator |
| CPU | CSI processing unit, Central Processing Unit |
| C/R | Command/Response field bit |
| CRAN | Cloud Radio Access Network, Cloud RAN |
| CRB | Common Resource Block |
| CRC | Cyclic Redundancy Check |
| CRI | Channel-State Information Resource Indicator, CSI-RS Resource Indicator |
| C-RNTI | Cell RNTI |
| CS | Circuit Switched |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, Cell-specific Search Space |
| CTS | Clear-to-Send |
| CW | Codeword |
| CWS | Contention Window Size |
| D2D | Device-to-Device |
| DC | Dual Connectivity, Direct Current |
| DCI | Downlink Control Information |
| DF | Deployment Flavour |
| DL | Downlink |
| DMTF | Distributed Management Task Force |
| DPDK | Data Plane Development Kit |
| DM-RS, DMRS | Demodulation Reference Signal |
| DN | Data network |
| DRB | Data Radio Bearer |
| DRS | Discovery Reference Signal |
| DRX | Discontinuous Reception |
| DSL | Domain Specific Language. Digital Subscriber Line |
| DSLAM | DSL Access Multiplexer |
| DwPTS | Downlink Pilot Time Slot |
| E-LAN | Ethernet Local Area Network |
| E2E | End-to-End |
| EAS | Edge Application Server |
| ECCA | extended clear channel assessment, extended CCA |
| ECCE | Enhanced Control Channel Element, Enhanced CCE |
| ECSP | Edge Computing Service Provider |
| ED | Energy Detection |
| EDGE | Enhanced Datarates for GSM Evolution (GSM Evolution) |
| EES | Edge Enabler Server |
| EGMF | Exposure Governance Management Function |
| EGPRS | Enhanced GPRS |
| EIR | Equipment Identity Register |
| eLAA | enhanced Licensed Assisted Access, enhanced LAA |
| EM | Element Manager |
| eMBB | Enhanced Mobile Broadband |
| EMS | Element Management System |
| eNB | evolved NodeB, E-UTRAN Node B |
| EN-DC | E-UTRA-NR Dual Connectivity |
| EPC | Evolved Packet Core |
| EPDCCH | enhanced PDCCH, enhanced Physical Downlink Control Cannel |
| EPRE | Energy per resource element |
| EPS | Evolved Packet System |
| EREG | enhanced REG, enhanced resource element groups |
| ETSI | European Telecommunications Standards Institute |
| ETWS | Earthquake and Tsunami Warning System |
| eUICC | embedded UICC, embedded Universal Integrated Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, further enhanced LAA |
| FMSS | Flexible Mobile Service Steering |
| FN | Frame Number |
| FPGA | Field-Programmable Gate Array |
| FR | Frequency Range |
| G-RNTI | GERAN Radio Network Temporary Identity |
| GERAN | GSM EDGE RAN, GSM EDGE Radio Access Network |
| GGSN | Gateway GPRS Support Node |
| GLONASS | GLObal'naya NAvigatsionnaya Sputnikovaya Sistema |
| | (Engl.: Global Navigation Satellite System) |
| gNB | Next Generation NodeB |
| gNB-CU | gNB-centralized unit, Next Generation NodeB centralized unit |
| gNB-DU | gNB-distributed unit, Next Generation NodeB distributed unit |
| GNSS | Global Navigation Satellite System |
| GPRS | General Packet Radio Service |
| GSM | Global System for Mobile Communications, Groupe Spécial Mobile |
| GTP | GPRS Tunneling Protocol |
| GTP-UGPRS | Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure (https is http/1.1 over SSL, e.g. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IM | Interference Measurement, Intermodulation, IP Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IoT | Internet of Things |
| IP | Internet Protocol |
| Ipsec | IP Security, Internet Protocol Security |
| IP-CAN | IP-Connectivity Access Network |
| IP-M | IP Multicast |
| IPv4 | Internet Protocol Version 4 |
| IPv6 | Internet Protocol Version 6 |
| IR | Infrared |
| IS | In Sync |
| IRP | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN Constraint length of the convolutional code, USIM Individual key |
| kB | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network layer) |
| LAA | Licensed Assisted Access |
| LAN | Local Area Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, Low Layer Compatibility |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level Integration with IPsec Tunnel |
| LTE | Long Term Evolution |
| M2M | Machine-to-Machine |
| MAC | Medium Access Control (protocol layering context) |
| MAC | Message authentication code (security/encryption context) |
| MAC-A | MAC used for authentication and key agreement (TSG T WG3 context) |
| MAC-IMAC | used for data integrity of signalling messages (TSG T WG3 context) |
| MANO | Management and Orchestration |
| MBMS | Multimedia Broadcast and Multicast Service |
| MBSFN | Multimedia Broadcast multicast service Single Frequency Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, Management Information Base |
| MIMO | Multiple Input Multiple Output |
| MLC | Mobile Location Centre |
| MM | Mobility Management |
| MME | Mobility Management Entity |
| MN | Master Node |
| MnS | Management Service |
| MO | Measurement Object, Mobile Originated |
| MPBCH | MTC Physical Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, MCH Scheduling Information |
| MSID | Mobile Station Identifier |
| MSIN | Mobile Station Identification Number |
| MSISDN | Mobile Subscriber ISDN Number |
| MT | Mobile Terminated, Mobile Termination |
| MTC | Machine-Type Communications |
| mMTC | massive MTC, massive Machine-Type Communications |
| MU-MIMO | Multi User MIMO |
| MWUS | MTC wake-up signal, MTC WUS |
| NACK | Negative Acknowledgement |
| NAI | Network Access Identifier |
| NAS | Non-Access Stratum, Non-Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, Next Gen |
| NGEN-DC | NG-RAN E-UTRA-NR Dual Connectivity |
| NM | Network Manager |
| NMS | Network Management System |
| N-PoP | Network Point of Presence |
| NMIB, N-MIB | Narrowband MIB |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWUS | Narrowband wake-up signal, Narrowband WUS |
| NZP | Non-Zero Power |
| O&M | Operation and Maintenance |
| ODU2 | Optical channel Data Unit - type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, Personal Computer |
| PCC | Primary Component Carrier, Primary CC |
| PCell | Primary Cell |
| PCI | Physical Cell ID, Physical Cell Identity |
| PCEF | Policy and Charging Enforcement Function |
| PCF | Policy Control Function |
| PCRF | Policy Control and Charging Rules Function |
| PDCP | Packet Data Convergence Protocol, Packet Data Convergence Protocol layer |
| PDCCH | Physical Downlink Control Channel |
| PDCP | Packet Data Convergence Protocol |
| PDN | Packet Data Network, Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSFCH | Physical Sidelink Feedback Channel |
| PSSCH | Physical Sidelink Shared Channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, QoS Flow Identifier |
| QoS | Quality of Service |
| QPSK | Quadrature (Quaternary) Phase Shift Keying |
| QZSS | Quasi-Zenith Satellite System |
| RA-RNTI | Random Access RNTI |
| RAB | Radio Access Bearer, Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, Remaining Minimum System Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, Radio Resource Control layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time |
| Rx | Reception, Receiving, Receiver |
| S1AP | S1 Application Protocol |
| S1-MME | S1 for the control plane |
| S1-U | S1 for the user plane |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, Secondary CC |
| SCell | Secondary Cell |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, Service Data Adaptation Protocol layer |
| SDL | Supplementary Downlink |
| SDNF | Structured Data Storage Network Function |
| SDP | Session Description Protocol |
| SDSF | Structured Data Storage Function |
| SDU | Service Data Unit |
| SEAF | Security Anchor Function |
| SeNB | secondary eNB |
| SEPP | Security Edge Protection Proxy |
| SFC | Service Function Chaining |
| SFP | Serivce Function Path(s) |
| SFI | Slot format indication |
| SFTD | Space-Frequency Time Diversity, SFN and frame timing difference |
| SFN | System Frame Number or Single Frequency Network |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, Sequence Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | SS Block |
| SSBRI | SSB Resource Indicator |
| SSC | Session and Service Continuity |
| SS-RSRP | Synchronization Signal based Reference Signal Received Power |
| SS-RSRQ | Synchronization Signal based Reference Signal Received Quality |
| SS-SINR | Synchronization Signal based Signal to Noise and Interference Ratio |
| SSS | Secondary Synchronization Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, Tracking Area |
| TAC | Tracking Area Code |
| TAG | Timing Advance Group |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, Technical Standard |
| TTI | Transmission Time Interval |
| Tx | Transmission, Transmitting, Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDR | Unified Data Repository |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, |
| VLAN | Virtual LAN, Virtual Local Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VoIP | Voice-over-IP, Voice-over-Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Power |

### Terminology

For the purposes of the present document, the following terms and definitions are applicable to the examples and embodiments discussed herein.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “memory” and/or “memory circuitry” as used herein refers to one or more hardware devices for storing data, including RAM, MRAM, PRAM, DRAM, and/or SDRAM, core memory, ROM, magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource. The term “element” refers to a unit that is indivisible at a given level of abstraction and has a clearly defined boundary, wherein an element may be any type of entity including, for example, one or more devices, systems, controllers, network elements, modules, etc., or combinations thereof. The term “device” refers to a physical entity embedded inside, or attached to, another physical entity in its vicinity, with capabilities to convey digital information from or to that physical entity. The term “entity” refers to a distinct component of an architecture or device, or information transferred as a payload. The term “controller” refers to an element or entity that has the capability to affect a physical entity, such as by changing its state or causing the physical entity to move.

The term “cloud computing” or “cloud” refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like). The term “computing resource” or simply “resource” refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, etc.), operating systems, virtual machines (VMs), software/applications, computer files, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable. As used herein, the term “cloud service provider” (or CSP) indicates an organization which operates typically large-scale “cloud” resources comprised of centralized, regional, and edge data centers (e.g., as used in the context of the public cloud). In other examples, a CSP may also be referred to as a Cloud Service Operator (CSO). References to “cloud computing” generally refer to computing resources and services offered by a CSP or a CSO, at remote locations with at least some increased latency, distance, or constraints relative to edge computing.

As used herein, the term “data center” refers to a purpose-designed structure that is intended to house multiple high-performance compute and data storage nodes such that a large amount of compute, data storage and network resources are present at a single location. This often entails specialized rack and enclosure systems, suitable heating, cooling, ventilation, security, fire suppression, and power delivery systems. The term may also refer to a compute and data storage node in some contexts. A data center may vary in scale between a centralized or cloud data center (e.g., largest), regional data center, and edge data center (e.g., smallest).

As used herein, the term “edge computing” refers to the implementation, coordination, and use of computing and resources at locations closer to the “edge” or collection of “edges” of a network. Deploying computing resources at the network's edge may reduce application and network latency, reduce network backhaul traffic and associated energy consumption, improve service capabilities, improve compliance with security or data privacy requirements (especially as compared to conventional cloud computing), and improve total cost of ownership). As used herein, the term “edge compute node” refers to a real-world, logical, or virtualized implementation of a compute-capable element in the form of a device, gateway, bridge, system or subsystem, component, whether operating in a server, client, endpoint, or peer mode, and whether located at an “edge” of an network or at a connected location further within the network. References to a “node” used herein are generally interchangeable with a “device”, “component”, and “sub-system”; however, references to an “edge computing system” or “edge computing network” generally refer to a distributed architecture, organization, or collection of multiple nodes and devices, and which is organized to accomplish or offer some aspect of services or resources in an edge computing setting.

Additionally or alternatively, the term “Edge Computing” refers to a concept, as described in [4], that enables operator and 3rd party services to be hosted close to the UE's access point of attachment, to achieve an efficient service delivery through the reduced end-to-end latency and load on the transport network.

As used herein, the term “Edge Computing Service Provider” refers to a mobile network operator or a 3rd party service provider offering Edge Computing service.

As used herein, the term “Edge Data Network” refers to a local Data Network (DN) that supports the architecture for enabling edge applications.

As used herein, the term “Edge Hosting Environment” refers to an environment providing support required for Edge Application Server's execution.

As used herein, the term “Application Server” refers to application software resident in the cloud performing the server function.

The term “Internet of Things” or “IoT” refers to a system of interrelated computing devices, mechanical and digital machines capable of transferring data with little or no human interaction, and may involve technologies such as real-time analytics, machine learning and/or AI, embedded systems, wireless sensor networks, control systems, automation (e.g., smarthome, smart building and/or smart city technologies), and the like. IoT devices are usually low-power devices without heavy compute or storage capabilities. “Edge IoT devices” may be any kind of IoT devices deployed at a network's edge.

As used herein, the term “cluster” refers to a set or grouping of entities as part of an edge computing system (or systems), in the form of physical entities (e.g., different computing systems, networks or network groups), logical entities (e.g., applications, functions, security constructs, containers), and the like. In some locations, a “cluster” is also referred to as a “group” or a “domain”. The membership of cluster may be modified or affected based on conditions or functions, including from dynamic or property-based membership, from network or system management scenarios, or from various example techniques discussed below which may add, modify, or remove an entity in a cluster. Clusters may also include or be associated with multiple layers, levels, or properties, including variations in security features and results based on such layers, levels, or properties.

The terms “instantiate,” “instantiation,” and the like as used herein refers to the creation of an instance. An “instance” also refers to a concrete occurrence of an object, which may occur, for example, during execution of program code.

The term “information element” refers to a structural element containing one or more fields. The term “field” refers to individual contents of an information element, or a data element that contains content.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

As used herein, the term “radio technology” refers to technology for wireless transmission and/or reception of electromagnetic radiation for information transfer. The term “radio access technology” or “RAT” refers to the technology used for the underlying physical connection to a radio based communication network.

As used herein, the term “communication protocol” (either wired or wireless) refers to a set of standardized rules or instructions implemented by a communication device and/or system to communicate with other devices and/or systems, including instructions for packetizing/depacketizing data, modulating/demodulating signals, implementation of protocols stacks, and/or the like.

As used herein, the term “service function” or “SF” refers to a function, specifically representing network service function, that is responsible for specific treatment of received packets other than the normal, standard functions of an IP router (e.g., IP forwarding and routing functions) on the network path between a source host and destination host (see e.g., [3])

As used herein, the term “service function chain” or “SF chain” refers to a chain that defines an ordered set of abstract service functions and ordering constraints that must be applied to packets and/or frames and/or flows selected as a result of classification and/or policy.

As used herein, the term “service function chaining” or “SFC” refers to a mechanism of building service function chains and forwarding packets/frames/flows through them.

As used herein, the term “service function path” or “SFP” refers to a path that defines an ordered set of specific instantiations of service functions that packets and/or frames and/or flows must visit within a specific service function chain. An SFP is determined among the relevant service function paths within a specific service function chain, satisfying capacity and QoS requirements of service functions and their connecting links. There is typically a 1: n relationship between a service function chain and a service function path.

As used herein, the term “service routing” refers to a unified service supporting platforms built on DSN. It supplies the service registration, publication, discovery, triggering and access mechanisms, and enhanced capabilities to optimize the service provision.

As used herein, the term “user plane” refers to a set of traffic forwarding components through which traffic flows.

1-23. (canceled)

24. One or more non-transitory computer-readable media (NTCRM) having instructions, stored thereon, that when executed by one or more processors cause an apparatus of a wireless cellular network to:
receive configuration information for a service function path (SFP) that specifies one or more ordered service functions for service function chaining (SFC); and
configure the SFP based on the configuration information to coordinate with a SFC function in an edge data network to provide the one or more ordered service functions via the SFP across the wireless cellular network and the edge data network.

25. The one or more NTCRM of claim 24, wherein the configuration information is received from an operations, administration, and management (OAM) entity or a network function repository function (NRF) of the wireless cellular network.

26. The one or more NTCRM of claim 24, wherein the configuration information includes one or more SFC parameters based on a service level agreement (SLA) for SFC services at the wireless cellular network.

27. The one or more NTCRM of claim 24, wherein the configuration information is received from an edge application server (EAS) and indicates the one or more ordered service functions to be provided by the wireless cellular network and associated parameters.

28. The one or more NTCRM of claim 24, wherein to configure the SFP includes to configure one or more SFC user plane functions (SFCF-Us) to provide the one or more ordered service functions.

29. The one or more NTCRM of claim 28, wherein the configuration information includes an indication of one or more SFCF-U instances that support one or more of the one or more ordered service functions.

30. The one or more NTCRM of claim 29, wherein the instructions, when executed, are further to cause the apparatus to send a request for the configuration information associated with the one or more SFCF-U instances, wherein the request identifies the one or more ordered service functions.

31. The one or more NTCRM of claim 29, wherein the configuration information further includes at least one of a SFC application ID or a SFC service ID associated with the respective one or more SFCF-U instances.

32. The one or more NTCRM of claim 24, wherein the apparatus implements a SFC control plane function (SFCF-C).

33. One or more non-transitory computer-readable media (NTCRM) having instructions, stored thereon, that when executed by one or more processors cause an operations, administration, and management (OAM) entity to:
receive, from a service function chaining (SFC) control plane function (SFCF-C), a request for information associated with one or more SFC user plane function (SFCF-U) instances that support one or more service ordered functions associated with a service function path; and
send the information associated with the one or more SFCF-U instances to the SFCF-C.

34. The one or more NTCRM of claim 33, wherein the instructions, when executed, are further to cause the OAM entity to:
determine that no SFCF-U instance that supports a first service function of the one or more ordered service functions is available; and
configure, based on the determination, a new SFCF-U instance to support the first service function.

35. The one or more NTCRM of claim 33, wherein the instructions, when executed, are further to cause the OAM entity to register the new SFCF-U instance with a network function repository function (NRF).

36. The one or more NTCRM of claim 35, wherein to register the new SFCF-U instance with the NRF includes to provide information on at least one of an application ID and a SFC service ID associated with the SFCF-U instance.

37. The one or more NTCRM of claim 33, wherein the service function path includes the one or more ordered service functions to be provided by a wireless cellular network and one or more other ordered service functions to be provided by an edge data network.

38. An apparatus of an edge data network, the apparatus comprising:
a traffic classifier to receive service function chaining (SFC) traffic from a wireless cellular network and route the SFC traffic to one or more ordered service functions via a service function path (SFP); and
a traffic declassifier to receive the SFP traffic from the SFP and provide the SFP traffic to an edge application server or an edge enabler server.

39. The apparatus of claim 38, wherein the traffic classifier is further to receive SFC policy information, and wherein the SFC traffic is to identify the SFP via with to route the SFC traffic based on the SFC policy information.

40. The apparatus of claim 39, wherein the SFC policy information is received from the edge application server, the edge enabler server, or an operations, administration, and management (OAM) entity of the wireless cellular network.

41. The apparatus of claim 38, wherein the SFC traffic is received via an N6 interface and the SFP traffic is provided via an EDGE-X or EDGE-Y interface.

42. The apparatus of claim 38, wherein the traffic declassifier is to combine SFP traffic from multiple SFPs and provide the combined SFP traffic to the edge application server or the edge enabler server.

43. The apparatus of claim 38, wherein the one or more service functions include one or more of: network address translation (NAT), an Internet Protocol (IP) tunnel endpoint, a packet classifier, deep packet inspection (DPI), lawful inspection (LI), a transmission control protocol (TCP) proxy, a load balancer, a firewall function, a transcoder, a video optimizer, a uniform resource locator (URL) filter, or application detection and control (ADC).

44. The apparatus of claim 38, wherein the traffic classifier is to receive SFC parameters for an SFC service associated with the SFC traffic, wherein the SFC parameters include one or more of: a SFC service ID, a SFC configuration that includes one or more service functions and associated service function parameters, or a SFP configuration that includes an SFP index and associated ordered service functions; and wherein the traffic classifier is route the SFC traffic based further on the SFC parameters.

45. The apparatus of claim 44, wherein the SFC parameters further include one or more validity parameters for the SFC service, wherein the one or more validity parameters include one or more of: a duration, a scheduled time period, one or more application IDs, a packet data unit session type or other associated PDU session parameters, or a slice differentiator.

46. The apparatus of claim 38, wherein the SFC traffic includes one or more of a user equipment (UE) address, an application ID, a media type, or a traffic priority.
